(19) United States
(12) Patent Application Publication
(10) Pub. No.: US 2025/0145749 A1
(43) Pub. Date: May 8, 2025

(54) POLY(CYCLIC VINYL ETHERS), COMPOSITIONS OF SAME, METHODS OF MAKING SAME AND USES THEREOF

(71) Applicant: Cornell University, Ithaca, NY (US)

(72) Inventors: Brett P. FORS, Ithaca, NY (US); Scott SPRING, Ithaca, NY (US); Tristan H. LAMBERT, Lansing, NY (US); Veronika KOTTISCH, Münster (DE)

(21) Appl. No.: 18/685,186

(22) PCT Filed: Aug. 19, 2022
(86) PCT No.: PCT/US2022/040841

§ 371 Date: Feb. 20, 2024

Related U.S. Application Data
(60) Provisional application No. 63/235,562, filed on Aug. 20, 2021.

(51) Int. Cl. C08F 234/02; C08F 2/06

(52) U.S. Cl. CPC C08F 234/02; C08F 2/06

(57) ABSTRACT

Poly(cyclic vinyl ethers) (PCVEs), compositions of same, methods of making same, and uses of same. In various examples, PCVEs (e.g., homopolymers and/or copolymers) comprise repeat units comprising cyclic vinyl ether (CVE) groups in the backbone (e.g., poly(2,3-dihydrofuran) and/or poly(3,4-dihydropyran)). In various examples, PCVE homopolymers comprise molecular weights (Mn and/or Mw) of 200 kilodalton (kD) or greater. In various examples, PCVE copolymers (e.g., random or block) comprise one or more CVE group(s) and/or additional (e.g., acyclic vinyl ether (AVE) and/or styrenic) group(s)). A method of preparing PCVEs comprises polymerizing monomers comprising CVE groups (e.g., 2,3-dihydrofuran and/or 3,4-dihydropyran). In various examples, pentakis(carbonylcyclopentadienes) (PCCPs) and/or hydrogen bond donors are polymerization catalysts and/or initiators. various examples, PCVEs are biorenewable, recyclable, thermoplastic materials that exhibit desirable optical clarity, desirable barrier properties to, e.g., oxygen, carbon dioxide, and water, and find uses in food packaging, windows, and the like.

### CROSS-REFERENCE TO RELATED APPLICATIONS

This application claims the benefit of U.S. Provisional Patent Application No. 63/235,562, filed Aug. 20, 2021, the contents of the above-identified application are hereby fully incorporated herein by reference in their entirety.

### STATEMENT REGARDING FEDERALLY SPONSORED RESEARCH AND DEVELOPMENT

This invention was made with government support under grant nos. DGE-1650441 and CHE-1901635 awarded by the National Science Foundation. The government has certain rights in the invention.

### BACKGROUND OF THE DISCLOSURE

The annual production of plastics exceeded 381 million metric tons in 2015. With 90% of polymers produced from petroleum feedstocks, plastics are projected to account for 20% of annual petroleum consumption by 2050 without intervention. To reduce the carbon footprint and oil consumption of the plastics industry, there is a concerted effort to generate sustainable materials from biomass. The exponential growth in global demand for poly(lactic acid) (PLA) illustrates the commercial interest in sustainable polymers; however, PLA can only meet a fraction of the total plastic demand due to brittle material properties, poor water barrier properties, and low heat stability. Three grand challenges of sustainable polymers are that they should be derived from sustainable resources, should be highly effective in their intended use, and should offer sustainable solutions after use.

The creation of strong and tough plastics from sustainable and biorenewable resources is a significant challenge in polymer science. This challenge is further complicated when attempting to make these materials in an economically viable process, which is often hindered by the production and availability of chemical feedstocks as well as the efficiency of the monomer synthesis. Recent efforts to develop biorenewable polymers have focused on lactones, acrylates, and styrenic monomers derived from lignin. While these monomers produce desirable materials, lignin valorization still faces many challenges in commercial development. Carbohydrate-sourced monomers such as isosorbide and itaconic acid have also gained interest, offering a different biorenewable pathway. However, isosorbide production is still inefficient, and generating desirable polymers from itaconic acid remains difficult. Alternatively, bioalcohols represent a largely untapped resource in the production of biorenewable plastics. Several alcohols are already produced on plant scale from biomass for use as transportation fuel. In 2019 the United States produced 15.7 billion gallons of bio-ethanol and 1 million gallons of bio-isobutanol, and recently, Cargill announced plans to build a 65,000 ton per year plant dedicated to production of 1,4-butanediol from biomass.

DHF has captured the interest of polymer chemists since the 1950s. This cyclic vinyl ether results in a polymer with a restricted backbone, leading to a material with a high glass transition temperature of ˜135° C. It was envisioned that poly(2,3-dihydrofuran) (PDHF) could address these aims, where it was hypothesized that PDHF could be sourced from a commercial bioalcohol, provide a strong and tough thermoplastic, and degrade back to small molecules for biodegradation or chemical recycling. Facile methods are available to transform biorenewable alcohols into vinyl ether monomers, such as the one-step cyclization of 1,4-butanediol to generate 2,3-dihydrofuran (DHF). Further, based on previous incorporation of DHF as a glassy block in sustainable thermoplastic elastomers, it was hypothesized that achieving a high molecular weight (Mₙ) PDHF would produce a strong and tough thermoplastic.

Historically, the development of high T_{g}, sustainable polymers has been a grand challenge, where for example, much effort has been expended to increase the T_{g} of commercial plastics such as PLA (T_{g}˜60° C.) and polystyrene (T_{g}˜100° C.). The first controlled polymerization of DHF was previously performed using iodine as an initiator at −40° C. A Lewis acid initiator was previously used to obtain a controlled polymerization at −78° C. and the relationship between PDHF tacticity and T_{g} was characterized. A base-stabilized method was previously performed that resulted in a controlled polymerization at 0° C. Tangentially, a ring opening metathesis polymerization (ROMP) of DHF was previously performed, which produced a rubbery poly(enol ether) that could be depolymerized back to monomer or acid-degraded to small molecules. Reversible addition-fragmentation chain-transfer polymerization was previously used to generate PDHF and polyisobutyl vinyl ether block copolymers at room temperature, and achieved only moderate PDHF molecular weights. Overall, this extensive interest in DHF is underlined by the various patents issued for the synthesis and application of PDHF as a degradable fiber and thermoplastic. Despite these many advances, all reported cationic polymerization methods require low temperatures and low monomer concentrations, resulting in substantial energy and solvent costs at plant scale. In addition to these drawbacks, only low molecular weight (Mₙ) PDHF has been produced, leaving the material properties of high Mₙ PDHF unknown. Thus, the development of an energy- and solvent-efficient controlled polymerization for high Mₙ PDHF remains a challenge.

Previous Lewis acid methods for controlled cationic polymerizations required low temperatures-likely to reduce reactivity and counteract exothermal heat generation and chain transfer. This excessive chain transfer prohibits access to high Mₙ; thus, the development of a room temperature cationic polymerization to high Mₙ would represent a significant advancement. It has been demonstrated that pentakis-(methoxycarbonyl)cyclopentadiene (PCCP) can initiate controlled polymerization of vinyl ethers under ambient conditions. PCCP is a readily available, highly acidic reagent which provides a unique reactivity profile due to its extended carbanionic π-system.

### SUMMARY OF THE DISCLOSURE

In an aspect, the present disclosure provides methods of preparing poly(cyclic vinyl ethers) (PCVEs). In various examples, a method comprises: forming a reaction mixture comprising: one or more cyclic vinyl ether (CVE) monomer(s), each cyclic vinyl ether monomer independently comprising the following structure:

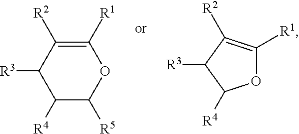

or a structural analog thereof, where: R² is H; and R¹ is independently at each occurrence chosen from H, C₁-C₁₀ alkyl groups, C₃-C₁₀ cycloalkyl groups, and C₅-C₁₀ polycycloalkyl groups; and R³ and R⁴ and R⁵ are according to the following: R³ and R⁴ and R⁵ are each independently at each occurrence chosen from H, C₁-C₁₀ alkyl groups, C₃-C₁₀ cycloalkyl groups, and C₅-C₁₀ polycycloalkyl groups; or R³ and R⁴, taken together, form a group independently at each occurrence chosen from C₃-C₁₀ cycloalkyl groups, C₅-C₁₀ polycycloalkyl groups, and C₅-C₁₀ aryl groups, and R⁵, if present, is independently at each occurrence chosen from H, C₁-C₁₀ alkyl groups, C₃-C₁₀ cycloalkyl groups, and C₅-C₁₀ polycycloalkyl groups; or R⁴ and R⁵, taken together, form a group independently at each occurrence chosen from C₃-C₁₀ cycloalkyl groups, C₅-C₁₀ polycycloalkyl groups, and C₅-C₁₀ aryl groups, and R³ is independently at each occurrence chosen from H, C₁-C₁₀ alkyl groups, C₃-C₁₀ cycloalkyl groups, and C₅-C₁₀ polycycloalkyl groups; and one or more pentakis((alkoxy/aryloxy)carbonylcyclopentadiene) (alkoxy/aryloxy PCCP) polymerization catalyst(s) and/or initiator(s); and holding the reaction mixture for a time and at a temperature, where a PCVE is formed.

In various examples, the CVE monomer(s) is/are chosen from 2,3-dihydrofuran, α-methyl-2,3-dihydrofuran, 5-methyl-2,3-dihydrofuran, benzofuran, 2-methyl benzofuran, 2,3-dihydropyran, structural analogs thereof, and any combination thereof. In various examples, the concentration of the CVE monomer(s) is from about 20% to about 60% by volume, based on the total volume of the reaction mixture.

In various examples, each alkoxy/aryloxy PCCP polymerization catalyst and/or initiator independently comprises the following structure:

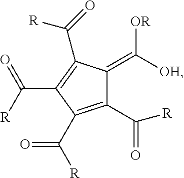

or a structural analog thereof, where the R groups and the OR group are, independently at each occurrence, chosen from: alkoxy groups, the alkoxy groups, independently at each occurrence, comprising an alkyl group; and aryloxy groups, the aryloxy groups, independently at each occurrence, comprising an aryl group. In various examples, the R groups and the OR group are, independently at each occurrence, chosen from:

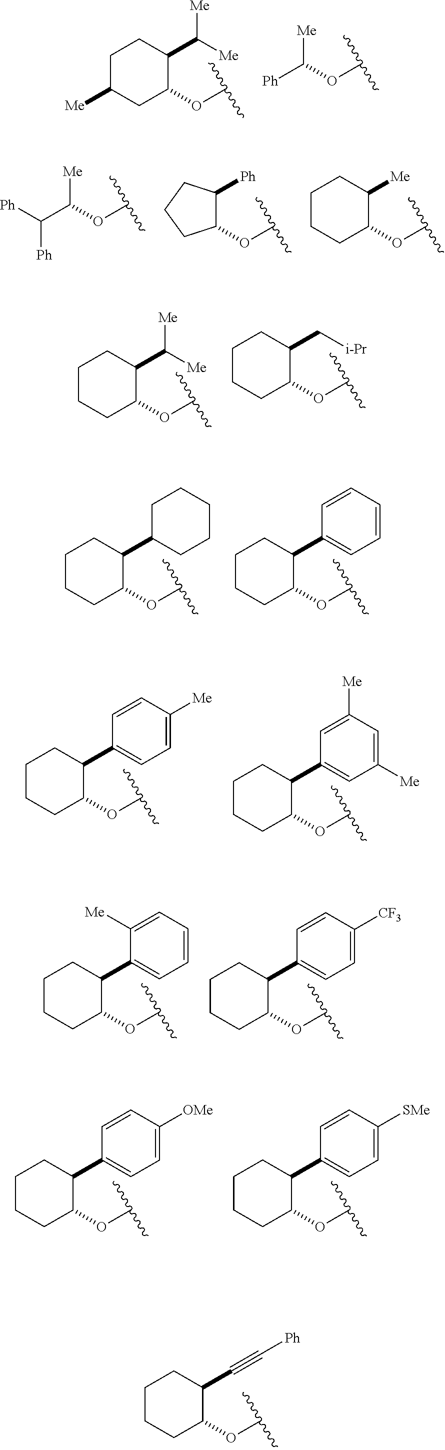

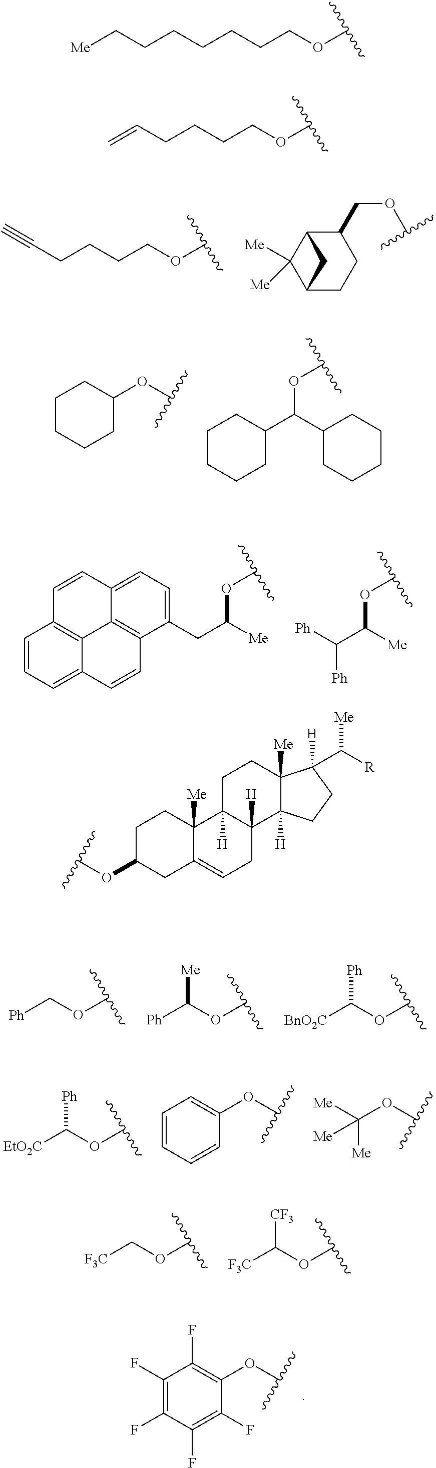

and any structural analog thereof, where

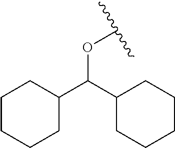 [SMILES: *OC(C1CCCCC1)C1CCCCC1]

is in the C protonated form. In various examples, the alkoxy/aryloxy PCCP polymerization catalyst(s) and/or initiator(s) is/are chosen from C₁-C₃₀ alkoxy/aryloxy PCCP polymerization catalyst(s) and/or initiator(s). In various examples, the R groups and the OR group are, independently at each occurrence, derived from cholesterol or menthol or methanol. In various examples, one or more of the alkoxy/aryloxy PCCP polymerization catalyst(s) and/or initiator(s) is/are chiral alkoxy/aryloxy PCCP polymerization catalyst(s) and/or initiator(s).

In various examples, the reaction mixture further comprises one or more acyclic vinyl ether (AVE) monomer(s), one or more styrenic monomer(s), or any combination thereof; and/or the method further comprises, after a desired conversion of the CVE monomer(s), adding one or more AVE monomer(s), one or more styrenic monomer(s), or any combination thereof, to the reaction mixture, where the PCVE is a PCVE copolymer.

In various examples, each AVE monomer independently comprises the following structure:

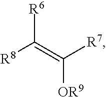

where: R⁶, R⁷, and R⁸ are each H; R⁹ is independently at each occurrence chosen from H, C₁-C₁₀ alkyl groups, C₃-C₁₀ cycloalkyl groups, and C₅-C₁₀ polycycloalkyl groups; and/or each styrenic monomer independently comprises the following structure:

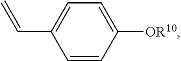

or a structural analog thereof, where: R¹⁰ are independently at each occurrence chosen from H, C₁-C₈ alkyl groups, C₃-C₁₀ cycloalkyl groups, and C₅-C₁₀ polycycloalkyl groups. In various examples, the AVE monomer(s) is/are chosen from isobutyl vinyl ether (VE), cyclohexane VE, adamantane VE, ethyl VE, 2-chloroethyl VE, n-butyl VE, t-butyl VE, n-propyl VE, iso-propyl VE, dodecyl VE, phenyl VE, 2-ethylhexyl VE, polyethylene glycol methyl VE, cyclohexyl VE, structural analogs thereof, and any combination thereof, and/or the styrenic monomer(s) is/are chosen from 4-methoxystyrene, structural analogs thereof, and any combination thereof. In various examples, the reaction mixture comprises from about 1 mol % to about 99 mol %, of the AVE monomer(s) and/or the styrenic monomer(s), based on the total moles of the CVE monomer(s), the AVE monomer(s), and the styrenic monomer(s); and/or where the AVE monomer(s) and/or the styrenic monomer(s) is/are added to the reaction mixture at from about 1 mol % to about 99 mol %, based on the total moles of the CVE monomer(s), the AVE monomer(s), and the styrenic monomer(s). In various examples, the reaction mixture comprises from about 0.02 mol % to about 1.5 mol %, of alkoxy/aryloxy PCCP polymerization catalyst(s) and/or initiator(s), based on the total moles of the CVE monomer(s), the AVE monomer(s), the styrenic monomer(s), and the alkoxy/aryloxy PCCP polymerization catalyst(s) and/or initiator(s).

In various examples, the reaction mixture further comprises one or more hydrogen bond donor(s), optionally chiral hydrogen bond donor(s). In various examples, the hydrogen bond donor(s) is/are polymerization catalyst(s) and the alkoxy/aryloxy PCCP(s) is/are polymerization initiator(s). In various examples, the hydrogen bond donor(s) is/are chosen from thiophosphoramide(s), sulfamide(s), thiourea(s), squaramide(s), and any combination thereof.

In various examples, the thiophosphoramide(s) independently comprise(s) the following structure:

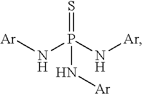

where Ar is independently at each occurrence an aryl group or the like, a structural analog thereof, or the like; the sulfamide(s) independently comprise(s) the following structure:

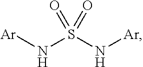

where Ar is independently at each occurrence an aryl group or the like, a structural analog thereof, or the like; the thiourea(s) independently comprise(s) the following structure:

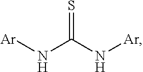

where Ar is independently at each occurrence an aryl group or the like, a structural analog thereof, or the like; the squaramide(s) independently comprise(s) the following structure:

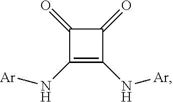

where Ar is independently at each occurrence an aryl group or the like, a structural analog thereof, or the like; and/or optionally, the Ar group(s) is/are di(fluoroalkyl)phenyl group(s). In various examples, the concentration of the hydrogen bond donor(s) is/are from about 0.0125 mol % to about 0.1 mol %, based on the total moles of the CVE monomer(s), the AVE monomer(s), the styrenic monomer(s), the alkoxy/aryloxy PCCP(s) polymerization catalyst(s) and/or initiator(s), and the hydrogen bond donor(s).

In various examples, the reaction mixture is held until the conversion rate of the CVE monomer(s) to PCVE is from about 90% to about 100%, and, optionally, where the reaction mixture is quenched prior to, at, or after 100% conversion. In various examples, the reaction mixture comprises one or more organic solvent(s) chosen from chlorinated hydrocarbon(s), alkane(s), ether(s), aromatic hydrocarbon(s), and any combination thereof. In various examples, a method further comprises forming an article of manufacture by casting, molding, spin-coating, extrusion, blowing, spinning, or any combination thereof, one or more of the PCVE(s).

In an aspect, the present disclosure provides poly(cyclic vinyl ether) (PCVEs). In various examples, a PCVE comprises a plurality of cyclic vinyl ether (CVE) repeat units, the PCVE comprising the following structure:

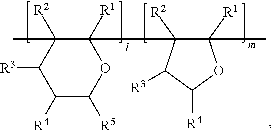

or a structural analog thereof, where: R² is H; and R¹ is independently at each occurrence chosen from H, C₁-C₁₀ alkyl groups, C₃-C₁₀ cycloalkyl groups, C₅-C₁₀ and polycycloalkyl groups; and R³ and R⁴ and R⁵ are according to the following: R³ and R⁴ and R⁵ are each independently at each occurrence chosen from H, C₁-C₁₀ alkyl groups, C₃-C₁₀ cycloalkyl groups, and C₅-C₁₀ polycycloalkyl groups; or R³ and R⁴, taken together, form a group independently at each occurrence chosen from C₃-C₁₀ cycloalkyl groups, and C₅-C₁₀ polycycloalkyl groups, C₅-C₁₀ aryl groups, and R⁵, if present, is independently at each occurrence chosen from H, C₁-C₁₀ alkyl groups, C₃-C₁₀ cycloalkyl groups, and C₅-C₁₀ polycycloalkyl groups; or R⁴ and R⁵, taken together, form a group independently at each occurrence chosen from C₃-C₁₀ cycloalkyl groups, C₅-C₁₀ polycycloalkyl groups, and C₅-C₁₀ aryl groups, and R³ is independently at each occurrence chosen from H, C₁-C₁₀ alkyl groups, C₃-C₁₀ cycloalkyl groups, and C₅-C₁₀ polycycloalkyl groups; and the mole ratio of the l repeat unit value to the m repeat unit value is from 100:0 to 0:100; and the l+m repeat unit value is from about 70 to about 17,200.

In various examples, the PCVE comprises a PCVE homopolymer comprising a molecular weight (Mn and/or Mw), of about 200 kg/mol or greater. In various examples, the PCVE comprises a polydispersity index (Mw/Mn) of from about 1.05 to about 10. In various examples, the PCVE comprises: a molecular weight between entanglements (Mₑ) of from about 2 kg/mol to about 5 kg/mol; and/or a critical molecular weight (M_{c}) of from about 4 kg/mol to about 10 kg/mol.

In various examples, the CVE repeat units are independently at each occurrence chosen from a tetrahydrofuran group, a α-methyl-tetrahydrofuran group, a benzo-dihydrofuran group, and any structural analog thereof. In various examples, the PCVE comprises a PCVE copolymer further comprising one or more acyclic vinyl ether (AVE) repeat unit(s), one or more styrenic ether repeat unit(s), or any combination thereof.

In various examples, the PCVE copolymer has the following structure,

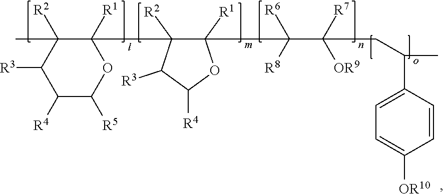

or a structural analog thereof, where: R², R⁶, R⁷, and R⁸ are each H; and R¹ and R⁹ are each independently at each occurrence chosen from H, C₁-C₁₀ alkyl groups, C₃-C₁₀ cycloalkyl groups, and C₅-C₁₀ polycycloalkyl groups; and R¹⁰ is independently at each occurrence chosen from C₁-C₁₀ alkyl groups, C₃-C₈ cycloalkyl groups, and C₅-C₁₀ polycycloalkyl groups; and R³ and R⁴ and R⁵ are according to the following: R³ and R⁴ and R⁵ are each independently at each occurrence chosen from H, C₁-C₁₀ alkyl groups, C₃-C₁₀ cycloalkyl groups, and C₅-C₁₀ polycycloalkyl groups; or R³ and R⁴, taken together, form a group independently at each occurrence chosen from C₃-C₁₀ cycloalkyl groups, and C₅-C₁₀ polycycloalkyl groups, C₅-C₁₀ aryl groups, and R⁵, if present, is independently at each occurrence chosen from H, C₁-C₁₀ alkyl groups, C₃-C₁₀ cycloalkyl groups, and C₅-C₁₀ polycycloalkyl groups; or R⁴ and R⁵, taken together, form a group independently at each occurrence chosen from C₃-C₁₀ cycloalkyl groups, C₅-C₁₀ polycycloalkyl groups, and C₅-C₁₀ aryl groups, and R³ is independently at each occurrence chosen from H, C₁-C₁₀ alkyl groups, C₃-C₁₀ cycloalkyl groups, and C₅-C₁₀ polycycloalkyl groups; and the mole ratio of the l, m, or l+m repeat unit value to the n, o, or n+o repeat unit value is from 99:1 to 1:99; and only one of the l repeat unit value and the m repeat unit value can be zero; and only one of the n repeat unit value and the o repeat unit value can be zero. In various examples, the l, m, or l+m repeat unit value is from about 70 to about 4300, and where the n, o, or n+o repeat unit value is from about 10 to about 3000. In various examples, the PCVE copolymer comprises a molecular weight (Mn and/or Mw) of from about 5 kg/mol to about 500 kg/mol. In various examples, the PCVE copolymer is: a statistical PCVE copolymer comprising a mole ratio of the l, m, or l+m repeat unit value to the n, o, or n+o repeat unit value of from about 99:1 to about 1:99; or a block PCVE copolymer comprising a mole ratio of the l, m, or l+m repeat unit value to the n, o, or n+o repeat unit value of from about 5:95 to about 90:10.

In various examples, the AVE repeat unit(s) is/are chosen from an isobutyl vinyl ether (VE) repeat unit, a cyclohexyl (VE) repeat unit, an adamantane (VE) repeat unit, an ethyl (VE) repeat unit, a 2-chloroethyl (VE) repeat unit, an n-butyl (VE) repeat unit, a t-butyl (VE) repeat unit, an n-propyl (VE) repeat unit, an iso-propyl (VE) repeat unit, a dodecyl (VE) repeat unit, a phenyl (VE) repeat unit, a 2-ethylhexyl (VE) repeat unit, a polyethylene glycol methyl (VE) repeat unit, a cyclohexyl (VE) repeat unit, structural analogs thereof, and any combination thereof; and/or the styrenic repeat unit is chosen from a 4-methoxystyrene repeat unit, structural analogs thereof, and any combination thereof.

In various examples, the PCVE comprises one or more end group(s) chosen independently from cyclic ether end group(s), cyclic vinyl ether end group(s), quencher end group(s), alkyl end groups, alkoxy end groups, and any combination thereof. In various examples, the PVE comprises one or more domain(s) and the domain(s) is/are, independently, at least partially or completely atactic, isotactic, isoenriched, syndiotactic, syndioenriched, or any combination thereof. In various examples, the PVE comprises one or more domain(s) and the domain(s) is/are, independently, at least partially or completely crystalline, amorphous, or any combination thereof. In various examples, the PCVE exhibits one or more or all of the following: a tensile strength (σ) of from about 50 megapascal (MPa) to about 80 MPa; a strain at break (ε) of from about 4% to about 50%; a Young's modulus (E) of from about 2 gigapascal (GPa) to about 3 GPa; a toughness of from about 1 MPa to about 25 MPa; a glass transition temperature (Tg) of from about 130° C. or greater; a thermal stability of 5% mass loss at from about 350° C. to about 370° C.; an optical clarity of about 90% transmission or greater; a permeability of water vapor of about 3 g·mm/m²·day or less; a permeability of gas of about 1.5 Barrer or less; or partial or complete degradability. In various examples, the PCVE is in the form of a flake, a pellet, a powder, a granule, a particle, a bead, a bar, a film, a fiber, a sheet, a monolith, a solution, an emulsion, or any combination thereof.

In an aspect, the present disclosure provides compositions (e.g., PCVE compositions). In various examples, a PCVE composition comprises one or more PCVE(s) as described herein. In various examples, a PCVE composition further comprising one or more additive(s) chosen from heat stabilizer(s), oxidation inhibitor(s), plasticizer(s), and any combination thereof. In various examples, the composition is in the form of a flake, a pellet, a powder, a granule, a particle, a bead, a bar, a film, a fiber, a sheet, a monolith, a solution, an emulsion, or any combination thereof.

In an aspect, the present disclosure provides articles comprising one or more PCVE(s) as described herein. In various examples, the article is a molded article, an extruded article, a blown article, a cast article, a spun article, or any combination thereof. In various examples, the article is a coating, a sheet, a film, a fiber, a textile, a foam, a composite, or any combination thereof. In various examples, the article is a single use article, a packaging article, a biomedical article, an architectural article, an automotive article, an agricultural article, an electronic article, a drug delivery article, a wound closure article, a surgical suture, a medical implant, a tissue engineering construct, or any combination thereof. In various examples, the article is a wrapping, a bag, a container, a filler, a protector, a pad, a fastener, a cup, a bottle, a lid, a cutlery, a straw, or any combination thereof, or any combination thereof. In various examples, the article is degradable in soil, freshwater environments, saltwater environments, or the like, or any combination thereof.

### BRIEF DESCRIPTION OF THE FIGURES

For a fuller understanding of the nature and objects of the disclosure, reference can be made to the following detailed description taken in conjunction with the accompanying figures.

FIG. 1 shows a poly(2,3-dihydrofuran) (PDHF) as a strong, tough, and degradable thermoplastic sourced sustainably from a bioalcohol.

FIGS. 2A-2B show: (FIG. 2A) a controlled polymerization of 2,3-dihydrofuran (DHF) using a metal-free, single-component, and room temperature method. (FIG. 2B) A hydrogen bond donor (HBD) enables a polymerization of DHF in a green solvent cyclopentyl methyl ether (CPME).

FIGS. 3A-3B show. (FIG. 3A) gel permeation chromatography (GPC) traces of example PDHFs targeting various Mₙ. (FIG. 3B) Number-average molecular weight (Mₙ) increases linearly with respect to DHF conversion.

FIG. 4 shows stress-strain curves for example PDHFs compared to polycarbonate (PC) at a strain rate of 2 millimeters per minute (mm min⁻¹) to failure, indicated by x.

FIG. 5 shows melt stability of a PDHF evaluated through complex viscosity (η*) monitored at 180° C. with 0.1% oscillatory strain applied at a frequency of 0.1 radian per second (rad sec⁻¹) for 20 min.

FIG. 6 shows frequency sweeps of example PDHF-52, PDHF-84, and PDHF-198 showing the effect of Mₙ on complex viscosity (11*).

FIGS. 7A-7D show example PDHF films demonstrate desirable optical properties (Transmittance at 380-700 nm of >89% and Refractive Index at 589 nm of 1.51 (FIG. 7A) and moderate permeability for O₂ (FIG. 7B), CO₂ (FIG. 7C), and water vapor (FIG. 7D).

FIGS. 8A-8B show: (FIG. 8A) facile oxidative degradation of a PDHF using Fenton's reagent (Fe(II)/H₂O₂) reduced the polymer to oligomers over 48 hours. (FIG. 8B) Gel permeation chromatography traces show a clear decrease in molecular weight.

FIG. 9 shows a PDHF as a next-generation sustainable thermoplastic provided from an efficient bioalcohol source and with robust material properties and facile degradability.

FIG. 10 shows GPC traces of example PDHFs of entries 7-10 of Table 1; FIG. 2B, polymerizations of example PDHFs in CPME.

FIG. 11 shows GPC traces of example PDHFs of entries 1-10 of Table 2, polymerization of example PDHFs in DCM over time.

FIG. 12 shows mechanisms for an example PDHF deprotonation and chain transfer (top) and an example PDHF chain coupling (bottom).

FIG. 13 shows a quantitative ¹H NMR in deuterated chloroform (CDCl₃) of a PDHF.

FIG. 14 shows a quantitative ¹³C NMR in CDCl₃ of a PDHF.

FIG. 15 shows a quantitative ¹³C NMR in 1,1,2,2-tetrachloroethane-d2 of a PDHF, 15 kg/mol.

FIG. 16 shows a quantitative ¹³C NMR in 1,1,2,2-tetrachloroethane-d2 of a PDHF, 30 kg/mol.

FIG. 17 shows a quantitative ¹³C NMR in 1,1,2,2-tetrachloroethane-d2 of a PDHF, 47 kg/mol.

FIG. 18 shows stress-strain curves for a PDHF-53.

FIG. 19 shows stress-strain curves for a PDHF-78.

FIG. 20 shows stress-strain curves for a PDHF-140.

FIG. 21 shows stress-strain curves for a PDHF-198.

FIG. 22 shows stress-strain curves for a PC-45.

FIG. 23 shows a master curve for a PDHF.

FIGS. 24A-24C show frequency sweeps of a PDHF-53 (FIG. 24A), a PDHF-78 (FIG. 24B), and a PDHF-198 (FIG. 24C) with G′ (filled triangles), G″ (open triangles), and Tan(S) (circles) plotted.

FIG. 25 shows a strain sweep of a PDHF performed from 0.1 to 100% strain, at 1 Hz, 180° C.

FIG. 26 shows a temperature sweep of a PDHF performed from 125 to 200° C. at 0.1% strain, 1 Hz.

FIG. 27 shows a Differential Scanning Calorimetry (DSC) curve of a PDHF (126 kg/mol). The T_{g} was observed at 135° C.

FIG. 28 shows a Thermal Gravimetric Analysis (TGA) curve of a PDHF. 95% weight loss reported at 364° C.

FIG. 29 shows transmittance and refractive index of a PDHF film measured across visible wavelengths (380-700 nm).

FIGS. 30A-30B show: (FIG. 30A) O₂ and (FIG. 30B) CO₂ permeability of a PDHF film.

FIG. 31 shows an inverse plot of Mₙ vs. time for a PDHF degradation.

FIG. 32 shows a ¹H NMR spectra of a PDHF and degradation product.

FIG. 33 shows a ¹³C NMR spectra of a PDHF degradation product.

FIG. 34 shows FTIR spectra of a PDHF and a degradation product.

FIG. 35 shows a proposed mechanism for accelerated oxidative degradation of a PDHF.

FIGS. 36A-36C show: (FIG. 36A) statistical polymerization of DHF and isobutyl vinyl ether (IBVE) with a PCCP. (FIG. 36B) SEC traces of example PDHF copolymers show comparable molecular weights. (FIG. 36C) Slightly lower tensile strength for example PDHF copolymers when compared to a PDHF.

FIG. 37 shows a Kelen-Tüdős Plot of DHF and IBVE copolymerization used to estimate reactivity ratios.

### DETAILED DESCRIPTION OF THE DISCLOSURE

Although claimed subject matter will be described in terms of certain examples, other examples, including examples that do not provide all of the benefits and features set forth herein, are also within the scope of this disclosure. Various structural, logical, and process step changes may be made without departing from the scope of the disclosure.

As used herein, unless otherwise stated, “about,” “approximately,” “substantially,” or the like, when used in connection with a measurable variable such as, for example, a parameter, an amount, a temporal duration, or the like, are meant to encompass variations of, for example, a specified value including, for example, those within experimental error (which can be determined by for example, a given data set, an art accepted standard, and/or with a given confidence interval (e.g. 90%, 95%, or more confidence interval from the mean), such as, for example, variations of +/−10% or less, +/−5% or less, +/−1% or less, and +/−0.1% or less of and from the specified value), insofar such variations are appropriate to perform in the context of the disclosure. As used herein, the terms “about,” “approximate,” “at or about,” and “substantially” can mean that the amount or value in question can be the exact value or a value that provides equivalent results or effects as recited in the sample claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of skill in the art such that, for example, equivalent results, effects, or the like are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also, unless otherwise stated, include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further disclosure. For example, if the value “about 10” is disclosed, then “10” is also disclosed.

As used herein, unless otherwise stated, the term “group” refers to a chemical entity that is monovalent (i.e., comprises one terminus that can be covalently bonded to other chemical species), divalent, or polyvalent (i.e., comprises two or more termini that can be covalently bonded to other chemical species). The term “group” also includes radicals (e.g., monovalent and multivalent, such as, for example, divalent radicals, trivalent radicals, and the like). Illustrative, non-limiting examples of groups include:

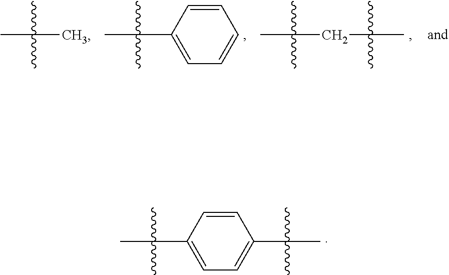

As used herein, unless otherwise indicated, the term “alkyl group” refers to branched or unbranched hydrocarbon groups that include only single bonds between carbon atoms (not including substituent(s), if any). In various examples, an alkyl group is a saturated group. In various examples, an alkyl group is a C₁ to C₃₀ alkyl group, including all integer numbers of carbons and ranges of numbers of carbons therebetween (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉ C₂₀, C₂₁, C₂₂, C₂₃, C₂₄, C₂₅, C₂₆, C₂₇, C₂₈, C₂₉, and C₃₀, C₁ to C₁₀, C₃ to C₁₀, and C₅ to C₁₀). In various examples, an alkyl group is a cycloalkyl group, e.g., a monocycloalkyl group or a polycycloalkyl group (e.g. bicyclic and the like). In various examples, a cycloalkyl group is a C₁ to C₁₀ cycloalkyl group, including all integer numbers of carbons and ranges of numbers of carbons therebetween (e.g., C₁, C₂, C₃, C₄, C₅, C₆, C₇, C₈, C₉, and C₁₀, C₃ to C₁₀, and C₅ to C₁₀). In various examples, a monocycloalkyl group is a C₃ to C₁₀ monocycloalkyl group, including all integer numbers of carbons and ranges of numbers of carbons therebetween (e.g., C₃, C₄, C₅, C₆, C₇, C₈, C₉, and C₁₀). In various examples, a polycycloalkyl group is a C₅ to C₁₀ polycycloalkyl group including all integer numbers of carbons and ranges of numbers of carbons therebetween (e.g., C₅, C₆, C₇, C₈, C₉, and C₁₀). In various examples, a polycycloalkyl group is a C₁ to C₃₀ alkyl group, including all integer numbers of carbons and ranges of numbers of carbons therebetween (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉ C₂₀, C₂₁, C₂₂, C₂₃, C₂₄, C₂₅, C₂₆, C₂₇, C₂₈, C₂₉, and C₃₀, C₁ to C₁₀, C₃ to C₁₀, and C₅ to C₁₀).

In various examples, an alkyl group is unsubstituted or substituted with one or more substituent group(s). Examples of substituent groups include, but are not limited to, various substituents such as, for example, halide groups (—F, —Cl, —Br, and —I), aliphatic groups (e.g., alkyl groups (e.g., a C₁ to C₃₀ alkyl groups (e.g., methyl, ethyl, propyl, and the like), monocycloalkyl groups (e.g., cyclohexyl, cyclopentyl, and the like), polycycloalkyl groups (e.g., bicyclic groups, and the like), alkenyl groups, alkynyl groups, and the like), halogenated aliphatic groups (e.g., trifluoromethyl group and the like), aryl groups (e.g., phenyl group and the like), polyaryl groups (e.g., pyrenyl group, and the like), halogenated aryl groups, hydroxyl groups, amine groups, nitro groups, cyano groups, isocyano groups, silyl groups, alkoxide groups, alcohol groups, ether groups, ketone groups, carboxylate groups, carboxylic acid groups, ester groups, amide groups, thioether groups, structural analogs thereof, and the like, and any combination thereof. Examples of alkyl groups include, but are not limited to, methyl groups, ethyl groups, propyl groups, butyl groups, isopropyl groups, tert-butyl groups, cyclohexyl groups, and structural analogs thereof. A substituent group of an alkyl group can be further substituted with one or more substituent group(s) described herein.

As used herein, unless otherwise stated, an alkoxy group comprises an alkyl group as used herein. In various examples, an alkoxy group is derived from an alkyl alcohol. Examples of alkoxy groups include, but are not limited to, alkoxy groups derived from naturally occurring alcohols, whether naturally obtained or synthetically prepared (e.g., methanol, menthol, cholesterol, and the like).

As used herein, unless otherwise indicated, the term “aryl group” refers to C₅ to C₃₀ aromatic or partially aromatic carbocyclic groups, including all integer numbers of carbons and ranges of numbers of carbons therebetween (e.g., C₅, C₆, C₇, C₈, C₉, C₁₀, C₁₁, C₁₂, C₁₃, C₁₄, C₁₅, C₁₆, C₁₇, C₁₈, C₁₉ C₂₀, C₂₁, C₂₂, C₂₃, C₂₄, C₂₅, C₂₆, C₂₇, C₂₈, C₂₉, and C₃₀). Aryl groups may comprise polyaryl groups such as, for example, fused ring groups, biaryl groups, and the like, and any combination thereof. In various examples, the aryl group is unsubstituted or substituted with one or more substituent group(s). Examples of substituent groups include, but are not limited to, substituents such as, for example, halide groups (—F, —Cl, —Br, and —I), aliphatic groups (e.g., alkyl groups, alkenyl groups, alkynyl groups, and the like), halogenated aliphatic groups (e.g., trifluoromethyl group and the like), aryl groups, halogenated aryl groups, hydroxyl groups, amine groups, nitro groups, cyano groups, isocyano groups, silyl groups, alkoxide groups, alcohol groups, ether groups, ketone groups, carboxylate groups, carboxylic acid groups, ester groups, amide groups, thioether groups, structural analogs thereof, and the like, and any combination thereof. Aryl groups may contain hetero atoms, such as, for example, oxygen, nitrogen (e.g., pyridinyl groups and the like), sulfur, and the like, and any combination thereof. Examples of aryl groups include, but are not limited to, phenyl groups, biaryl groups (e.g., biphenyl groups and the like), fused ring groups (e.g., naphthyl groups and the like), hydroxybenzyl groups, tolyl groups, xylyl groups, furanyl groups, benzofuranyl groups, indolyl groups, imidazolyl groups, benzimidazolyl groups, pyridinyl groups, structural analogs thereof, and the like. A substituent group of an aryl group can be further substituted with one or more substituent group(s) described herein.

As used herein, unless otherwise stated, an aryloxy group comprises an aryl group as used herein. In various examples, an aryloxy group is derived from an aryl alcohol (e.g., phenol, guaiacol, vanillin, syringol, cresol, sesamol, and the like).

As used herein, unless otherwise stated, the terms “pendant” or “pendant group” or “side group” or “ligand” are used interchangeably and refer to a group attached to a polymer backbone. A pendant group may be directly attached to a polymer backbone or a linking group may connect a pendant group to a polymer backbone.

As used herein, unless otherwise stated, the term “structural analog” refers to any compound or group that can be envisioned to arise from an original compound or group, respectively, if one atom or group of atoms, functional groups, or substructures is replaced with another atom or group of atoms, functional groups, substructures, or the like. In various examples, the term “structural analog” refers to any compound or group that is derived from an original compound or group, respectively, by a chemical reaction, where the compound or group is modified or partially substituted such that at least one structural feature of the original compound or group is retained. Examples of structural analogs include, but are not limited to isomers, homologs, derivatives, and the like. In various examples, a structural analog is not a functional analog (e.g., exhibits significantly different physical, chemical, biochemical, or pharmacological properties from the original compound or group).

As used herein, unless otherwise stated, the term “room temperature” refers to a temperature range of 18° C. to 30° C. (64° F. to 86° F.), including all 1° C. (1° F.) values and ranges therebetween.

The present disclosure describes poly(cyclic vinyl ethers) (PCVEs) and compositions thereof. The present disclosure also describes methods of making the PCVEs, compositions thereof, and uses of the PCVEs and compositions thereof.

In an aspect, the present disclosure provides methods of making PCVEs. In various examples, a method is used to make a PCVE as described herein. Non-limiting examples of methods of preparing PCVEs and/or PCVE compositions are described herein.

In various examples, a method of preparing PCVEs is a polymerization reaction. A polymerization reaction can be performed under various reaction conditions, such as for example, temperature, pressure, time, or any combination thereof. A polymerization reaction can comprise one or more step(s). In various examples, each step of a polymerization reaction can be performed under the same or different reaction conditions as other steps.

In various examples, a polymerization reaction comprises reacting one or more cyclic vinyl ether (CVE) monomer(s), where the polymerization reaction is catalyzed and/or initiated by one or more polymerization catalyst(s) and/or initiator(s). In various examples, the polymerization reaction forms a poly(cyclic vinyl ether) (PCVE) comprising a plurality of CVE repeat units, each CVE repeat unit independently formed from the polymerization of a CVE monomer. In various examples, a PCVE comprises (or is) a PCVE homopolymer, a PCVE copolymer, or any combination thereof (hereinafter referred to collectively, unless otherwise indicated, as a PCVE).

In various examples, a PCVE homopolymer is formed by the homo-polymerization of a single CVE monomer. In various examples, a PCVE copolymer is formed by the co-polymerization of two or more different monomers chosen from one or more CVE monomer(s), one or more additional monomer(s) (e.g. monomer(s) other than CVE monomer(s)), and any combination thereof. In various examples, at least a portion of or all of the two or more different monomers are added to a reaction mixture at the same time, at various times (e.g., individually at different times, in various combinations and/or amounts at desired times, etc.), or the like. In various examples, a PCVE block copolymer is formed by a method further comprising, after a desired conversion of a first monomer (e.g., a first CVE monomer or a first additional monomer), adding one or more second monomer(s) (e.g., different CVE monomer(s), additional monomer(s), or any combination thereof) to the reaction mixture. In various examples, a PCVE block copolymer is formed by adding different monomer(s) to the reaction mixture individually at different times (e.g. sequentially, following a desired conversion of any previously added monomer(s)), in various combinations and/or amounts at desired times, and the like).

In various examples, a method of preparing PCVEs comprises (or consists essentially of or consists of): forming a reaction mixture comprising one or more cyclic vinyl ether (CVE) monomer(s). In various examples, a reaction mixture further comprises one or more polymerization catalyst(s) and/or initiator(s), where a PCVE is formed. In various examples, a method further comprises holding a reaction mixture for a time and at a temperature, where a PCVE is formed.

A method can use various CVE monomer(s). In various examples, one or more or all of the CVE monomer(s) is/are C₄ or C₅ CVE monomers(s), including all integer number of carbons and ranges of numbers of carbons therebetween (e.g., C₄, C₅, and the like). In various examples, C₄ or C₅ CVE monomers(s) independently comprise(s) a C₄ or a C₅ CVE group, respectively (not including substituent(s), if any). In various examples, one or more or all of the CVE monomer(s) is/are chosen from dihydrofuran monomer(s), dihydropyran monomer(s), and the like, and any combination thereof.

In various examples, one or more or all CVE monomer(s) independently comprise(s) the following structure:

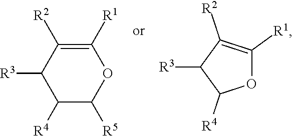

or a structural analog thereof, or the like. In various examples, R² is H or the like. In various examples, R¹ is independently at each occurrence chosen from H, alkyl groups, cycloalkyl groups, polycycloalkyl groups, and the like. In various examples, R³ and R⁴ and R⁵ are each independently at each occurrence chosen from H, alkyl groups, cycloalkyl groups, polycycloalkyl groups, and the like.

One or more or all CVE monomer(s) can each independently comprise a cyclic ether (CVE) group fused to a second cyclic group (fused ring CVE group). In various examples, R³ and R⁴, taken together, form a group independently at each occurrence chosen from cycloalkyl groups, polycycloalkyl groups, aryl groups, and the like, and R⁵, if present, is independently at each occurrence chosen from H, alkyl groups, cycloalkyl groups, polycycloalkyl groups, and the like. In various examples, R⁴ and R⁵, taken together, form a group independently at each occurrence chosen from cycloalkyl groups, polycycloalkyl groups, aryl groups, and the like, and R³ is independently at each occurrence chosen from H, alkyl groups, cycloalkyl groups, polycycloalkyl groups, and the like.

In various examples, one or more or all of CVE monomer(s) is/are C₄ monomer(s). In various examples, one or more or all C₄ CVE monomer(s) is/are chosen from 2,3-dihydrofuran, α-methyl-2,3-dihydrofuran, 5-methyl-2,3-dihydrofuran, benzofuran, 2-methyl benzofuran, 2,3-dihydropyran, structural analogs thereof, and the like, any combination thereof. In various examples, one or more or all of CVE monomer(s) is/are C₅ monomer(s). In various examples, one or more or all C₅ CVE monomer(s) is/are chosen from 3,4-dihydropyran, structural analogs thereof, and the like, any combination thereof.

A method can use various amounts of CVE monomer(s). In various examples, a reaction mixture comprises from about 20% to about 60% by volume, including all 0.1 volume % values and ranges therebetween (e.g., about 50% by volume), of CVE monomer(s), based on the total volume of the reaction mixture. In various examples, the concentration of CVE monomer(s) is about 50% based on the total volume of the reaction mixture.

A method can use various polymerization catalysts and/or initiators. In various examples, a reaction mixture comprises one or more polymerization catalyst(s) and/or initiator(s). In various examples, one or more or all polymerization catalyst(s) and/or initiator(s) is/are pentakis(carbonylcyclopentadiene) (PCCP) polymerization catalyst(s) and/or initiator(s), or the like, or any combination thereof. In various examples, one or more or all PCCP polymerization catalyst(s) and/or initiator(s) is/are alkoxy/aryloxy PCCP polymerization catalyst(s) and/or initiator(s), or the like, or any combination thereof.

In various examples, one or more or all alkoxy/aryloxy PCCP polymerization catalyst(s) and/or initiator(s) independently comprise(s) the following structure:

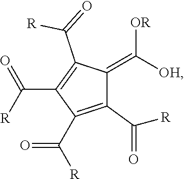

or a structural analog thereof, or the like. In various examples, one or more or all R and OR groups are, independently at each occurrence, chosen from alkoxy groups, aryloxy groups, and the like. In various examples, one or more or all alkoxy group(s), independently at each occurrence, comprise(s) an alkyl group. In various examples, one or more or all aryloxy group(s), independently at each occurrence, comprise(s) an aryl group. In various examples, one or more or all alkoxy/aryloxy PCCP polymerization catalyst(s) and/or initiator(s) is/are chosen from C₁-C₃₀ alkoxy/aryloxy PCCP polymerization catalyst(s) and/or initiator(s) and the like. In various examples, one or more or all alkoxy/aryloxy PCCP polymerization catalyst(s) and/or initiator(s) is/are chosen from methoxy PCCP polymerization catalyst(s) and/or initiator(s) and the like. In various examples, one or more or all R and OR group(s) is/are, independently at each occurrence, derived from cholesterol or menthol or methanol or the like. In various examples, one or more or all R and OR group(s) is/are, independently at each occurrence, chosen from:

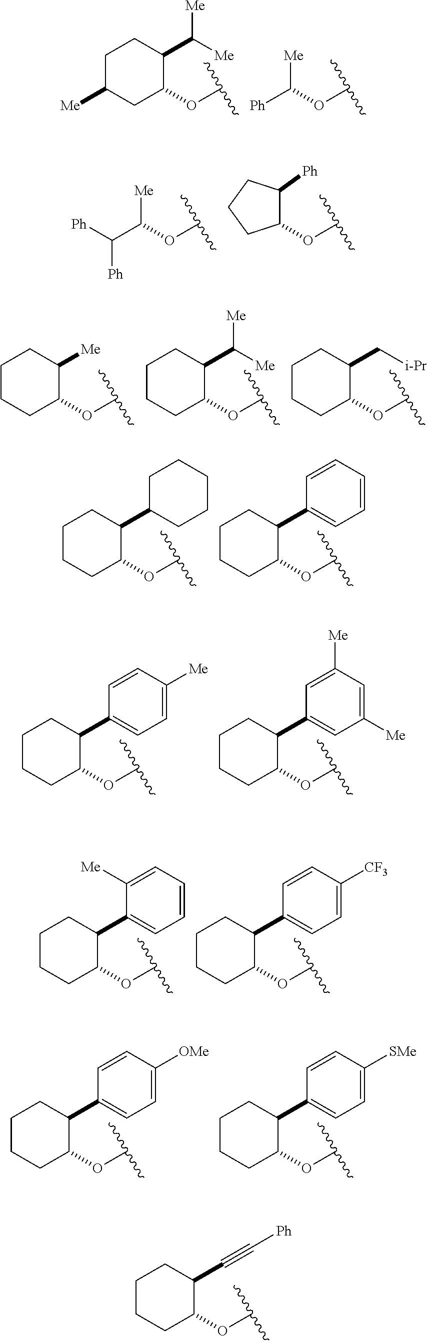

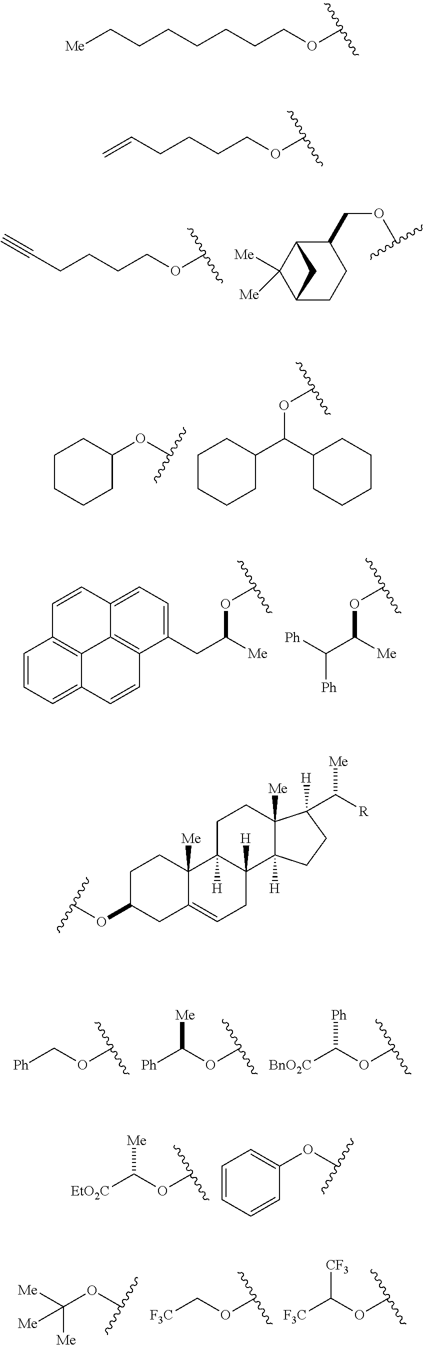

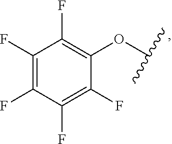 [SMILES: *Oc1c(F)c(F)c(F)c(F)c1F]

and any structural analog thereof, and the like, where

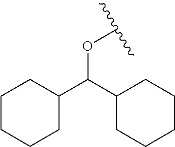 [SMILES: *OC(C1CCCCC1)C1CCCCC1]

is in the C protonated form. In various examples, one or more or all alkoxy/aryloxy PCCP polymerization catalyst(s) and/or initiator(s) is/are chiral.

A method can use various amounts of PCCP polymerization catalyst(s) and/or initiator(s) and/or hydrogen bond donor(s). In various examples, a reaction mixture comprises from about 0.02 mol % to about 1.5 mol %, including all 0.001 mol % values and ranges therebetween (e.g., from about 0.02 mol % to about 1 mol %, or from about 0.028 mol % to about 1.4 mol %), of alkoxy/aryloxy PCCP polymerization catalyst(s) and/or initiator(s), based on the total moles of monomer(s) and alkoxy/aryloxy PCCP polymerization catalyst(s) and/or initiator(s).

A method can form a PCVE copolymer. In various examples, a method forms a PCVE copolymer comprising two or more different CVE monomer(s) or the like. In various examples, a method forms a PCVE copolymer comprising one or more CVE monomer(s) or the like and further comprising one or more additional monomer(s) or the like.

A method can use various additional monomer(s). In various examples, a reaction mixture comprises one or more additional monomer(s). In various examples, a PCVE copolymer is formed by a method further comprising, after a desired conversion of one or more CVE monomer(s), adding one or more additional monomer(s) to the reaction mixture. In various examples, one or more or all additional monomer(s) is/are chosen from one or more acyclic vinyl ether (AVE) monomer(s), one or more styrenic monomer(s), and the like, and any combination thereof.

A method can use various AVE monomers. In various examples, one or more or all AVE monomer(s) is/are chosen from C₃ or greater AVE monomer(s), and the like, and any combination thereof. In various examples, one or more or all AVE monomer(s) each independently comprise(s) the following structure:

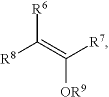

or the like. In various examples, R⁶, R⁷, and R⁸ are each H. In various examples, R⁹ is independently at each occurrence chosen from H, alkyl groups, cycloalkyl groups, polycycloalkyl groups, and the like. In various examples, one or more or all AVE monomer(s) is/are chosen from isobutyl vinyl ether (VE), cyclohexane VE, adamantane VE, ethyl VE, 2-chloroethyl VE, n-butyl VE, t-butyl VE, n-propyl VE, iso-propyl VE, dodecyl VE, phenyl VE, 2-ethylhexyl VE, polyethylene glycol methyl VE, cyclohexyl VE, and the like, and any combination thereof.

A method can use various styrenic monomers. In various examples, one or more or all styrenic monomer(s) each independently comprise(s) the following structure:

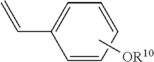

(e.g.,

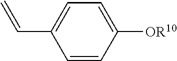

or the like) or the like. In various examples, R¹⁰ is independently at each occurrence chosen from H, alkyl groups, cycloalkyl groups, polycycloalkyl groups, and the like. In various examples, one or more or all styrenic monomer(s) is/are chosen from methoxystyrenic monomer(s) (e.g., 2-methoxystyrene, 3-methoxystyrene, 4-methoxystyrene, and the like, and any combination thereof) and the like.

A method can use various amounts of additional monomers. In various examples, the reaction mixture comprises from about 1 mol % to about 99 mol %, of the AVE monomer(s) and/or the styrenic monomer(s), based on the total moles of the AVE monomer(s), the styrenic monomer(s), and the CVE monomer(s). In various examples, AVE monomer(s) and/or the styrenic monomer(s) is/are added to the reaction mixture at from about 1 mol % to about 99 mol %, including all 0.1 mol % values and ranges therebetween, based on the total moles of the AVE monomer(s), the styrenic monomer(s), and the CVE monomer(s). In various examples, a reaction mixture comprises from about 20% to about 60% by volume, including all 0.1 volume % values and ranges therebetween, of total monomer(s) (e.g., CVE monomer(s), AVE monomer(s), and/or styrenic monomer(s) and the like), based on the total volume of the reaction mixture. In various examples, the concentration of total monomer(s) is about 50% based on the total volume of the reaction mixture.

In various examples, a reaction mixture further comprises one or more hydrogen bond donor(s). In various examples, one or more or all hydrogen bond donor(s) is/are chiral. In various examples, hydrogen bond donor(s) is/are polymerization catalyst(s) and the alkoxy/aryloxy PCCP(s) is/are polymerization initiator(s).

A method can use various hydrogen bond donors. In various examples, one or more or all hydrogen bond donor(s) is/are chosen from thiophosphoramide(s), sulfamide(s), thiourea(s), squaramide(s), and the like, and any combination thereof. In various examples, one or more or all thiophosphoramide(s) independently comprise(s) the following structure:

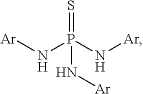

where Ar is independently at each occurrence an aryl group or the like, a structural analog thereof, or the like; one or more or all sulfamide(s) independently comprise(s) the following structure:

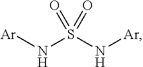

where Ar is independently at each occurrence an aryl group or the like, a structural analog thereof, or the like; one or more or all thiourea(s) independently comprise(s) the following structure:

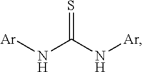

where Ar is independently at each occurrence an aryl group or the like, a structural analog thereof, or the like; one or more or all squaramide(s) independently comprise(s) the following structure:

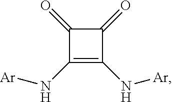

where Ar is independently at each occurrence an aryl group or the like, a structural analog thereof, or the like; and/or optionally, Ar is independently at each occurrence a di(fluoroalkyl)phenyl group.

A method can use various amounts of PCCP polymerization catalyst(s) and/or initiator(s) and/or hydrogen bond donor(s). In various examples, a reaction mixture comprises from about 0.02 mol % to about 1.5 mol %, including all 0.001 mol % values and ranges therebetween (e.g., from about 0.02 mol % to about 1 mol %, or from about 0.028 mol % to about 1.4 mol %), of alkoxy/aryloxy PCCP polymerization catalyst(s) and/or initiator(s), based on the total moles of monomer(s), alkoxy/aryloxy PCCP polymerization catalyst(s) and/or initiator(s), and hydrogen bond donor(s). In various examples, a reaction mixture comprises from about 0.005 mol % to about 1.5 mol %, including all 0.0001 mol % values and ranges therebetween (e.g., from about 0.0125 mol % to about 0.1 mol %) of hydrogen bond donor(s), based on the total moles of the monomer(s), the alkoxy/aryloxy PCCP(s) polymerization catalyst(s) and/or initiator(s), and the hydrogen bond donor(s).

A method can be carried out under various atmospheres. In various examples, a method is carried out in air. In various examples, a method is carried out in an inert atmosphere.

A method can be carried out with or without one or more solvent(s). In various examples, a method is carried out neat (a reaction mixture does not further comprise a solvent or the like). In various examples, a method is carried out using one or more solvent(s) (a reaction mixture comprises one or more solvent(s) or the like). In various examples, solvent(s) is/are chosen from organic solvent(s) and the like. In various examples, organic solvent(s) is/are chosen from chlorinated hydrocarbon(s) (e.g., dichloromethane (DCM), dichloroethane (DCE), and the like, and any combination thereof), alkanes (e.g., hexanes, cyclohexane, and the like, and any combination thereof), ethers (e.g., cyclopentyl methyl ether, diethyl ether, and the like, and any combination thereof), aromatic hydrocarbon(s) (e.g., toluene, and the like, and any combination thereof), and the like, and any combination thereof.

A method can be carried out at various reaction temperatures. In various examples, a method is carried out at about room temperature (e.g., from about 18° C. to about 30° C., including all 0.1° C. values and ranges therebetween, such as, for example, from about 20° C. to about 30° C. or about 22° C.), below room temperature (e.g., below about room temperature, such as for example, from about −78° C. to about room temperature, including all 0.1° C. values and ranges therebetween), or above room temperature (e.g., above room temperature up to or about a boiling point of solvent(s), if present) (e.g., room temperature to about 100° C. or above (e.g. including all 0.1° C. values and ranges therebetween), or any combination thereof (e.g., where each step is performed at a different temperature as other steps). In various examples, a method is carried out at about −78° C. to about 100° C., including all 0.1° C. values and ranges therebetween (e.g., from about 0° C. to about 40° C.). In various examples, a method is carried out without heating a reaction mixture with an exogeneous heat source. In various examples, a reaction mixture is heated with an exogeneous heat source. In various examples, a method is carried out without cooling a reaction mixture with an exogeneous cooling source. In various examples, a reaction mixture is cooled with an exogeneous cooling source.

A method can be carried out at various reaction pressures. In various examples, a method is carried out at atmospheric pressure (e.g., 1 standard atmosphere (atm) at sea level), at greater than atmospheric pressure (e.g. heating in a sealed pressurized reaction vessel and the like), at below atmospheric pressure (e.g., under vacuum (e.g., from about 1 mTorr or less to about 100 mTorr or less, including all 0.1 mTorr values and ranges therebetween, e.g., about 100 mTorr or less, about 50 mTorr or less, about 10 mTorr or less, or about 1 mTorr or less) and the like), or any combination thereof (e.g., where each step is performed at a different pressure as other steps).

A method can be carried out for various reaction times. The reaction time can depend on factors such as, for example, temperature, pressure, presence and/or efficiency of a catalyst and/or initiator, presence and/or intensity of an applied energy source, mixing (e.g., stirring or the like), or the like, or a combination thereof. In various examples, reaction times range from about minutes (e.g., 1 minute) to greater than about 28 hours, including all integer second values and ranges therebetween (e.g., from about 1 minute to about 24 hours or the like), or any combination thereof (e.g., where each step is performed at a different time as other steps). In various examples, a reaction mixture is held for a time sufficient to achieve a desired monomer conversion, a desired polymer molecular weight, or the like, or any combination thereof is reached. In various examples, a reaction mixture is held for a time sufficient to achieve a monomer (e.g., CVE monomer(s) additional monomer(s), or any combination thereof) conversion rate of from about 90% to about 100%, including all 0.1% values and ranges therebetween. In various examples, conversion is terminated by quenching a reaction mixture prior to, at, or after 100% conversion of monomers. In various examples, a reaction mixture is held for about 15 minutes to about 1 day. In various examples, a reaction time depends on equivalent(s) of catalyst(s) and/or initiator(s) and type of monomer(s).

In various examples, a PCVE prepared by a method as describe herein is isolated. Suitable polymer isolation methods are known in the art. In various examples, at least a portion or all of the PCVE is isolated by filtration, centrifugation, precipitation, chromatography, or the like.

A method can be a metal-free method. In various examples, a reaction mixture does not comprise a metal. In various examples, a polymerization catalyst and/or initiator does not comprise a metal.

In an aspect, the present disclosure provides methods of making articles of manufacture from PCVEs and/or PCVE compositions. In various examples, methods of making articles of manufacture are performed using PCVEs and/or PCVE compositions as described herein. Non-limiting examples of methods of making articles of manufacture comprising PCVEs and/or PCVE compositions are described herein.

An article of manufacturing comprising PCVEs and/or PCVE compositions can be made by various methods. In various examples, an article of manufacture is made by casting, molding, spin-coating, extrusion, blowing, spinning, or the like, or any combination thereof, one or more PCVE(s) and/or PCVE compositions (e.g., PCVE(s) and/or PCVE compositions as described herein and/or PCVE(s) and/or PCVE compositions formed by a method as described herein). In various examples, a method of preparing PCVEs further comprises forming an article of manufacture by casting, molding, spin-coating, extrusion, blowing, spinning, or the like, or any combination thereof, one or more PCVE(s) (e.g. as described herein).

In an aspect, the present disclosure provides poly(cyclic vinyl ethers) (PCVEs). In various examples, a PCVE comprises a PCVE polymer. In various examples, a PCVE is made by a method of the present disclosure. Non-limiting examples of PCVEs are described herein.

In various examples, a PCVE polymer is a linear PCVE polymer, a non-linear PCVE polymer (such, as for example, a branched polymer, a network polymer, cyclic polymer, cross-linked polymer, covalent organic framework, or the like), or the like, or any combination thereof. In various examples, a PCVE polymer comprises a PCVE backbone (e.g., a linear PCVE backbone, a non-linear PCVE backbone, or the like, or any combination thereof). In various examples, a PCVE backbone comprises a plurality of cyclic vinyl ether (CVE) repeat units covalently linked successively along the PCVE backbone. In various examples, the plurality of CVE repeat units independently comprise a CVE group, and the PCVE backbone comprises the CVE groups. In various examples, a PCVE comprises (or is) a PCVE homopolymer, a PCVE copolymer, or the like, or any combination thereof.

A PCVE can comprise various CVE repeat units. In various examples, the plurality of repeat units are derived from (e.g., formed by the polymerization of) one or more cyclic vinyl ether monomer(s) independently comprising a CVE group. In various examples a PCVE can comprise one or more CVE repeat unit(s). In various examples, CVE repeat unit(s) is/are all the same CVE repeat unit. In various examples, CVE repeat units(s) comprise two or more, three or more, four or more, different (e.g., chemically distinct (e.g., structurally distinct or the like) or the like) CVE repeat units. In various examples, one or more or all CVE repeat unit(s) is/are chosen from C₄-C₆ CVE repeat unit(s) and the like. In various examples, one or more or all CVE repeat unit(s) is/are chosen from dihydrofuran repeat unit(s), dihydropyran repeat unit(s), and the like, and any combination thereof.

A PCVE can comprise various structures (e.g., CVE repeat unit types, quantities, arrangements, and the like, and any combination thereof) or the like. A PCVE can comprise (or be) a PCVE homopolymer. In various examples, a PCVE homopolymer comprises a plurality of the same (e.g., chemically the same (e.g., structurally the same or the like) or the like) CVE repeat units (e.g., of the present disclosure and/or prepared by polymerizing the same CVE monomers of the present disclosure).

A PCE can comprise (or be) a PCVE copolymer. In various examples, a PCVE copolymer comprises two or more, three or more, four or more, different (e.g., chemically distinct (e.g., structurally distinct or the like) or the like) repeat units (e.g., CVE repeat units, additional repeat units, or any combination thereof) or the like. In various examples, a PCVE copolymer is a terpolymer or the like. In various examples, a PCVE copolymer comprises (or has) two or more different CVE repeat units or the like. In various examples, a PCVE copolymer comprises (or has) one or more additional repeat unit(s) or the like. In various examples, CVE repeat unit(s) and/or additional repeat unit(s) is/are present in a copolymer as one or more block(s) of a single repeat unit, distributed (e.g., randomly, tapered, or the like) in the copolymer, or the like, or any combination thereof. In various examples, a PCVE copolymer is a block copolymer, a random copolymer, an alternating copolymer, a tapered copolymer, a graft copolymer, a dendritic copolymer, or the like, or any combination thereof. In various examples, a PCVE block copolymer comprises (or has) one or more CVE block(s) (e.g., two or more CVE blocks or the like), each CVE block comprising one or more CVE repeat unit(s), where optionally one or more of the CVE block(s) comprise(s) CVE repeat unit(s) different than (e.g., distinct from or the like) one or more or all other CVE block(s). In various examples, a PCVE block copolymer comprises (or has) one or more additional blocks (e.g., two or more additional blocks or the like), each comprising one or more additional repeat unit(s), where optionally one or more of the additional block(s) comprise repeat unit(s) different than (e.g., distinct from or the like) one or more or all other additional block(s). In various examples, a PCVE block copolymer comprises (or has) one or more CVE block(s), one or more additional block(s), or the like, or any combination thereof. In various examples, a PCVE block copolymer comprises (or is) a PCVE multi-block copolymer (e.g., a PCVE di-block copolymer, a PCVE tri-block copolymer, or the like).

A PCVE can comprise various CVE repeat unit(s). In various examples, one or more or all of the CVE repeat unit(s) is/are C₄ or C₅ CVE repeat unit(s), including all integer number of carbons and ranges of numbers of carbons therebetween (e.g., C₄, C₅, and the like). In various examples, C₄ or C₅ CVE repeat unit(s) independently comprise(s) a C₄ or a C₅ CVE group, respectively (not including substituent(s), if any). In various examples, one or more or all of the CVE repeat unit(s) is/are chosen from dihydrofuran repeat unit(s), dihydropyran repeat unit(s), and the like, and any combination thereof.

In various examples, a PCVE (e.g., a PCVE homopolymer, a PCVE copolymer, or any combination thereof) comprises (or has) the following structure:

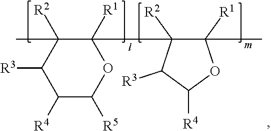

or a structural analog thereof, or the like. In various examples, R² is H or the like. In various examples, R¹ is independently at each occurrence chosen from H, alkyl groups, cycloalkyl groups, polycloalkyl groups, and the like. In various examples, R³ and R⁴ and R⁵ are each independently at each occurrence chosen from H, alkyl groups, cycloalkyl groups, polycycloalkyl groups, and the like.

A PCVE can comprise one or more CVE repeat unit(s), each independently comprising a cyclic ether (CVE) group fused to a second cyclic group (fused ring CVE group). In various examples, R³ and R⁴, taken together, form a group independently at each occurrence chosen from cycloalkyl groups, polycycloalkyl groups, aryl groups, and the like, and R⁵, if present, is independently at each occurrence chosen from H, alkyl groups, cycloalkyl groups, polycycloalkyl groups, and the like.

In various examples, R⁴ and R⁵, taken together, form a group independently at each occurrence chosen from cycloalkyl groups, polycycloalkyl groups, aryl groups, and the like, and R³ is independently at each occurrence chosen from H, alkyl groups, cycloalkyl groups, polycycloalkyl groups, and the like.

In various examples, one or more or all C₄ CVE repeat units(s) is/are chosen from 2,3-dihydrofuran repeat unit, α-methyl-2,3-dihydrofuran repeat unit, 5-methyl-2,3-dihydrofuran repeat unit, a benzofuran repeat unit, 2-methyl benzofuran repeat unit, 2,3-dihydropyran repeat unit, structural analogs thereof, and the like, any combination thereof. In various examples, one or more or all C₅ CVE repeat unit(s) is/are chosen from 3,4-dihydropyran repeat unit, structural analogs thereof, and the like, any combination thereof.

A PCVE comprising the same or different CVE repeat unit(s) can comprise various degree of polymerization, molecular weight, molecular weight polydispersity, and the like. In various examples, a PCVE comprises a mole ratio of the l repeat unit value to the m repeat unit (l:m) value is from 100:0 to 0:100, including all integer mole ratio values and ranges therebetween. In various examples, a PCVE comprises a l+m repeat unit value is from about 70 to about 17,200, including all integer repeat unit values and ranges therebetween (e.g., from about 70 to about 4300). In various examples, a PCVE comprises a molecular weight (Mn and/or Mw) of from about 5 kg/mol to about 500 kg/mol, including all 0.1 kg/mol values and ranges therebetween (e.g., from about 5 kg/mol to about 300 kg/mol, or from about 200 kg/mol to about 300 kg/mol, about 200 kg/mol, about 210 kg/mol, about 220 kg/mol, about 230 kg/mol, about 240 kg/mol, about 250 kg/mol, about 260 kg/mol, about 270 kg/mol, about 280 kg/mol, about 290 kg/mol, or about 300 kg/mol, or at about 150 kg/mole or greater, about 200 kg/mol or greater, about 250 kg/mol or greater, or about 300 kg/mol or greater).

In various examples, a PCVE comprises a polydispersity index (Mw/Mn) of from about 1.05 to about 10, including all 0.1 polydispersity index values and ranges therebetween (e.g., from about 1.1 to about 2.6). In various examples, a PCVE comprises a molecular weight between entanglements (Mₑ) of from about 2 kg/mol to about 5 kg/mol, including all 0.1 kg/mol Mₑ values and ranges therebetween. In various examples, a PCVE comprises a critical molecular weight (M_{c}) of from about 4 kg/mol to about 10 kg/mol, including all 0.1 kg/mol M_{c} values and ranges therebetween.

In various examples, a PCVE comprises (or is) a PCVE homopolymer or the like, where all of the CVE repeat unit(s) is/are the same CVE repeat unit(s). In various examples, a PCVE homopolymer comprises a molecular weight (Mn and/or Mw), of about 200 kg/mol or greater (e.g., about 250 kg/mol or greater, about 300 kg/mol or greater, about 350 kg/mol or greater, about 400 kg/mol or greater, or about 450 kg/mol or greater).

In various examples, a PCVE comprises (or is) a PCVE copolymer or the like, where the CVE repeat unit(s) comprise(s) different CVE repeat unit(s) (e.g., at least two or more different CVE repeat unit(s) or the like). In various examples, a PCVE copolymer comprises (or has) the same or different CVE repeat unit(s) and one or more additional repeat unit(s) or the like. In various examples, additional repeat unit(s) comprise(s) one or more substituent group(s). In various examples, the substituent group(s) is/are pendant group(s) attached to the PCVE backbone or the like. In various examples, additional repeat unit(s) is/are derived from (e.g. formed by polymerization of) additional monomer(s) independently comprising a substituent group.

A PCVE copolymer can comprise various additional repeat unit(s) or the like. In various examples, additional repeat unit(s) is/are all the same additional repeat unit. In various examples, additional repeat units(s) comprise two or more, three or more, four or more, different (e.g., chemically distinct (e.g., structurally distinct or the like) or the like) additional repeat unit(s), or the like. In various examples, a PCVE copolymer comprises (or has) the same or different CVE repeat unit(s) and the same or different additional repeat unit(s). In various examples, additional repeat unit(s) is/are chosen from one or more acyclic vinyl ether (AVE) repeat unit(s), one or more styrenic ether repeat unit(s), and the like, and any combination thereof.

A PCVE copolymer can comprise various structures (e.g., CVE repeat unit structures and/or additional repeat unit types, quantities, arrangements, and the like, and any combination thereof) or the like. In various examples, a PCVE copolymer comprises (or has) the following structure:

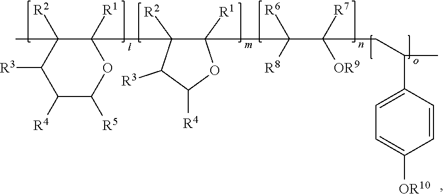

or a structural analog thereof, or the like. In various examples, R², R⁶, R⁷, and R⁸ are each H. In various examples, R¹ and R⁹ are independently at each occurrence chosen from H, alkyl groups, cycloalkyl groups, polycycloalkyl groups, and the like. In various examples, R¹⁰ are independently at each occurrence chosen from H, alkyl groups, cycloalkyl groups, polycycloalkyl groups, and the like. In various examples, R³ and R⁴ and R⁵ are each independently at each occurrence chosen from H, alkyl groups, cycloalkyl groups, polycycloalkyl groups, and the like.

A PCVE can comprise one or more CVE repeat unit(s), each independently comprising a cyclic ether (CVE) group fused to a second cyclic group (fused ring CVE group). In various examples, R³ and R⁴, taken together, form a group independently at each occurrence chosen from cycloalkyl groups, polycycloalkyl groups, aryl groups, and the like, and R⁵, if present, is independently at each occurrence chosen from H, alkyl groups, cycloalkyl groups, polycycloalkyl groups, and the like.

In various examples, R⁴ and R⁵, taken together, form a group independently at each occurrence chosen from cycloalkyl groups, polycycloalkyl groups, aryl groups, and the like, and R³ is independently at each occurrence chosen from H, alkyl groups, cycloalkyl groups, polycycloalkyl groups, and the like.

In various examples, one or more or all C₅ CVE repeat units(s) is/are chosen from 2,3-dihydrofuran repeat unit, α-methyl-2,3-dihydrofuran repeat unit, 5-methyl-2,3-dihydrofuran repeat unit, a benzofuran repeat unit, 2-methyl benzofuran repeat unit, 2,3-dihydropyran repeat unit, structural analogs thereof, and the like, any combination thereof. In various examples, one or more or all C₆ CVE repeat unit(s) is/are chosen from 3,4-dihydropyran repeat unit, structural analogs thereof, and the like, any combination thereof.

In various examples, AVE repeat unit(s) is/are chosen from isobutyl vinyl ether (VE) repeat unit, cyclohexane VE repeat unit, adamantane VE repeat unit, ethyl VE repeat unit, 2-chloroethyl VE repeat unit, n-butyl VE repeat unit, t-butyl VE repeat unit, n-propyl VE repeat unit, iso-propyl VE repeat unit, dodecyl VE repeat unit, phenyl VE repeat unit, 2-ethylhexyl VE repeat unit, polyethylene glycol methyl VE repeat unit, cyclohexyl VE repeat unit, structural analogs thereof, and the like, and any combination thereof. In various examples, styrenic repeat unit(s) is/are chosen from methoxystyrenic repeat unit(s) (e.g., 2-methoxystyrene repeat unit, 3-methoxystyrene repeat unit, 4-methoxystyrene repeat unit, and the like, and any combination thereof), structural analogs thereof, and the like, and any combination thereof.

A PCVE copolymer comprising the same or different CVE repeat unit(s) and the same or different additional repeat unit(s) can comprise various degree of polymerization, molecular weight, molecular weight polydispersity, and the like. In various examples, a PCVE copolymer comprises a mole ratio of the l, m, or l+m repeat unit value to the n, o, or n+o repeat unit value is from 99:1 to 1:99, including all integer mole ratio values and ranges of mole ratio values therebetween. In various examples, only one of the l repeat unit value and the m repeat unit value is zero. In various examples, only one of the n repeat unit value and the o repeat unit value is zero. In various examples, the l, m, or l+m repeat unit value is from about 70 to about 4300, including all integer values and ranges therebetween. In various examples, and where the n, o, or n+o repeat unit value is from about 10 to about 3000, including all integer values and ranges therebetween.

In various examples, a PCVE copolymer comprises (or is) a statistical PCVE copolymer or the like, the statistical PCVE copolymer comprising a mole ratio of the l, m, or l+m repeat unit value to the n, o, or n+o repeat unit value of from about 99:1 to about 1:99. In various examples, a PCVE copolymer comprises (or is) a block PCVE copolymer or the like, the block PCVE copolymer comprising a mole ratio of the l, m, or l+m repeat unit value to the n, o, or n+o repeat unit value of from about 5:95 to about 90:10, including all 0.1 mole ratio values and ranges therebetween (e.g., from about 5:95 to about 70:30, from about 5:95 to about 60:40, from about 5:95 to about 50:50, from about 5:95 to about 40:70, from about 5:95 to about 25:75, from about 10:90 to about 90:10, from about 10:90 to about 70:30, from about 10:90 to about 60:40, from about 10:90 to about 50:50, from about 10:90 to about 40:70, or from about 10:90 to about 25:75). In various examples, a PCVE copolymer comprises a molecular weight (Mₙ and/or Mw) of from about 5 kg/mol to about 500 kg/mol, including all 0.1 kg/mol values and ranges therebetween (e.g., from about 10 kg/mol to about 150 kg/mol).

A PCVE can comprise various end groups. In various examples, the PCVE comprises one or more end group(s), one or more or all end group(s) chosen independently from cyclic ether end group(s), cyclic vinyl ether end group(s), quencher end group(s) (e.g., acetal group(s), aldehyde group(s), hydroxyl group(s), ether group(s), and the like, and any combination thereof), alkyl end groups (e.g., methyl end group(s), and the like, and any combination thereof), alkoxy end groups e.g., methoxy end group(s), and the like, and any combination thereof), and any combination thereof.

A PCVE can comprise various structural features (e.g., degree and/or type of branching, tacticity, and the like), various morphological features (e.g., degree and/or type of crystallinity and the like), and the like, and any combination thereof. In various examples, a PCVE is a linear PCVE or a PCVE comprises one or more intrachain and/or interchain branches. In various examples, the PVE comprises one or more domain(s) and the domain(s) is/are, independently, at least partially or completely atactic, isotactic, isoenriched, syndiotactic, syndioenriched, or any combination thereof. In various examples, the PVE comprises one or more domain(s) and the domain(s) is/are, independently, at least partially or completely crystalline, amorphous, or any combination thereof. In various examples, a PCVE is an atactic PCVE homopolymer or an atactic PCVE copolymer. In various examples, the PCVE is at least partially or completely crystalline, semi-crystalline, amorphous, or the like. In various examples, the PVE comprises one or more domain(s) and the domain(s) is/are, independently, crystalline, semi-crystalline, amorphous, or the like. The crystallinity or lack thereof of the PCVE (or the presence of crystalline and/or semicrystalline and/or amorphous domains) can be determined by methods known in the art. In various examples, the crystallinity or lack thereof of the PCVE (or the presence of crystalline and/or semicrystalline and/or amorphous domains) is determined (e.g., measured or the like) by measured by powder x-ray diffraction (PXRD), small angle X-ray scattering (SAXS), differential scanning calorimetry (DSC), or the like.

A PCVE can exhibit various mechanical properties (e.g., strength, elongation at break, Young's modulus, toughness, and the like). In various examples, a PCVE exhibits a tensile strength (σ), e.g., measured by tensile testing as described herein or the like, of from about 50 MPa to about 80 MPa, including all 0.1 MPa values and ranges therebetween. In various examples, a PCVE exhibits a strain at break (ε), e.g., measured by tensile testing as described herein or the like, of from about 4% to about 50%. In various examples, a PCVE exhibits a Young's modulus (E), e.g., measured by tensile testing as described herein or the like, of from about 2.0 GPa to about 3.0 GPa, including all 0.1 GPa values and ranges therebetween (e.g., from about 2.1 GPa to about 3.0 GPa). In various examples, a PCVE exhibits a toughness, e.g., measured by tensile testing as described herein or the like, of from about 1 MPa to about 25 MPa, including all 0.1 MPa values and ranges therebetween (e.g., from about 1.1 MPa to about 20.9 MPa, or from about 1.5 MPa to about 20 MPa).

A PCVE can exhibit various thermal properties (e.g., melting point, glass transition temperature, and the like). In various examples, a PCVE exhibits a glass transition temperature (Tg), e.g., measured by differential scanning calorimetry (DSC) or the like, of about 130° C. or greater. In various examples, a PCVE exhibits a thermal stability, e.g., measured by thermogravometric analysis (TGA) or the like, of 5% mass loss at from about 350° C. to about 370° C., including all 0.1° C. values ranges therebetween (e.g., from about 360° C. to about 370° C.).

A PCVE can exhibit various optical properties. In various examples, a PCVE exhibits an optical clarity, e.g., measured by transmittance of light from 380 to 700 nm, or the like, of about 90% transmission or greater.

A PCVE can exhibit various barrier properties (such as for example, permeability of water vapor, one or more gas(s), and the like, and any combination thereof). In various examples, a PCVE exhibits a permeability of water vapor of about 3 g·mm/m²·day or less (e.g., about 2.7 about g·mm/m²·day or less, or about 2 g·mm/m²·day or less). In various examples, a PCVE exhibits a permeability of gas (e.g., oxygen, nitrogen, carbon dioxide, or the like, or any combination thereof) of about 1.5 Barrer or less (e.g., about 1.2 Barrer or less, or about 1 Barrer or less), or the like, or any combination thereof).

A PCVE can exhibit various degradation properties (e.g., various desirable degradation properties and the like, such as for example, chemical degradability, or the like, or any combination thereof). In various examples, a PCVE exhibits partial or complete degradability in soil, fresh or salt water, or the like, or any combination thereof.

A PCVE can have various forms. In various examples, a PCVE is in the form of a flake, a pellet, a powder, a granule, a particle, a bead, a bar, a film, a fiber, a sheet, a monolith, a solution, an emulsion, or the like, or any combination thereof.

In an aspect, the present disclosure provides PCVE compositions. In various examples, a PCVE composition comprises one or more PCVE polymers (PCVE(s) (e.g., of the present disclosure and/or prepared by a method of the present disclosure). Non-limiting examples of PCVE compositions are described herein.

In various examples, a PCVE composition further comprises one or more additive(s). In various examples, additive(s) is/are chosen from heat stabilizer(s), oxidation inhibitor(s) (e.g., phenolic antioxidant(s), and the like, and any combination thereof), plasticizer(s), and the like, and any combination thereof.

A PCVE composition can have various forms. In various examples, a PCVE composition is in the form of a flake, a pellet, a powder, a granule, a particle, a bead, a bar, a film, a fiber, a sheet, a monolith, a solution, an emulsion, or the like, or any combination thereof.

In an aspect, the present disclosure provides uses of PCVEs and PCVE compositions (e.g., PCVEs and/or PCVE compositions of the present disclosure and/or PCVE(s) prepared by a method of the present disclosure). Non-limiting examples of uses of PCVEs and PCVE compositions are described herein.

In various examples, PCVEs and/or PCVE compositions are used to prepare articles of manufacture. In various examples, an article of manufacture comprises one or more PCVE(s) and/or PCVE composition(s) of the present disclosure and/or one or more PCVE(s) prepared by a method of the present disclosure. Non-limiting examples of articles of manufacture made from PCVE polymers and PCVE compositions of the present disclosure are described herein.

An article of manufacture can be prepared by various methods. In various examples, an article of manufacture comprises a molded article, an extruded article, a blown article, a cast article, a spun article, or the like, or any combination thereof.

An article of manufacture can comprise various forms. In various examples, an article of manufacture comprises a coating, a sheet, a film (e.g., a free standing film or the like), a fiber, a textile, a solid article, a hollow article, a foam, a composite, or the like, or any combination thereof.

An article of manufacture can have various fields of use. In various examples, an article of manufacture comprises a single use article, a packaging article, a biomedical article, an architectural article (e.g. a window), an automotive article, an agricultural article, an electronic article, or the like, or any combination thereof.

An article of manufacture can have various biomedical uses. In various examples, an article of manufacture comprises a drug delivery article, a wound closure article, a surgical suture, a medical implant, a tissue engineering construct, or the like, or any combination thereof. In various examples, a biomedical article is also a single use article.

An article of manufacture can be a packaging article. In various examples, a packaging article comprises and/or a film, a wrapping, a sheet, a bag, a container, a filler, a protector, a pad, a fastener, a cup, a bottle, a lid, a cutlery, a straw, or the like, or any combination thereof. In various examples, a packaging article is also a single use article. In various examples, a packaging article is a food packaging article or the like (e.g. a single use food packaging article or the like).

In various examples, an article of manufacture is degradable (e.g., chemically degradable, and the like, and any combination thereof) in soil, freshwater environments, saltwater environments, or the like, or any combination thereof. In various examples, a degradable article is also article of manufacture comprises a single use article, a packaging article, a biomedical article, an automotive article, an agricultural article, an electronic article, or the like, or any combination thereof.

The following Statements describe various examples of methods, products and systems of the present disclosure and are not intended to be in any way limiting:

Statement 1. A poly(cyclic vinyl ether) (PCVE) comprising the following structure:

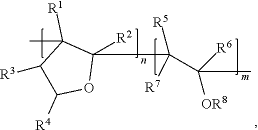

wherein: R¹, R⁵, R⁶, and R⁷ are each H; R² and R⁸ are each independently at each occurrence chosen from H, C₁-C₁₀ (e.g., C₁, C₂, C₃, C₄, C₅, C₆, C₇, C₈, C₉, and C₁₀, and the like) alkyl groups (such as, for example, methyl groups, isobutyl groups, and the like), C₁-C₁₀ (e.g., C₁, C₂, C₃, C₄, C₅, C₆, C₇, C₈, C₉, and C₁₀, and the like) cycloalkyl groups (such as, for example, cyclohexyl groups and the like), C₁-C₁₀ (e.g., C₁, C₂, C₃, C₄, C₅, C₆, C₇, C₈, C₉, and C₁₀, and the like) polycycloalkyl groups (such as, for example, adamantane groups and the like), and the like; R³ and R⁴ are each independently at each occurrence chosen from H, C₁-C₁₀ (e.g., C₁, C₂, C₃, C₄, C₅, C₆, C₇, C₈, C₉, and C₁₀, and the like) alkyl groups, C₁-C₁₀ (e.g., C₁, C₂, C₃, C₄, C₅, C₆, C₇, C₈, C₉, and C₁₀, and the like) cycloalkyl groups, C₁-C₁₀ (e.g., C₁, C₂, C₃, C₄, C₅, C₆, C₇, C₈, C₉, and C₁₀, and the like) polycycloalkyl groups, and the like, or R³ and R⁴ taken together form independently at each occurrence a C₁-C₁₀ (e.g., C₁, C₂, C₃, C₄, C₅, C₆, C₇, C₈, C₉, or C₁₀, or the like) cycloalkyl group, C₁-C₁₀ (e.g., C₁, C₂, C₃, C₄, C₅, C₆, C₇, C₈, C₉, or C₁₀, or the like) polycycloalkyl group, C₁-C₁₀ (e.g., C₁, C₂, C₃, C₄, C₅, C₆, C₇, C₈, C₉, or C₁₀, or the like) aryl group (such as, for example, a phenyl group or the like), and the like; and wherein the mole ratio of n to m is 100:0 to 1:99, including all integer 0.1 mole ratio values and ranges therebetween; and when m is 0, the PCVE is a PCVE homopolymer having a number average molecular weight (Mₙ and/or Mw), e.g., measured by gel permeation chromatography (GPC) or the like, of about 200 kg/mol or greater.
Statement 2. A poly(cyclic vinyl ether) (PCVE) according to Statement 1, wherein the PCVE comprises (or is) a block copolymer comprising one or more block(s) of n repeating units and one or more block(s) of m repeating units.
Statement 3. A poly(cyclic vinyl ether) (PCVE) according to Statement 1 or Statement 2, wherein the PCVE comprises (or has) a molecular weight between entanglements (Mₑ) of from about 2 kg/mol to about 5 kg/mol, including all 0.1 kg/mol values and ranges therebetween, and/or a critical molecular weight (Mc) of from about 4 kg/mol to about 10 kg/mol, including all 0.1 kg/mol values and ranges therebetween.
Statement 4. A poly(cyclic vinyl ether) (PCVE) according to any one of the preceding Statements, wherein the PCVE comprises (or has) one or more end group(s).
Statement 5. A poly(cyclic vinyl ether) (PCVE) according to any one of the preceding Statements, wherein the PCVE comprises (or has) a polydispersity index (Mw/Mn), e.g., measured by GPC or the like, of from about 1.1 to about 2.6, including all 0.1 values and ranges therebetween.
Statement 6. A poly(cyclic vinyl ether) (PCVE), e.g., a PCVE homopolymer, according to any one of the preceding Statements, wherein the PCVE exhibits one, more, or all of the following: a tensile strength (σ), e.g., measured by tensile testing as described herein or the like, of from about 50 MPa to about 80 MPa, including all 0.1 MPa values and ranges therebetween; a strain at break (E), e.g., measured by tensile testing as described herein or the like, of from about 4% to about 50%; a Young's modulus (E), e.g., measured by tensile testing as described herein or the like, of from about 2.0 GPa to about 3.0 GPa, including all 0.1 GPa values and ranges therebetween (e.g., from about 2.1 GPa to about 3.0 GPa); a toughness, e.g., measured by tensile testing as described herein or the like, of from about 1 MPa to about 25 MPa, including all 0.1 MPa values and ranges therebetween (e.g., from about 1.1 MPa to about 20.9 MPa, or from about 1.5 MPa to about 20 MPa); a glass transition temperature (Tg), e.g., measured by differential scanning calorimetry (DSC) or the like, of about 130° C. or greater; a thermal stability, e.g., measured by thermogravometric analysis (TGA) or the like, of 5% mass loss at from about 350° C. to about 370° C., including all 0.1° C. values ranges therebetween (e.g., from about 360° C. to about 370° C.) an optical clarity, e.g., measured by transmittance of light from 380 to 700 nm, or the like, of about 90% transmission or greater; desirable barrier properties (e.g., permeability of water vapor of about 3 g·mm/m²·day or less (e.g., about 2.7 about g·mm/m²·day or less, or about 2 g·mm/m²·day or less), permeability of gas (e.g., oxygen, nitrogen, carbon dioxide, or the like, or any combination thereof) of about 1.5 Barrer or less (e.g., about 1.2 Barrer or less, or about 1 Barrer or less), or the like, or any combination thereof); or desirable degradability (e.g., chemical degradability, biodegradability, or the like, or any combination thereof) (e.g., partial or complete degradability in soil, fresh or salt water, or the like, or any combination thereof).
Statement 7. A poly(cyclic vinyl ether) (PCVE) according to any one of the preceding Statements, wherein the PCVE is in the form of a flake, a pellet, a powder, a granule, a particle, a bead, a bar, a film, a fiber, a sheet, a monolith, a solution, an emulsion, or the like, or combinations thereof.
Statement 8. A composition comprising one or more poly(cyclic vinyl ether) (PCVE)(s) according to any one of the preceding according to any one of the preceding Statements and one or more additive(s).
Statement 9. A composition comprising one or more poly(cyclic vinyl ether) (PCVE)(s) according to any one of the preceding Statements, wherein the composition is in the form of a flake, a pellet, a powder, a granule, a particle, a bead, a bar, a film, a fiber, a sheet, a monolith, a solution, an emulsion, or the like, or any combination thereof
Statement 10. An article comprising or made from the composition according to any one of the preceding Statements in the form of a molded article, an extruded article, a blown article, a cast article, a spun article, or the like, or any combination thereof.
Statement 11. An article comprising or made from the composition according to any one of the preceding Statements in the form of a coating, a sheet, a film, a fiber, a textile, a solid article, a hollow article, a foam, a composite, or the like, or any combination thereof.
Statement 12. An article comprising or made from the composition according to any one of the preceding Statements in the form of a single use article, a packaging article, a biomedical article, an automotive article, an agricultural article, an electronic article, or the like, or any combination thereof.
Statement 13. An article comprising or made from the composition according to any one of the preceding Statements in the form of a drug delivery article, a wound closure article, a surgical suture, a medical implant, a tissue engineering construct, or the like, or any combination thereof.
Statement 14. An article comprising or made from the composition according to any one of the preceding Statements in the form of a film, a wrapping, a sheet, a bag, a container, a filler, a protector, a pad, a fastener, a cup, a bottle, a lid, a cutlery, a straw, or the like, or any combination thereof.
Statement 15. An article comprising or made from the composition according to any one of the preceding Statements, wherein the fabricated article is degradable in soil, freshwater environments, saltwater environments, or the like, or any combination thereof.
Statement 16. A method of preparing a poly(cyclic vinyl ether) (PCVE), the method comprising: forming a reaction mixture comprising: a plurality of one or more cyclic vinyl ether monomer(s), each cyclic vinyl ether monomer independently comprising the following structure:

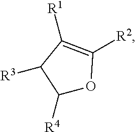

wherein: R¹ is H; R² is independently at each occurrence chosen from H, C₁-C₁₀ (e.g., C₁, C₂, C₃, C₄, C₅, C₆, C₇, C₈, C₉, and C₁₀, and the like) alkyl groups (such as, for example, methyl groups, isobutyl groups, and the like), C₁-C₁₀ (e.g., C₁, C₂, C₃, C₄, C₅, C₆, C₇, C₈, C₉, and C₁₀, and the like) cycloalkyl groups (such as, for example, cyclohexyl groups and the like), C₁-C₁₀ (e.g., C₁, C₂, C₃, C₄, C₅, C₆, C₇, C₈, C₉, and C₁₀, and the like) polycycloalkyl groups (such as, for example, adamantane groups and the like), and the like; R³ and R⁴ are each independently at each occurrence chosen from H, C₁-C₁₀ (e.g., C₁, C₂, C₃, C₄, C₅, C₆, C₇, C₈, C₉, and C₁₀, and the like) alkyl groups, C₁-C₁₀ (e.g., C₁, C₂, C₃, C₄, C₅, C₆, C₇, C₈, C₉, and C₁₀, and the like) cycloalkyl groups, C₁-C₁₀ (e.g., C₁, C₂, C₃, C₄, C₅, C₆, C₇, C₈, C₉, and C₁₀, and the like) polycycloalkyl groups, and the like, or R³ and R⁴ taken together form independently at each occurrence a C₁-C₁₀ (e.g., C₁, C₂, C₃, C₄, C₅, C₆, C₇, C₈, C₉, or C₁₀, or the like) cycloalkyl group, C₁-C₁₀ (e.g., C₁, C₂, C₃, C₄, C₅, C₆, C₇, C₈, C₉, or C₁₀, or the like) polycycloalkyl group, C₁-C₁₀ (e.g., C₁, C₂, C₃, C₄, C₅, C₆, C₇, C₈, C₉, or C₁₀, or the like) aromatic group (such as, for example, a benzyl group or the like), and the like; and a plurality of one or more pentakis(alkoxycarbonylcyclopentadiene) (alkoxy PCCP) polymerization catalyst(s) and/or initiator(s); and holding the reaction mixture for a time and at a temperature, wherein a PCVE is formed.
Statement 17. A method according to Statement 16, wherein the concentration of the cyclic vinyl ether monomer(s) is from about 20% to about 60% by volume, including all 0.1 volume % values and ranges therebetween, based on the total volume of the reaction mixture.
Statement 18. A method according to any one of Statements 16-17, wherein the pentakis(alkoxycarbonylcyclopentadiene) (alkoxy PCCP) polymerization catalyst(s) and/or initiator(s) is/are present in the reaction mixture at from about 1 mol % to about 0.02 mol %, including all 0.1 mol % values and ranges therebetween, based on the total moles of the cyclic vinyl ether monomer(s) and alkoxy PCCP polymerization catalyst(s) and/or initiator(s).
Statement 19. A method according to any one of Statements 16-18, wherein the reaction mixture is held at from about 0° C. to about 40° C., including all 0.1° C. values and ranges therebetween, and/or from 1 to 28 hours, including all 0.1 hour values and ranges therebetween.
Statement 20. A method according to any one of Statements 16-19, wherein the PCVE has the following structure:

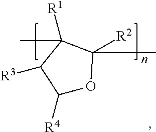

wherein: R¹ is H; R² is independently at each occurrence chosen from H, C₁-C₁₀ (e.g., C₁, C₂, C₃, C₄, C₅, C₆, C₇, C₈, C₉, and C₁₀, and the like) alkyl groups (such as, for example, methyl groups, isobutyl groups, and the like), C₁-C₁₀ (e.g., C₁, C₂, C₃, C₄, C₅, C₆, C₇, C₈, C₉, and C₁₀, and the like) cycloalkyl groups (such as, for example, cyclohexyl groups and the like), C₁-C₁₀ (e.g., C₁, C₂, C₃, C₄, C₅, C₆, C₇, C₈, C₉, and C₁₀, and the like) polycycloalkyl groups (such as, for example, adamantane groups and the like), and the like; R³ and R⁴ are each independently at each occurrence chosen from H, C₁-C₁₀ (e.g., C₁, C₂, C₃, C₄, C₅, C₆, C₇, C₈, C₉, and C₁₀, and the like) alkyl groups, C₁-C₁₀ (e.g., C₁, C₂, C₃, C₄, C₅, C₆, C₇, C₈, C₉, and C₁₀, and the like) cycloalkyl groups, C₁-C₁₀ (e.g., C₁, C₂, C₃, C₄, C₅, C₆, C₇, C₈, C₉, and C₁₀, and the like) polycycloalkyl groups, and the like, or R³ and R⁴ taken together form independently at each occurrence a C₁-C₁₀ (e.g., C₁, C₂, C₃, C₄, C₅, C₆, C₇, C₈, C₉, or C₁₀, or the like) cycloalkyl group, C₁-C₁₀ (e.g., C₁, C₂, C₃, C₄, C₅, C₆, C₇, C₈, C₉, or C₁₀, or the like) polycycloalkyl group, C₁-C₁₀ (e.g., C₁, C₂, C₃, C₄, C₅, C₆, C₇, C₈, C₉, or C₁₀, or the like) aromatic group (such as, for example, a benzyl group or the like), or the like; and n is 70 to 4300, including all integer n values and ranges therebetween.
Statement 21. A method according to any one of Statements 16-20, wherein the reaction mixture further comprises one or more organic solvent(s).
Statement 22. A method according to any one of Statements 16-21, further comprising:
adding, after a desired conversion (e.g., complete conversion) of the cyclic vinyl ether monomer(s), one or more vinyl ether monomer(s) comprising the following structure:

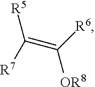

wherein: R⁵, R⁶, and R⁷ are each H; R⁸ is independently at each occurrence chosen from H, C₁-C₁₀ (e.g., C₁, C₂, C₃, C₄, C₅, C₆, C₇, C₈, C₉, and C₁₀, and the like) alkyl groups (such as, for example, methyl groups, isobutyl groups, and the like), C₁-C₁₀ (e.g., C₁, C₂, C₃, C₄, C₅, C₆, C₇, C₅, C₉, and C₁₀, and the like) cycloalkyl groups (such as, for example, cyclohexyl groups and the like), C₁-C₁₀ (e.g., C₁, C₂, C₃, C₄, C₅, C₆, C₇, C₈, C₉, and C₁₀, and the like) polycycloalkyl groups (such as, for example, adamantane groups and the like), and the like; and holding the reaction mixture for a time and at a temperature, wherein a PCVE copolymer is formed.
Statement 23. A method according to any one of Statements 16-22, wherein the vinyl ether monomer(s) are added at from about 1 mol % to about 99 mol %), including all 0.1 mol % values and ranges therebetween, based on the total moles of cyclic vinyl ether monomer(s) and vinyl ether monomer(s).
Statement 24. A method according to any one of Statements 16-23, wherein the PCVE copolymer has the following structure:

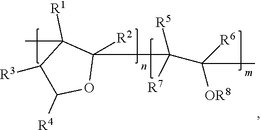

wherein: R¹, R⁵, R⁶, and R⁷ are each H; R² and R⁸ are each independently at each occurrence chosen from H, C₁-C₁₀ (e.g., C₁, C₂, C₃, C₄, C₅, C₆, C₇, C₈, C₉, and C₁₀, and the like) alkyl groups (such as, for example, methyl groups, isobutyl groups, and the like), C₁-C₁₀ (e.g., C₁, C₂, C₃, C₄, C₅, C₆, C₇, C₈, C₉, and C₁₀, and the like) cycloalkyl groups (such as, for example, cyclohexyl groups and the like), C₁-C₁₀ (e.g., C₁, C₂, C₃, C₄, C₅, C₆, C₇, C₈, C₉, and C₁₀, and the like) polycycloalkyl groups (such as, for example, adamantane groups and the like), and the like; R³ and R⁴ are each independently at each occurrence chosen from H, C₁-C₁₀ (e.g., C₁, C₂, C₃, C₄, C₅, C₆, C₇, C₈, C₉, and C₁₀, and the like) alkyl groups, C₁-C₁₀ (e.g., C₁, C₂, C₃, C₄, C₅, C₆, C₇, C₈, C₉, and C₁₀, and the like) cycloalkyl groups, C₁-C₁₀ (e.g., C₁, C₂, C₃, C₄, C₅, C₆, C₇, C₈, C₉, and C₁₀, and the like) polycycloalkyl groups, and the like, or R³ and R⁴ taken together form independently at each occurrence a C₁-C₁₀ (e.g., C₁, C₂, C₃, C₄, C₅, C₆, C₇, C₈, C₉, or C₁₀, or the like) cycloalkyl group, C₁-C₁₀ (e.g., C₁, C₂, C₃, C₄, C₅, C₆, C₇, C₈, C₉, or C₁₀, or the like) polycycloalkyl group, C₁-C₁₀ (e.g., C₁, C₂, C₃, C₄, C₅, C₆, C₇, C₈, C₉, or C₁₀, or the like) aromatic group (such as, for example, a benzyl group or the like), and the like; and wherein the mole ratio of n to m is 1:99 to 99:1, including all 0.1 mole ratio values and ranges therebetween.

The steps of the methods described in the various examples disclosed herein are sufficient to carry out the methods of the present disclosure. Thus, in an example, a method consists essentially of a combination of steps of the methods disclosed herein. In another example, a method consists of such steps.

The following examples are presented to illustrate the present disclosure. The examples are not intended to be limiting in any matter.

### Example 1

The following is an example of PCVEs and PCVE compositions, methods of making same, and methods of using same.

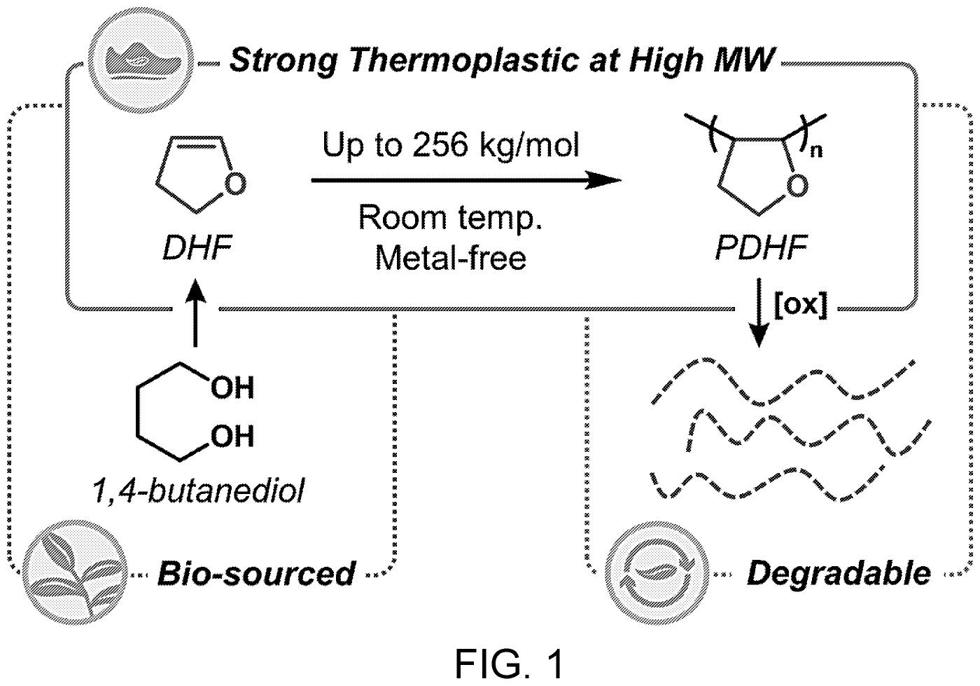

Described in this example is the synthesis and characterization of a strong thermoplastic made from 2,3-dihydrofuran (DHF), a monomer made in one step from 1,4-butanediol, a bioalcohol already produced on plant scale. A green, metal-free cationic polymerization was developed to enable the production of poly(2,3-dihydrofuran) (PDHF) with molecular weights of up to 256 kg/mol at room temperature (FIG. 1). Characterization of these polymers showed that PDHF possesses high tensile strength and toughness (70 and 14 MPa, respectively) comparable to commercial polycarbonate, high optical clarity, and good barrier properties to oxygen, carbon dioxide, and water. These properties make this material amenable to a variety of applications from food packaging to high strength windows. Importantly, a facile oxidative degradation process of PDHF was also developed, providing an end-of-life solution for PDHF materials.

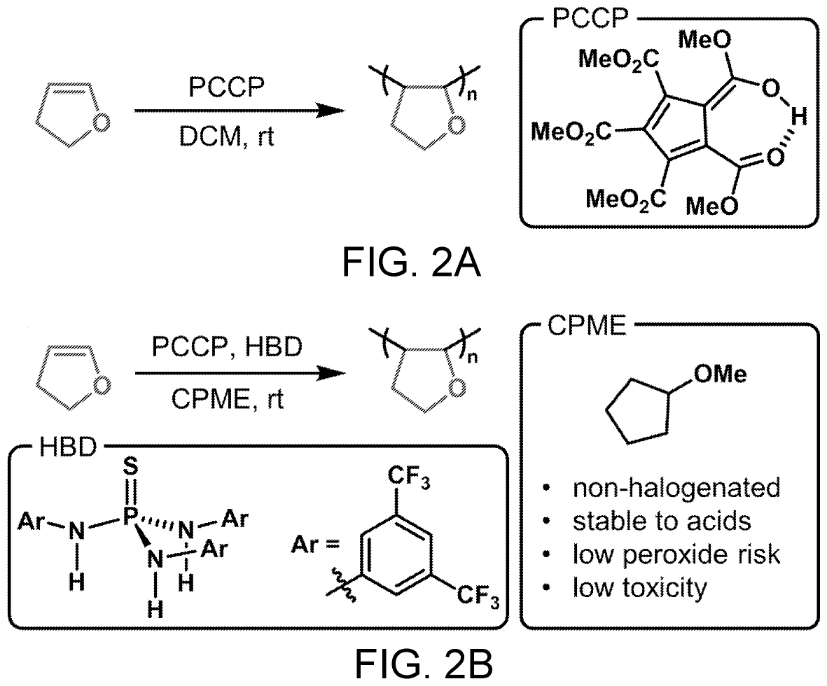

It was hypothesized that the strong coordination of the cyclopentadienyl anion of PCCP to the propagating oxocarbenium chain-end directed monomer addition and prevented termination from adventitious nucleophiles while tempering the reactivity of the chain-end, allowing for room temperature polymerization. It was posited that this new method could allow the synthesis and characterization of the properties of high Mₙ PDHF for the first time. The metal-free, room temperature synthesis of high molecular weight PDHF (FIG. 2A) is demonstrated. The polymerization method utilizes PCCP to target molecular weights from 20 to 250 kg/mol. Tensile characterization of PDHF demonstrated high ultimate tensile strength of up to 70 MPa, and high molecular weight samples achieved high toughness of up to 14 MPa. In addition, optically transparent films with low gas and water permeability were produced. As an end-of-life solution, a facile degradation of PDHF under oxidizing conditions was developed. This comprehensive study of PDHF provides a green method for the production of a strong and tough, high T_{g} thermoplastic from a readily available bioalcohol feedstock and provides an end-of-life strategy for this material.

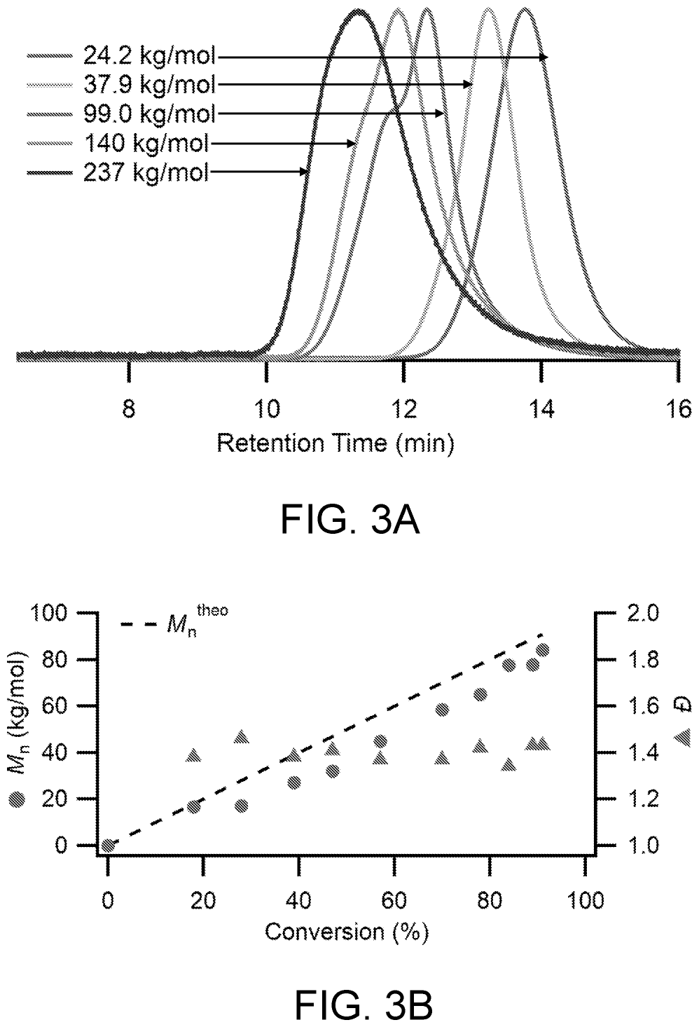

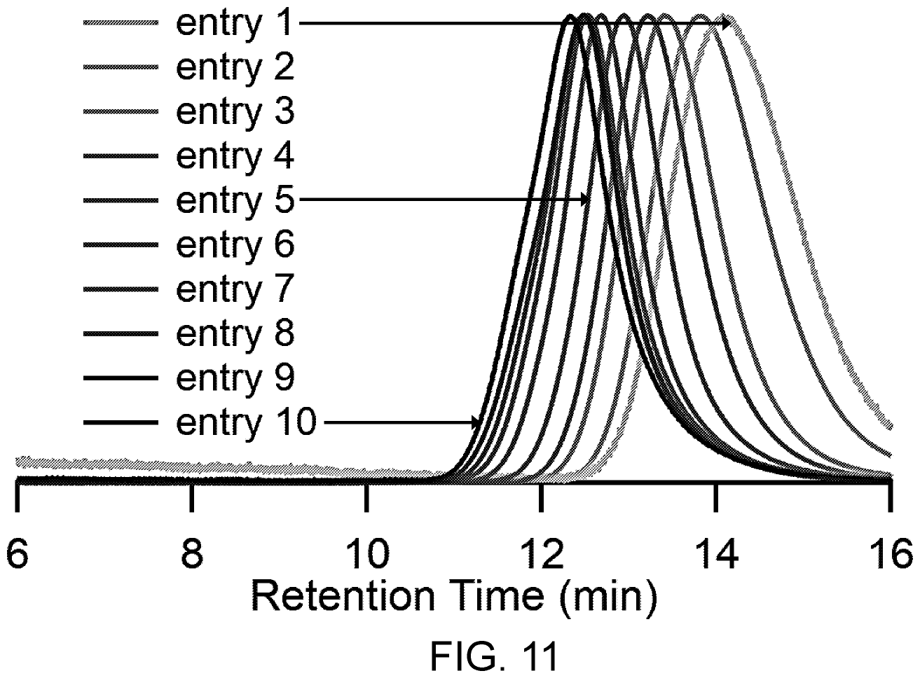

ROOM-TEMPERATURE POLYMERIZATION OF 2,3-DIHYDROFURAN. Initial studies focused on the polymerization of DHF using PCCP as the initiator. Mixing PCCP and DHF in a 1:290 ratio in DCM resulted in 99% conversion of the monomer after 2 hours (h) at room temperature to yield a 24.2 kg/mol polymer with a narrow dispersity (D) of 1.23 (FIG. 3A, top trace). Critically, the experimental (24 kg/mol) and theoretical (20.0 kg/mol) molar masses were in good agreement, suggesting that each PCCP led to a polymer chain and providing evidence that significant chain transfer was not occurring. By varying the ratio of the monomer to initiator a wide range of molar masses up to 256 kg/mol were successfully targeted (Table 1, entries 1-6). These high molar mass samples are an order of magnitude larger than what has been obtained by previous methods and, importantly, are still polymerized at room temperature. It was found when targeting molecular weights above 100 kg/mol, the distributions did broaden slightly (FIG. 3A); however, good agreement between theoretical and experimental Mₙs were maintained. Notably, this method was also amenable to large scale polymerizations, and 250 kg/mol PDHF was successfully produced on a 14 g scale with an isolated yield of 95% (Table 1, entry 6). Initial results suggested that the polymerization of DIF was proceeding through a chain-growth process with living characteristics. To further support this suggestion, a polymerization was monitored by NMR and gel permeation chromatography (Table 2, FIG. 3B, FIG. 11). As expected, linear growth in the molar mass of the polymer relative to conversion was observed. These initial results suggested that the polymerization of DHF was proceeding through a chain-growth process with living characteristics.

TABLE 1

| | | | Time | | Mₙ^{theo} | Mₙ^{exp} | |
|---|---|---|---|---|---|---|---|
| No. | [PCCP]:[DHF]:[HBD] | Solvent^{e} | (h) | Conversion^{f} | (kg/mol) | (kg/mol)^{g} | Ð |
| 1^{a} | 1:290:0 | DCM | 2 | 99% | 20.0 | 24.2 | 1.23 |
| 2^{a} | 1:572:0 | DCM | 4 | 94% | 37.6 | 37.9 | 1.27 |
| 3^{a} | 1:1420:0 | DCM | 17.5 | 99% | 100 | 99.0 | 1.50 |
| 4^{b} | 1:2140:0 | DCM | 19.5 | 94% | 142 | 140 | 1.51 |
| 5^{b} | 1:3570:0 | DCM | 26 | 99% | 250 | 237 | 1.49 |
| 6^{c} | 1:3530:0 | DCM | 22 | 99% | 248 | 256 | 1.62 |
| 7^{d} | 1:3570:0 | CPME | 168 | 39% | 97.5 | 82.3 | 2.16 |
| 8^{d} | 1:3570:1 | CPME | 77 | 91% | 229 | 214 | 1.42 |
| 9^{d} | 1:1427:1 | CPME | 23 | 96% | 96.0 | 89.2 | 1.61 |
| 10^{d} | 1:713:1 | CPME | 3 | 85% | 42.5 | 40.5 | 1.31 |

^{a}40 mmol DHF;
^{b}60 mmol DHF;
^{c}200 mmol DHF;
^{d}30 mmol DHF;
^{e}[DHF] = 6.7M;
^{f}Conversion calculated from 1H NMR;
^{g}Mn and Ð determined by light scattering.

TABLE 2

| | Reaction Time | DHF Conversion^{a} | Mₙ^{theo} | Mₙ^{b} | |
|---|---|---|---|---|---|
| No. | (h) | (%) | (kg/mol) | (kg/mol) | Ð |
| 1 | 0.5 | 18 | 18 | 16.5 | 1.38 |
| 2 | 1 | 28 | 28 | 17 | 1.46 |
| 3 | 2 | 39 | 39 | 27 | 1.38 |
| 4 | 3 | 47 | 47 | 32 | 1.41 |
| 5 | 4 | 57 | 57 | 44.9 | 1.37 |
| 6 | 5.5 | 70 | 70 | 58.3 | 1.37 |
| 7 | 6.5 | 78 | 78 | 65 | 1.42 |
| 8 | 7.5 | 84 | 84 | 77.5 | 1.34 |
| 9 | 8.5 | 89 | 89 | 77.9 | 1.43 |
| 10 | 9.25 | 91 | 91 | 84 | 1.43 |

^{a}Conversion was calculated from quantitative ¹H NMR;
^{b}Mₙ and Ð determined by light scattering.

Improved sustainability of this method was sought by employing a green solvent in place of halogenated DCM. The solubility of PDHF in tetrahydrofuran (THF) has been observed, but this is not an effective solvent for cationic polymerizations because it degrades by ring-opening under acidic conditions. In addition, THE readily forms peroxides which adds risk to large scale reactions. Cyclopentyl methyl ether (CPME) has recently captured attention in process chemistry as an alternative to THE and other ether solvents. It has been reported that CPME does not readily form peroxides like other ethers and exhibits low toxicity. In addition, its high boiling point and low energy of vaporization are favorable for solvent recovery. Because CPME has similar solubility properties to THE and is stable to acidic conditions, it was hypothesized that CPME would be an effective substitute for DCM.

First attempted was a polymerization targeting 250 kg/mol with standard conditions in CPME. This reaction reached only 39% conversion after 168 h, yielding an 82 kg/mol polymer with a broad dispersity of 2.16 (Table 1, entry 7). The slow rate of polymerization was attributed to the lower polarity of the solvent leading to a stronger interaction between the PCCP anion and polymer chain-end. To overcome this limitation, a hydrogen bond doner catalyst, tris(3,5-bis(trifluoromethyl)phenyl) thiophosphotriamide (HBD), was added to increase the reaction rate of PCCP-promoted reactions and reduce chain transfer (FIG. 2B). Addition of an equivalent of HBD relative to PCCP led to 91% conversion after 77 hours (h) and yielded a 214 kg/mol PDHF sample with a narrow dispersity (D=1.42) and good agreement between experimental and theoretical molar masses (Table 1, entry 8). Next, it was attempted to achieve various molar masses while maintaining excellent control over the polymerization (Table 1, entries 9 and 10). It was proposed that the HBD effectively weakens the association of the PCCP anion with the oxocarbenium ion chain-end to enable the use of the less polar CPME solvent as a green alternative to DCM.

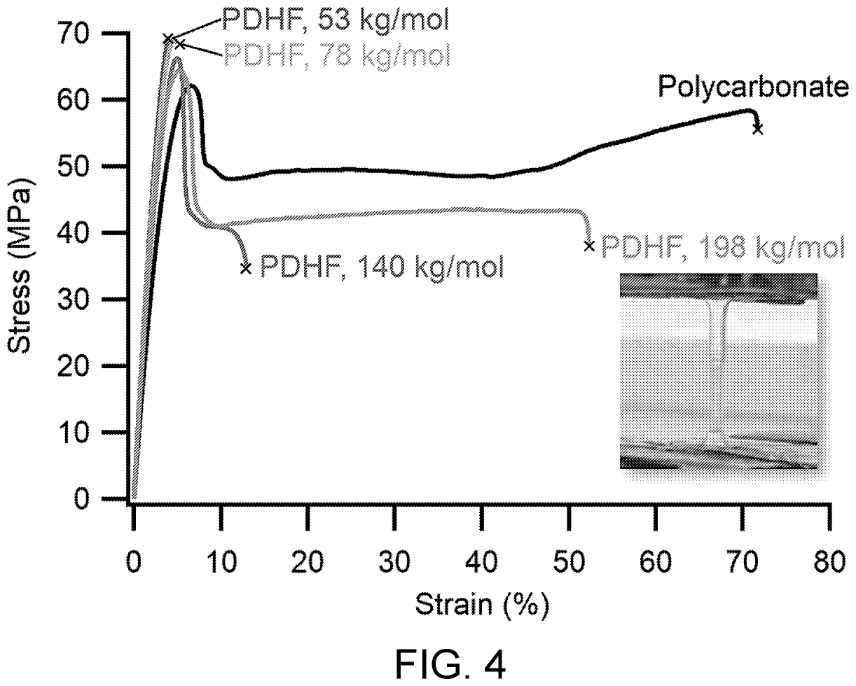

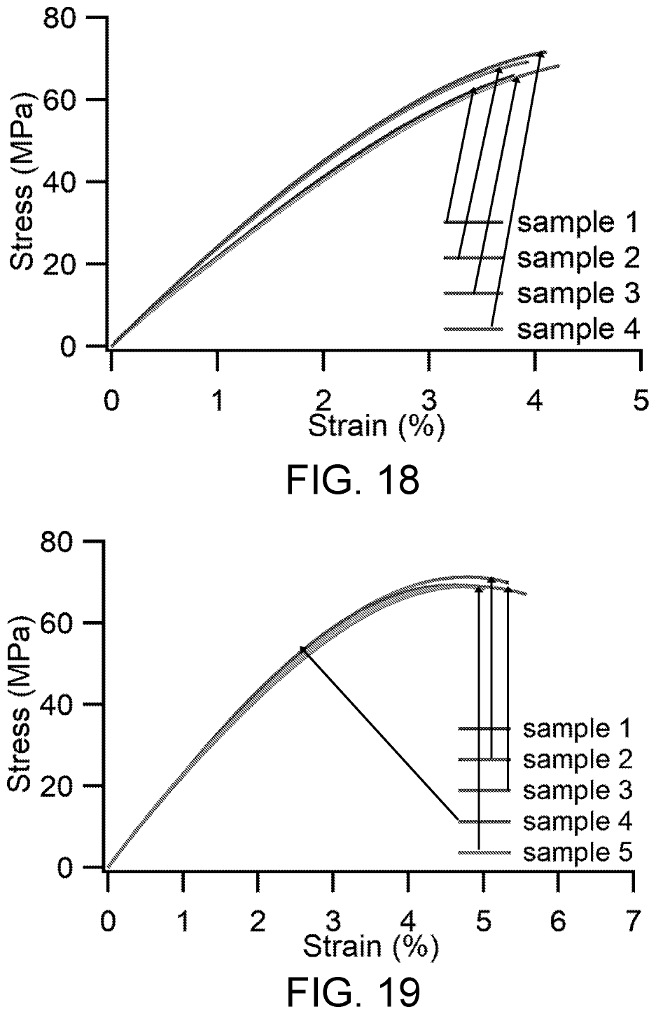

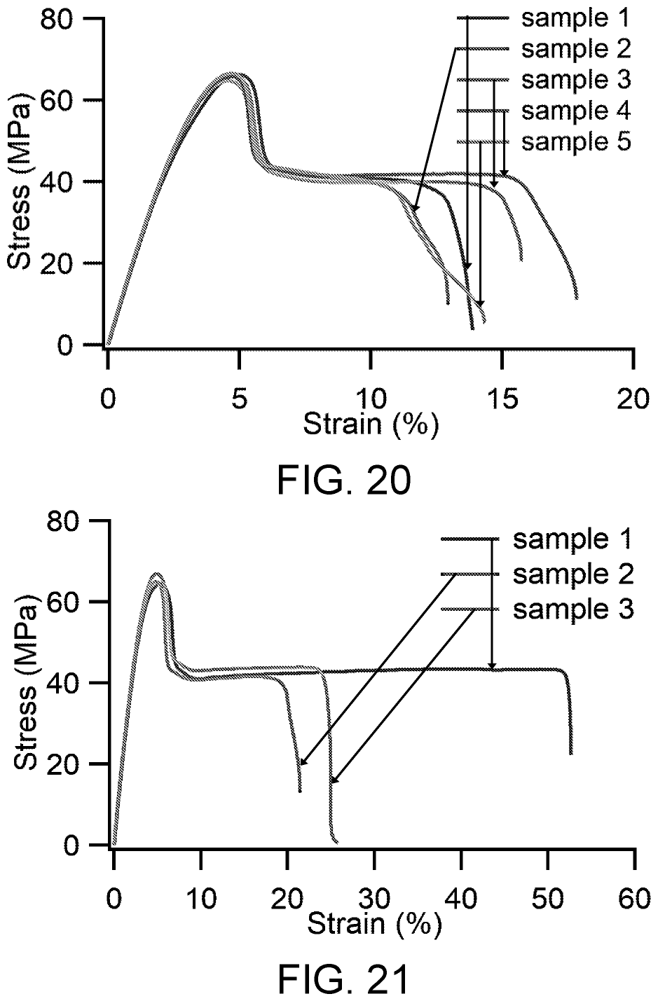

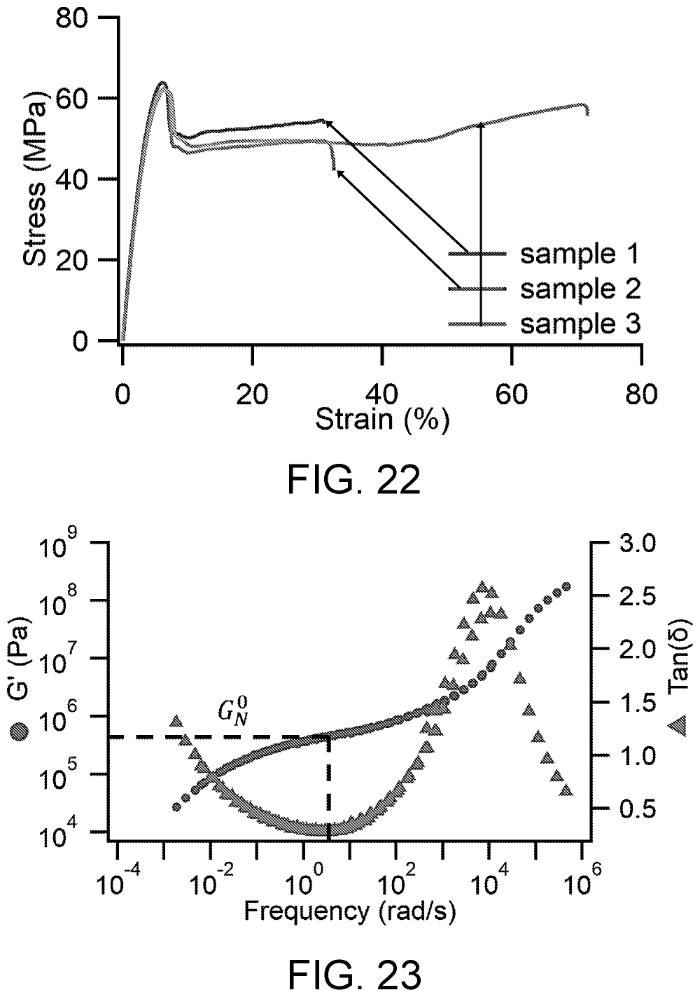

TENSILE PROPERTIES. Using the polymers synthesized with this new method, the tensile properties of PDHF samples with Mₙs ranging from 53-198 kg/mol were tested (Table 3, FIGS. 4, 18-22). Dogbone tensile bars were subjected to uniaxial tensile stress at a rate of 2 mm min⁻¹. All PDHF samples demonstrated high ultimate tensile strength (UTS), ranging from 65 to 70 MPa. Significantly, it was found that high molecular weight samples exhibited a definitive yield event, or neck, and subsequent cold-drawing phase (FIG. 4, photo inset). This drawing behavior dramatically increased strain-at-break up to 52% (PDHF-198), which improved the toughness to a maximum of 14 MPa. Interestingly, strain hardening was not observed, and the polymer failed before full propagation of the neck through the entire gauge length. This behavior is indicative of unstable crazing leading to premature failure during the cold-drawing. It was hypothesized that the addition of plasticizing agents could stabilize this cold-drawing behavior and further improve both strain-at-break and toughness.

TABLE 3

| | | | Ultimate | | |
|---|---|---|---|---|---|
| | | | Tensile | Strain | |
| | Mₙ ^{b} | | Strength | at Break | Toughness |
| Polymer-Mₙ | (kg/mol) | Ð ^{b} | (MPa) ^{c} | (%) | (MPa) |
| PDHF-53 | 53.4 | 1.45 | 69 ± 2 | 4.0 ± 0.2 | 1.6 ± 0.1 |
| PDHF-78 | 78.0 | 1.50 | 70 ± 1 | 5.3 ± 0.2 | 2.5 ± 0.2 |
| PDHF-140 | 140 | 1.51 | 65.9 ± 0.6 | 16 ± 2 | 6.1 ± 0.8 |
| PDHF-198 | 198 | 1.47 | 65 ± 1 | 33 ± 14 | 14 ± 6 |
| PC-45 ^{a} | 45 | N/A | 62.8 ± 0.8 | 45 ± 19 | 22 ± 10 |

^{a} Poly(bisphenol A carbonate) sample obtained from Millipore-Sigma;
^{b} Mn and Ð determined from light scattering;
^{c} Reported tensile data is the average of at least 3 samples.

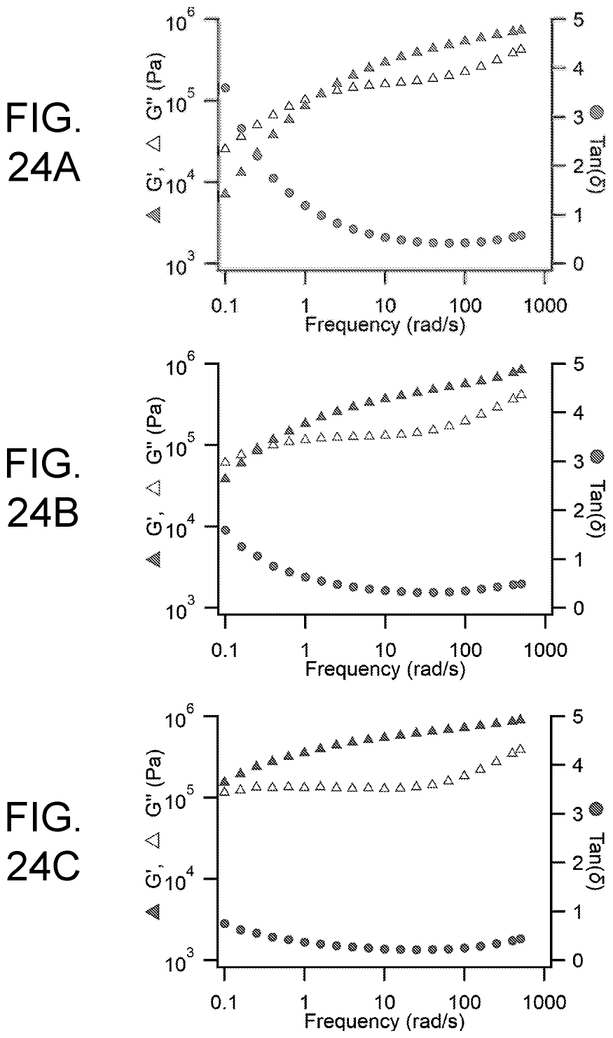

Encouraged by the tensile properties displayed by PDHF-198, it was compared to a benchmark commercial polymer known for strength and toughness. Hence, a 45 kg/mol poly(bisphenol A carbonate) (PC-45) sample was prepared and tested under the same conditions (FIG. 4, Polycarbonate trace, FIG. 23). Notably, the yield strength of PDHF-198 was comparable to PC-45 (65 vs. 63 MPa, respectively). The strain-at-break for PC-45 exceeded that of PDHF-198 and the PC-45 sample underwent strain hardening, resulting in an overall tougher thermoplastic (22 vs. 14 MPa, respectively). The high strength and toughness of unformulated PDHF, as compared to PC-45, showcases its promise as a biorenewable engineering plastic.

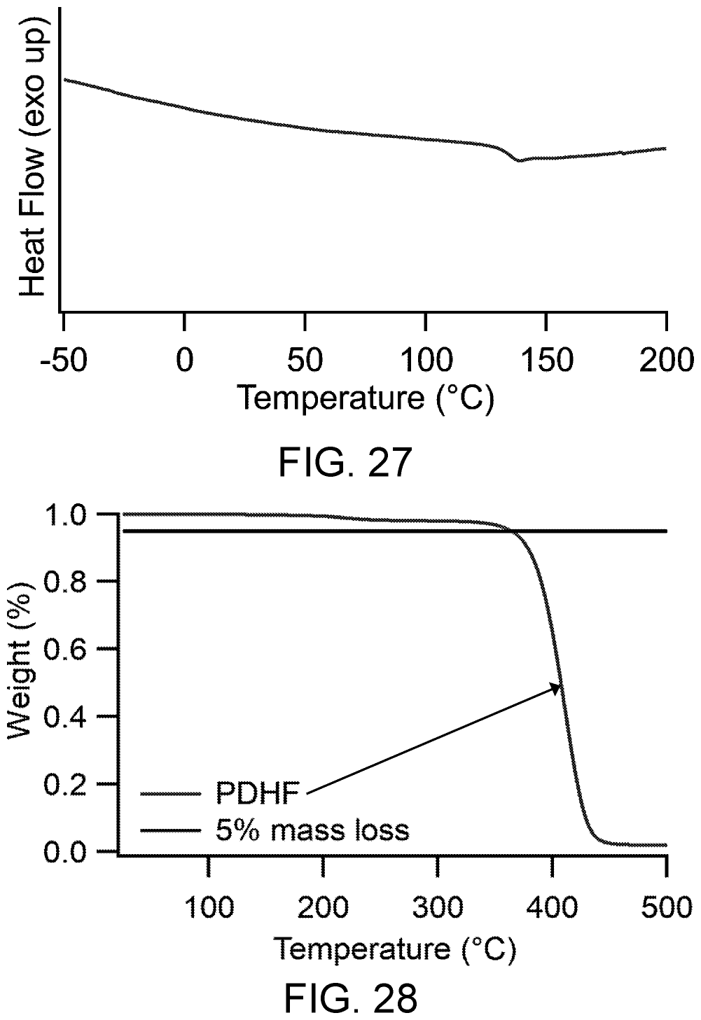

THERMAL PROPERTIES AND RHEOLOGY. PDHF is unique as a poly(vinyl ether) due to the retained cyclic backbone structure giving the polymer a high glass transition temperature. A T_{g} of 135° C. for PDHF was measured (FIG. 27), matching previous reports. PDHF also has exceptional thermal stability, with a 5% mass loss temperature of 364° C. (FIG. 28). These thermal properties demonstrate a large processing window for PDHF, where heat molding and polymer melt processing can take place. Reaction temperature has been reported to have an influence on diastereoselectivity and consequently the T_{g} of PDHF. Lower reaction temperatures favored the kinetic cis-isomer with a higher T_{g} while higher temperatures favored the thermodynamic trans-isomer with a lower T_{g}. Uncontrolled room temperature polymerization was reported to lead to a low T_{g} of ˜112° C. for the of 68% trans-PDHF. In contrast, this controlled room temperature polymerization generated 56% trans-PDHF with a high T_{g} of 131° C. for the same Mₙ(˜30 kg/mol) (Table 4). This was attributed to the better control achieved in our polymerization and it is believed that the relationship between diastereoselectivity and T_{g} is more nuanced than previously reported. Consequently, this controlled polymerization provides access to high T_{g} PDHF at room temperature.

TABLE 4

| | PDHF ^{a} | | Reaction | | | |
|---|---|---|---|---|---|---|
| Entry | (kg/mol) | Ð ^{a} | Temperature (° C.) | Solvent | Trans-content ^{b} | T_{g} ^{c} |
| 1 | 14.9 | 1.38 | 20 | DCM | 52-62% | 131 |
| 2 | 30.1 | 1.38 | 20 | DCM | 50-62% | 131 |
| 3 | 47.0 | 1.30 | 20 | DCM | 52-64% | 130 |

^{a} Mn and Ð determined from light scattering data;
^{b} Trans-content estimated from ¹³C NMR;
^{c} T_{g} determined with DSC.

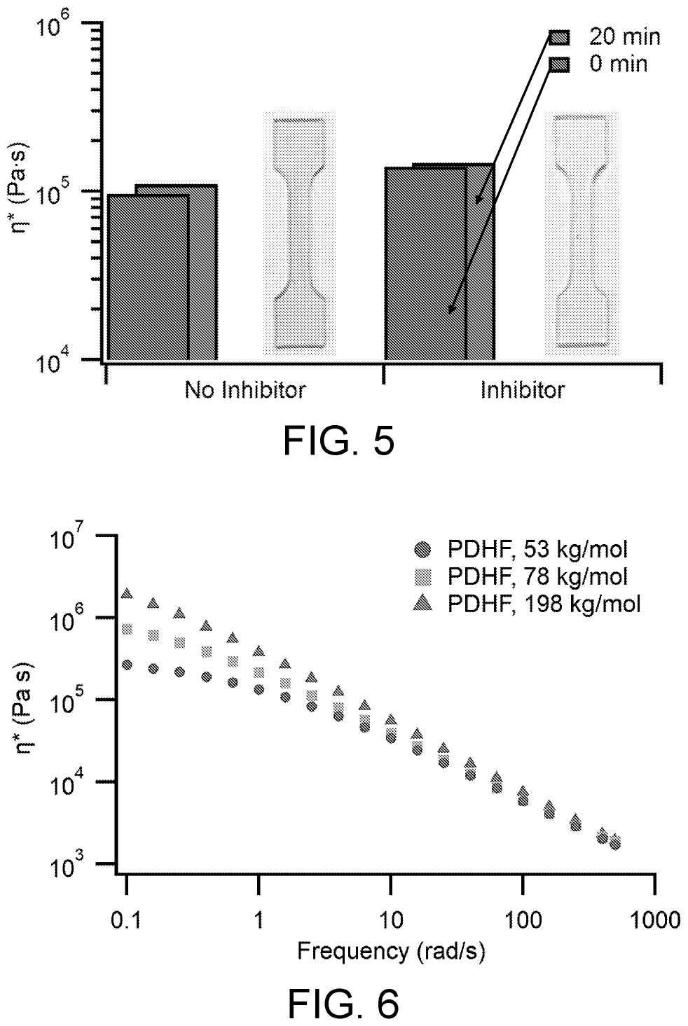

To evaluate the melt stability of PDHF, a batch of polymer was subjected to different processing conditions and evaluated the complex viscosity (η*) in parallel plate rheology. It was previously reported that PDHF is sensitive to thermo-oxidative degradation. It was hypothesized that the addition of a commercial phenolic inhibitor (Irganox© 1010) would stabilize the polymer at elevated temperatures. PDHF samples from the same batch were prepared without inhibitor and with 0.07 wt. % inhibitor. Constant 0.1% oscillatory strain was applied at a frequency of 0.1 rad s⁻¹ for 20 minutes at 180° C. Uninhibited PDHF showed a greater increase in η* over 20 minutes when compared to the inhibited PDHF (FIG. 5). In addition, uninhibited samples would often turn yellow during heat molding, while inhibited samples remained clear. This provided discernible evidence that the inhibitor increased the thermal stability of PDHF.

Another key parameter that influences polymer properties is the entanglement molecular weight (Mₑ). Using time-temperature superposition to generate a master curve (FIG. 23), the Mₑ was calculated to be ˜3 kg/mol using the equation given by Ferry (Equation 1). In reference to other polymers, this is quite low; for example, the value for polystyrene is estimated to be 18 kg/mol. Generally, a low Mₑ is associated with a strong thermoplastic, such as observed with PC (Mₑ=2.5 kg/mol). Consequently, it is believed that PDHF derives its strength from being well entangled, where Mₙ>>Mₑ. In addition, because PDHF is amorphous with a high T_{g}, it should maintain melt strength making it amenable to extrusion and other polymer processing techniques where high melt viscosity at low frequencies is desirable.

The influence of Mₙ on melt properties was then examined with frequency sweeps performed at 170° C. from 0.1 to 100 rad s⁻¹. Storage (G′) and loss (G″) moduli showed a clear crossover frequency that shifted to lower frequencies with increased Mₙ(FIGS. 24A-24C). The crossover between G′ and G″ indicates the frequency at which the polymer transitions from fluid-like to solid-like, giving insight into the sheer rates needed for melt-processing. The plot of η* at 180° C. shows an increase in η* with respect to increasing Mₙ at low frequency (<0.1 rad s⁻¹), indicative of the increased zero-shear viscosity (FIG. 6). Above 100 rad s⁻¹ the η* for all samples converge as a result of shear thinning. The onset of shear thinning indicates the shear rate at which viscosity diminishes with increased frequency, an important consideration in many polymer processing techniques, allowing PDHF of varying molecular weight to be processed with similar η* above 10 rad/sec. Finally, the range of observed complex viscosities suggests that PDHF could be well suited for hot-melt extrusion processing, as the optimal viscosity range has been cited as 1000-10000 Pa-s.

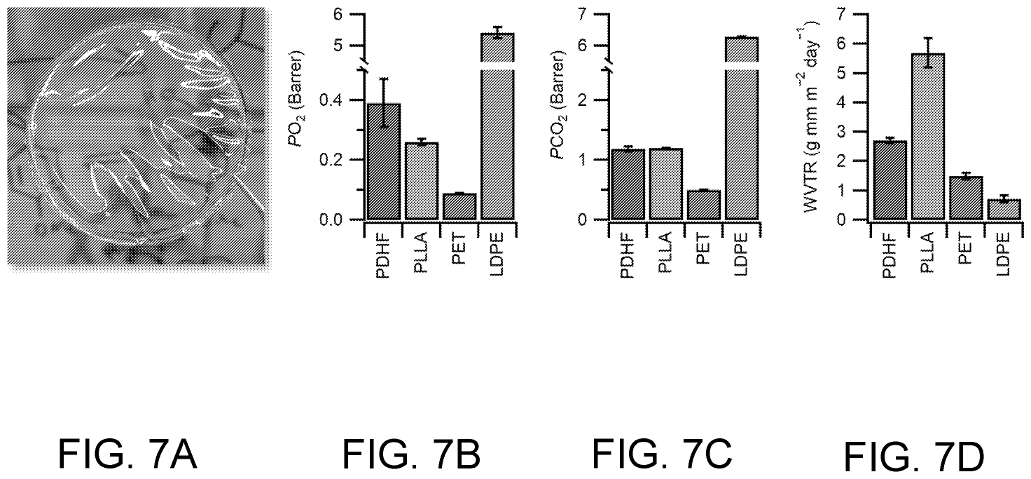

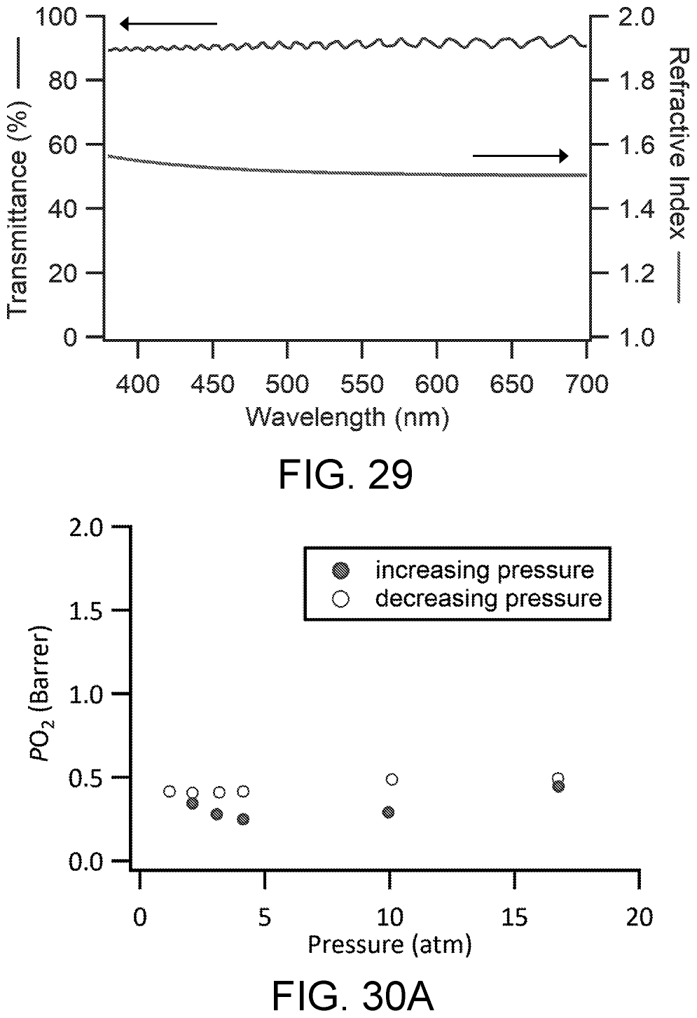

FILM BARRIER PROPERTIES. To study how PDHF performs as a barrier material for food packaging applications, free standing films were produced for analysis. These films were solvent cast then pressed at 170° C. to ensure the polymer was thermally relaxed. This produced uniform films ˜38 m thick with >89% transmittance across visible wavelengths (380-700 nm) (FIG. 7A, FIG. 29). For gas permeation measurements, PDHF films were tested by introducing an upstream pressure (1-17 atm) of single gas penetrants (O₂ or CO₂) and measuring downstream pressure (Table 5). Water vapor transmission rate (WVTR) was tested using previously described methods, in accordance with ASTM-E96. The values recorded for PDHF (Table 4) were compared to data from a recent publication on sustainable packaging materials (FIGS. 7B-7C). Previously, high strength thermoplastics such as PC have had poor barrier properties, therefore, PDHF was compared to materials currently used in barrier applications. O₂ permeability (PO₂) for PDHF at was lower than LDPE, but higher than PLLA and PET. CO₂ permeability (PCO₂) for PDHF was again lower than LDPE, and comparable to PLLA, but not as low as PET. Measured values for PDHF WVTR were low, at 2.7 g mm m⁻² day⁻¹. This is comparable to PET, (1.49 g mm m⁻² day⁻¹) and a significant improvement over PLLA (5.7 g mm m⁻² day⁻¹). The lower WVTR and resistance to hydrolysis gives PDHF clear advantages over PLLA for water-exposed applications. PDHF combines moderate gas and water permeability with robust material properties to produce a biorenewable polymer that could be attractive for food packaging applications.

TABLE 5

| | PO₂ | PCO₂ | WVTR |
|---|---|---|---|
| Polymer | (barrer) | (barrer) | (g mm m⁻² day⁻¹) |
| PDHF | 0.38 ± 0.08 | 1.19 ± 0.04 | 2.7 ± 0.1 |
| PLLA | 0.26 ± 0.01 | 1.2 | 5.7 ± 0.5 |
| PET | 0.09 ± 0 | 0.5 | 1.49 ± 0.11 |
| LDPE | 5.42 ± 0.18 | 6.3 | 0.71 ± 0.12 |

ACCELERATED OXIDATIVE DEGRADATION OF PDHF. In the development phase of any new plastic, it is imperative to examine the end-of-life solutions available for recycling and/or degradation. PDHF with inhibitor is a stable thermoplastic and thus can be mechanically recycled. However, the chemical degradation of this material was also investigated. A previously observed slow degradation of PDHF in the presence of air was attributed to an oxidative chain scission mechanism. A reduction in Mₙ from 85 to 4.5 kg/mol was reported after an uninhibited, high surface area sample was exposed to air for 130 days at room temperature. Motivated by this work, a method was developed by which PDHF degradation was chemically accelerated to oligomeric and small molecule fragments, which may hold potential for more favorable biodegradation or for waste valorization through chemical upcycling.

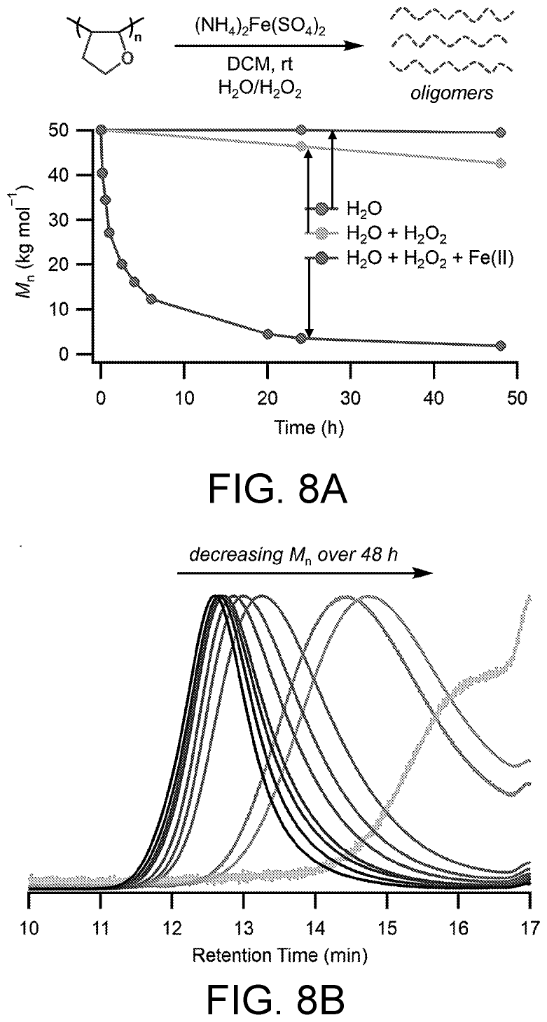

It is well known that the combination of hydrogen peroxide (H₂O₂) and a ferrous salt (Fe(II)), “Fenton's reagent,” results in the formation of a strongly oxidizing hydroxyl radical species. Due to the relative abundance and low cost of H₂O₂ and Fe(II), a Fenton's reagent oxidation was used to demonstrate a facile, accelerated chemical degradation of PDHF. PDHF was first dissolved in DCM before adding H₂O₂/H₂O (30 wt. %) and Fe(II) in the form of (NH₄)²Fe(SO₄)₂·6H₂O. DCM was chosen because it met the criteria of being difficult to oxidize while still providing good solubility for efficient degradation. On larger scale, 1,2-dichloroethane could serve as an alternative, where the solvent could be recovered and recycled. The biphasic reaction mixture was then monitored by GPC, revealing a reduction in Mₙ from 50 kg/mol to ˜1 kg/mol over 48 hours (h) (Table 6, FIGS. 8A-8B). The plot of Mₙ⁻¹ versus time exhibited a linear relationship, suggesting a chain scission mechanism (FIG. 31). When PDHF was stirred in only water and DCM, no reduction in Mₙ was observed, and when PDHF was stirred in H₂O₂, H₂O, and DCM but no Fe(II), the Mₙ only decreased to 42.7 kg/mol after 48 hours. These results demonstrate Fenton's reagent as an effective method for the rapid, facile degradation of PDHF.

TABLE 6

| Entry | Time (hours) | Mₙ (kg mol⁻¹) | Ð | Mₙ⁻¹ (mol kg⁻¹) |
|---|---|---|---|---|
| 0 | 0 | 50.1 | 1.58 | 0.01996 |
| 1 | 0.167 | 40.5 | 1.77 | 0.024691 |
| 2 | 0.5 | 34.5 | 1.90 | 0.028986 |
| 3 | 1 | 27.2 | 2.25 | 0.036765 |
| 4 | 2.5 | 20.1 | 2.50 | 0.049751 |
| 5 | 4 | 16.2 | 2.66 | 0.061728 |
| 6 | 6 | 12.3 | 2.84 | 0.081301 |
| 7 | 20 | 4.5 | 2.73 | 0.222222 |
| 8 | 24 | 3.6 | 2.66 | 0.277778 |
| 9 | 48 | 1.9 | 1.62 | 0.526316 |

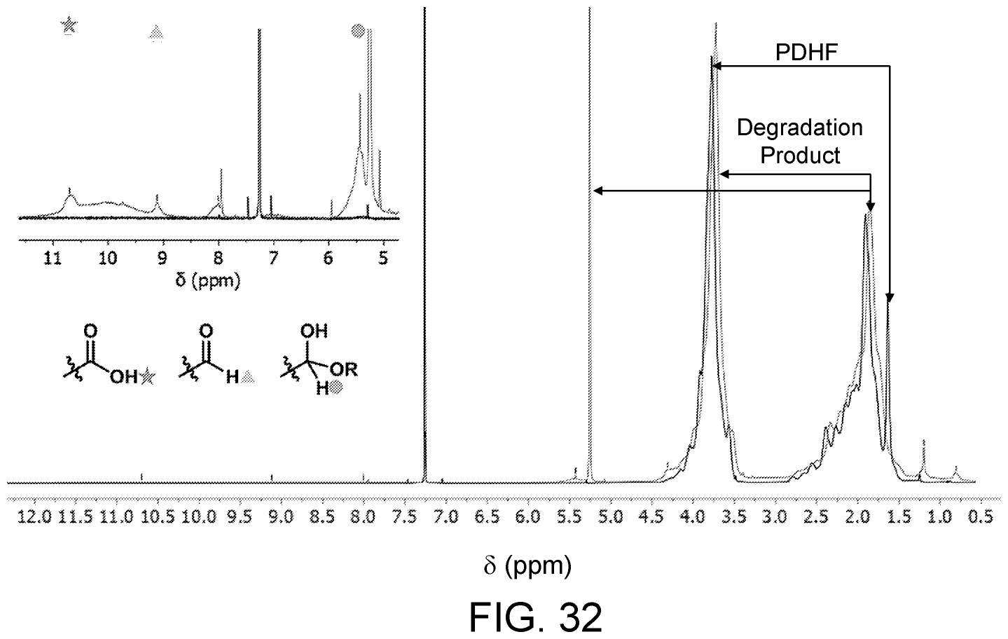

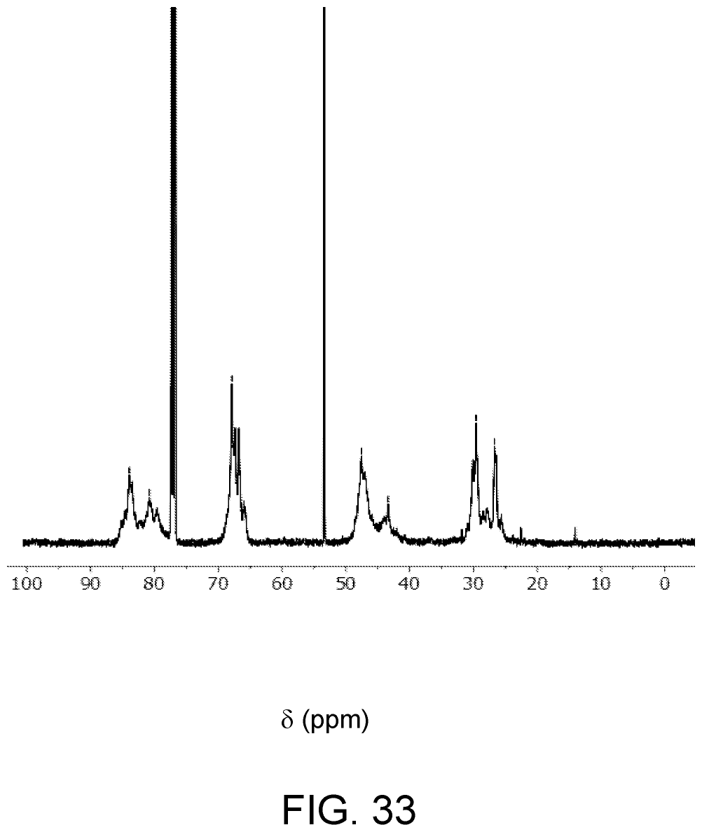

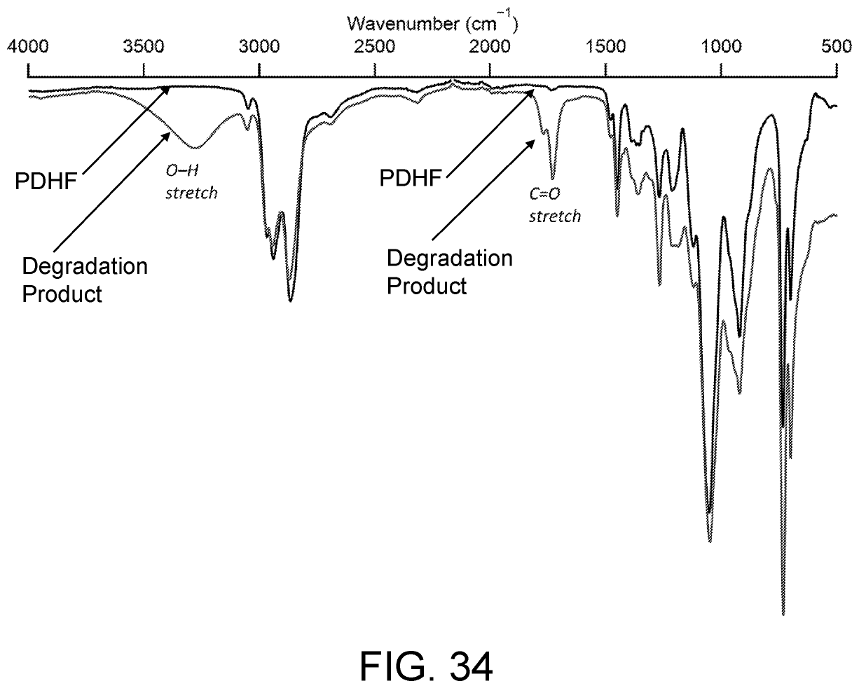

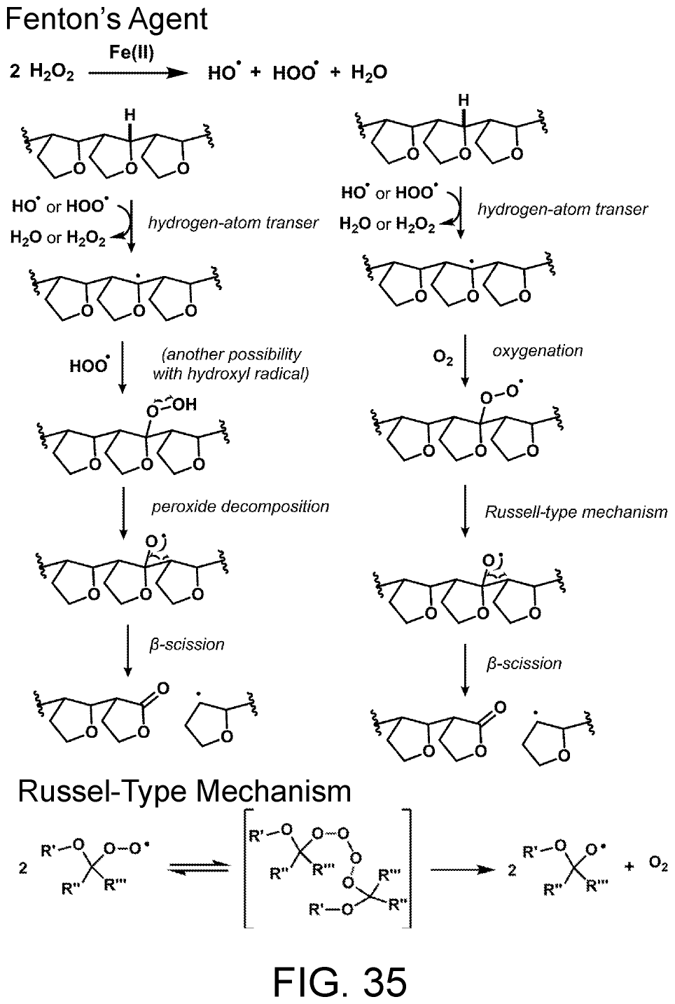

¹H NMR, ¹³C NMR, and FT-IR spectra of the degradation products provided initial insight into the mechanism. By ¹H NMR (FIG. 32), observed signals were consistent with a carboxylic acid (10.70 ppm), aldehyde (9.11 ppm), as well as an acetal (5.43 ppm), and in the ¹³C NMR spectrum (FIG. 33), a peak consistent with that of a lactone (162.07 ppm) was visible. These assignments were supported by FT-IR spectra (FIG. 34), in which new absorptions for C=O stretching were observed at 1730 and 1770 cm-1 in addition to a broad absorption ranging from 3050 to 3500 cm⁻¹ corresponding to O—H stretching. These observations align with those made previously for PDHF degradation, and it was expected that this accelerated oxidation proceeds through a similar mechanism (FIG. 35). This degradation study sets the groundwork for the development of a method to chemically upcycle PDHF, where optimization could allow for complete valorization of the oligomeric products into chemical feedstocks.

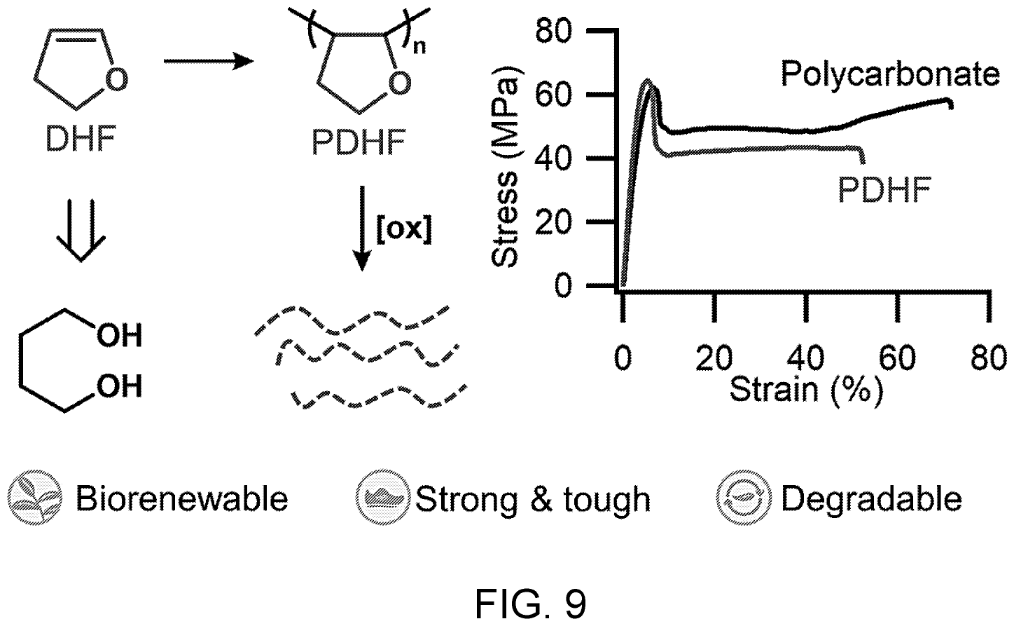

PDHF represents a unique opportunity to source a strong and degradable thermoplastic from a commercial bioalcohol (FIG. 9). PCCP was demonstrated as an effective organic acid initiator for cationic polymerization of DHF at room temperature to achieve high Mₙ PDHF (256 kg/mol) at 14 g scale. The addition of HBD enabled polymerization in an industrially relevant green solvent, CPME. Tensile properties revealed that high Mₙ PDHF is a strong (≤70 MPa) and tough (≤14 MPa) thermoplastic, comparable to PC. Film barrier properties showed promising results for food packaging, with low permeability to O₂ (0.42 barrer), CO₂ (1.2 barrer), and water vapor (2.7 g mm m⁻² day⁻¹). Finally, an accelerated chemical degradation of PDHF under oxidizing conditions was demonstrated. This comprehensive evaluation of PDHF lays a roadmap for developing this next-generation sustainable thermoplastic, where an efficient bioalcohol source, robust material properties, and facile degradability has been provided.

Experimental Section. Materials. 2,3-dihydrofuran (DHF) (99%, TCI) and cyclopentyl methyl ether (CPME) (99%, TCI) were dried over calcium hydride (CaH₂) (ACROS organics, 93% extra pure, 0-2 mm grain size) for 12 hours, distilled under vacuum, and degassed by three freeze-pump-thaw cycles. Dichloromethane (DCM), was purchased from J. T. Baker and was purified by purging with argon for 1 hour, followed by passing through two packed columns of neutral alumina under argon pressure. Poly(bisphenol A carbonate) (PC) (45 kg/mol, Sigma Aldrich) was used as received. Hydrogen peroxide (30 wt. % in H₂O, Fisher Scientific), ammonium iron(II) sulfate hexahydrate (98%, Sigma Aldrich), calcium chloride (4-20 mesh, Fisher Scientific), and Irganox 1010® (BASF) were used as received. Benzene, ethyl acetate (EtOAc), methanol (MeOH), and triethylamine (NEt₃) were purchased from Fischer Scientific and used as received. Pentacarbomethoxycyclopentadiene (PCCP) and Hydrogen bond donor (HBD) tris(3,5-tris(trifluoromethyl)phenyl)thiophosphotriamide were each independently synthesized according to previous literature procedures.

General Measurements. All polymer samples were analyzed using a Tosoh EcoSec HLC 8320 GPC system with two SuperHM-M columns in series at a flow rate of 0.350 mL/min. THE was used as the eluent and number-average molecular weights (Mₙ), weight-average molecular weights (M_{w}), and dispersities (Ð) for PDHF were determined by light scattering using a Wyatt miniDawn Treos multi-angle light scattering detector and a calculated dn/dc value of 0.1116 mL g⁻¹. The reported Mₙs for degradation of PDHF were calculated from refractive index chromatograms against TSKgel polystyrene standards. Nuclear magnetic resonance (NMR) spectra were recorded on a Varian 400 MHz, a Varian 600 MHz, or a Bruker 500 MHz instrument. Fourier Transform Infrared (FTIR) spectra were collected on a Bruker Tensor II IR spectrometer with a diamond Attenuated Total Reflectance (ATR) attachment. Ellipsometry was performed on a J.A. Woollam Co, Inc. M-2000 ellipsometer using wavelengths from 370 to 1000 nm with a 65° angle of incidence. The refractive index was predicted by the Cauchy dispersion equation. The

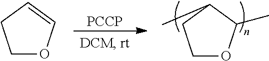

transmittance index of PDHF film was measured by Thermo Scientific™ Evolution 220 UV-Vis spectrophotometers using wavelengths from 380 to 700 nm.

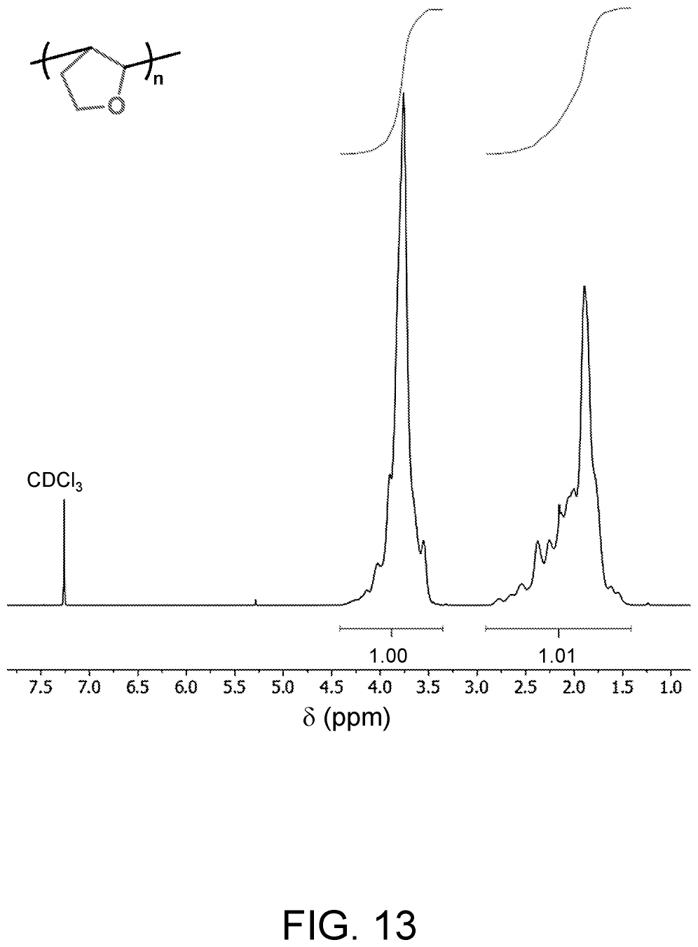

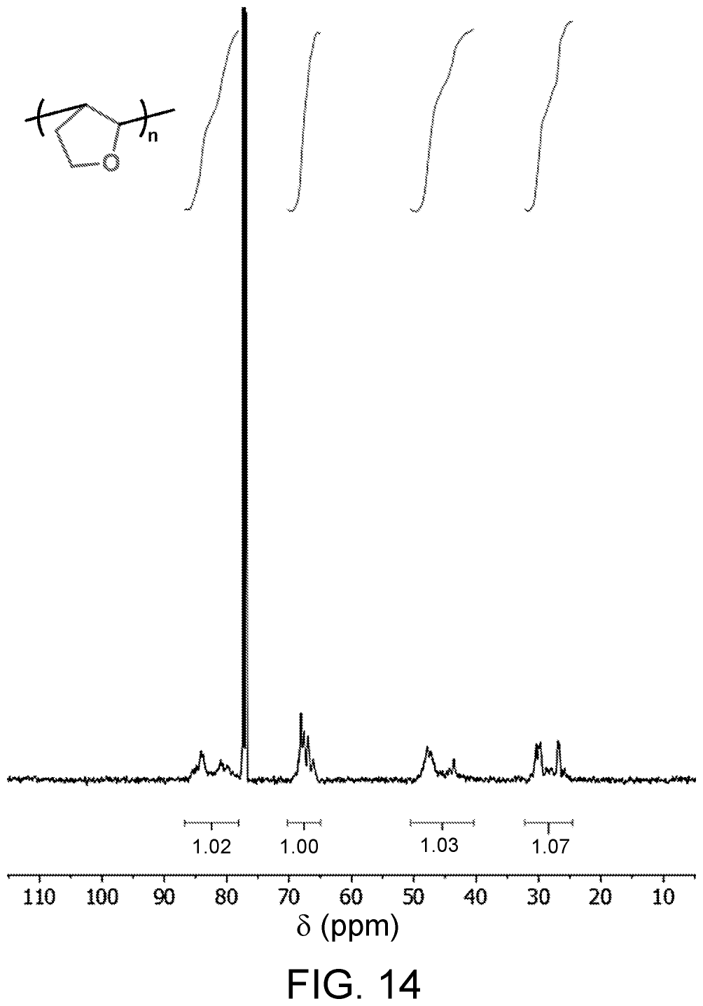

Procedure for Polymerization of DHF (250 kg/mol). All polymerizations were set up in a nitrogen glovebox. A scintillation vial equipped with a magnetic stir bar was charged with PCCP (6 mg, 0.017 mmol, 1 equiv.). Distilled DHF (4.5 mL, 60 mmol, 3566 equiv.) was then added, promptly followed by DCM (4.5 mL). The reaction was sealed with a Teflon-lined cap, then removed from the glove box and placed in a 22° C. water bath for heat dissipation and stirred for 26 hours. The reaction was terminated by the addition of 20 μL of 5% triethylamine/methanol. 89 μL (1 mmol) of benzene was added as an internal standard. Aliquots were taken for NMR and GPC and the sample was then precipitated twice into a 20% H₂O/methanol solution and dried under vacuum. ¹H and ¹³C NMR of the polymer are shown in FIGS. 13 and 14, respectively.

Procedure for Large Scale Polymerization of DHF (14 Gram Scale). In a nitrogen filled glovebox, a 100 mL Schlenk flask was equipped with a magnetic stir bar and was charged with a 10 mg/mL stock solution of PCCP (2.0 mL, 0.056 mmol, 1 equiv.). DCM (15 mL) was added, followed promptly by DHF (15.0 mL, 198 mmol, 3460 equiv.). The reaction was then sealed, removed from the glove box, and placed in a 22° C. water bath for heat dissipation and stirred for 26 hours. The reaction was terminated by the addition of 0.50 mL of 5% triethylamine/methanol. 89 μL (1 mmol) of benzene was added as an internal standard. Aliquots were taken for NMR and GPC and the sample was then precipitated twice into a 20% H₂O/methanol solution and dried under vacuum.

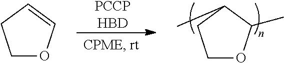

Procedure for Polymerization of DHF in Cyclopentyl Methyl Ether. In a nitrogen glovebox, a scintillation vial equipped with a magnetic stir bar was charged with PCCP (3 mg, 0.0084 mmol, 1 equiv.) and HBD (6 mg, 0.0084 mmol, 1 equiv.). DCM (2.3 mL) was added followed promptly by DHF (2.3 mL, 30 mmol, 3566 equiv.). The reaction was sealed with a Teflon-lined cap, then removed from the glove box and placed in a 22° C. water bath for heat dissipation and stirred for 26 hours. The reaction was terminated by the addition of 20 μL of 5% triethylamine/methanol. 89 μL (1 mmol) of benzene was added as an internal standard. Aliquots were taken for NMR and GPC.

Material Characterization. For tensile and rheology characterization, PDHF was dissolved in DCM and 0.07 wt. % Irganox 1010© was added. This was solvent cast into a large petri dish and solvent allowed to evaporate overnight, before drying under vacuum at 70° C. for 20 hours. PDHF and poly(bisphenol A carbonate) (PC) were pressed into dog-bone-shaped tensile bars using a 4120 Hydraulic Unit Carver heated press. The polymer samples were placed in the mold between two sheets of Mylar protective lining, and this was placed between two stainless-steel sheets. PDHF samples were held at 170° C. for 2 min. before pressing to 7,000 lbs. and holding for 2 min. The press was then water cooled to room temperature at an approximate rate of 10° C./minute (min) before releasing pressure. Excess material was trimmed away with a hobby knife to obtain dog-bone-shaped tensile bars with approximate gauge dimensions of 16×2.5×0.9 mm.

Tensile properties of the prepared samples were examined using a Zwick/Roell Z010 testing system equipped a 500 N load cell and hand-tightened grips. Samples were stretched to break at an extension rate of 2 mm min-. Values reported are an average calculated from at least three samples.

For determination of thermal transitions, differential scanning calorimetry (DSC) was performed using a TA Instruments Q1000. Samples were placed in aluminum crucibles and heated to 200° C. at 20° C. min⁻¹ to erase thermal history, cooled to −70° C. and held at this temperature for 10 minutes (min) to equilibrate. A second heat cycle was performed to 200° C. at 20° C. min⁻¹ during which the thermal data was collected. Thermogravimetric analysis (TGA) was performed using a TA Instruments Q500 where samples were heated at a rate of 20° C. min⁻¹ from 25° C. to 500° C.

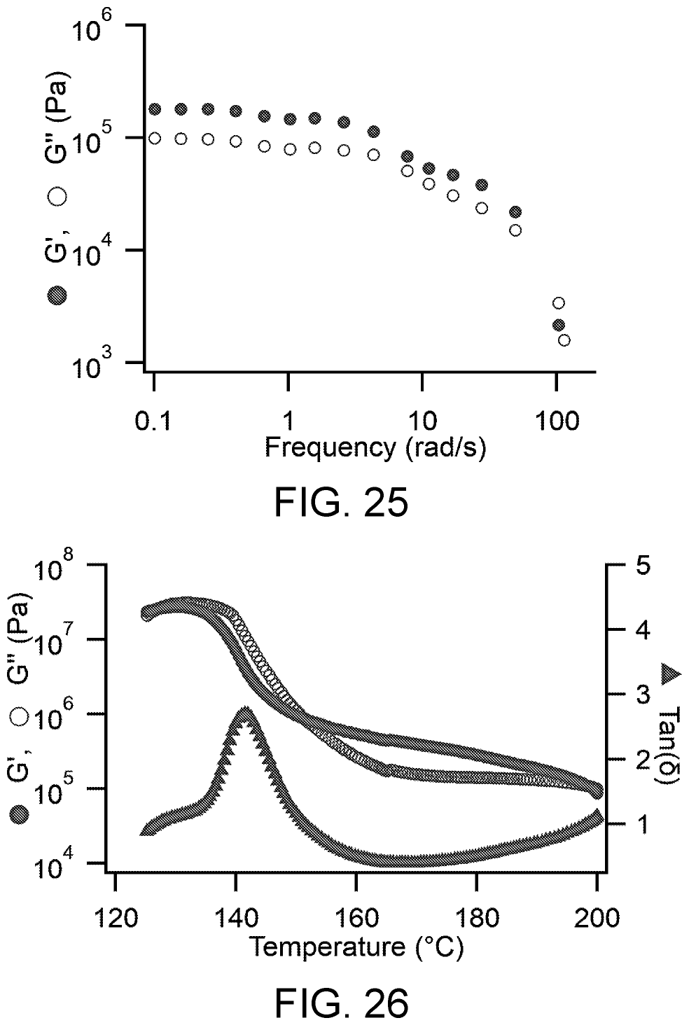

Rheological tests were performed on a TA Instruments DHR3 rheometer using an 8 mm parallel plate in a temperature controlled environmental test chamber under a nitrogen atmosphere. The sample was loaded onto the bottom parallel plate at 180° C. and the top plate was lowered to a trim gap of 1050 m. Excess polymer material was trimmed and then the plate was lowered to a gap of 1000 m. Strain sweeps (0.1-100%) at 180° C. were first performed at 6.3 rad/s (1 Hz) to determine the linear viscoelastic region (FIG. 25). A 0.1% strain was selected as it consistently lied within the linear viscoelastic region for the preceding range of frequencies. Before each frequency sweep, the sample was equilibrated at 180° C. for 5 minutes (min) to ensure uniform sample temperature.

For ellipsometry, thin films of PDHF were spin-coated onto silicon wafers. PHDF was dissolved in DCM (6 mg/mL) and 0.2 mL of this solution was dropped onto a clean silicon wafer mounted in a spin coater. The spin coater was run at 5000 rpm for 30 s, with an acceleration of 3000 rpm/s. This PDHF-coated wafer was then transferred to the ellipsometer for measurement of the refractive index.

For gas permeation and water vapor transmission measurements, PDHF films were prepared by solvent casting. 400 mg of PDHF and 0.3 mg Irganox 1010© (0.07 wt. %) were dissolved in 8 mL DCM to create a 50 mg/mL solution. 2 mL (each) of this solution was passed through a 13 mm, 0.45 m pore size syringe filter into three separate glass casting dishes. Casting dishes were cleaned of debris with compressed air immediately before use. The dishes were then covered with glass petri dish covers and placed on a platform equipped with a bubble leveler. The samples were left to evaporate solvent for 20 hours, then transferred to a vacuum oven and dried under vacuum at 70° C. for 18 hours. After allowing the films to cool, deionized water was added to the dishes and the films were cut around the edge with a hobby knife before delicate removal with blunt end forceps. The films were then individually placed between mylar protective sheets and stainless-steel sheets before pressing with a 4120 Hydraulic Unit Carver heated press. The films were held at 170° C. for 2 minutes before pressing to 5000 lbs. for 2 minutes. Pressure was released, and the sample dwelled for 2 minutes at 170° C., before pressure was increased again to 10,000 lbs. and held for 2 minutes. This pressure was held while the press was cooled to room temperature at a rate of 10° C./min. This procedure yielded clear PDHF films with a uniform thickness of 38 m.

Single gas permeabilities were measured by using constant volume, variable pressure method with ultra-high purity grade gases (O₂, and CO₂). PDHF film was placed in a 47 mm stainless steel HP Filter Holder, and the ultra-high purity grade gas was introduced from the upstream of the system. The gas permeability of the PDHF film was calculated by the increasing rate of the downstream pressure and the thickness of the film. The upstream pressure was measured by using a 1000 psi pressure transducer (High-Pressure Baratron® Absolute Capacitance Manometer Model 750C13PFE2GA), and the upstream pressure was controlled by a pressure regulator. The downstream pressure was measured by using a 10 torr capacitance manometer (Absolute Capacitance Manometer, Model 626C11TBE). A vacuum pump (Welch, Model 1400B-01) was installed to remove gas molecules in the whole system and create partial vacuum (˜0.001 torr). Upstream and downstream pressures were monitored and recorded by National Instruments Lab-VIEW software. The gas leak between the system and the environment was confirmed to be very low (<10-7 torr/s). The average thickness of the PDHF films were measured by using a dial gauge and the testing area was calculated by image J software analysis

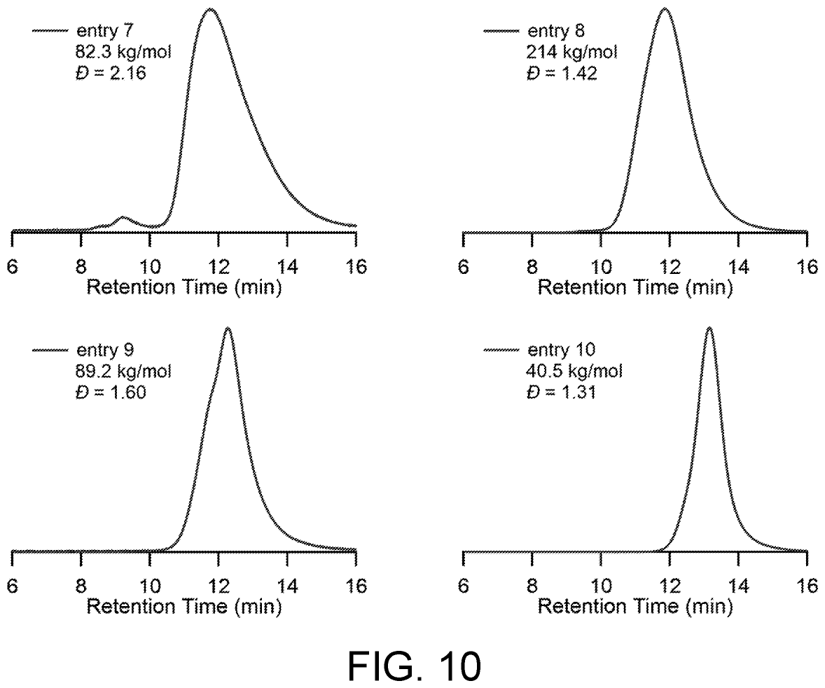

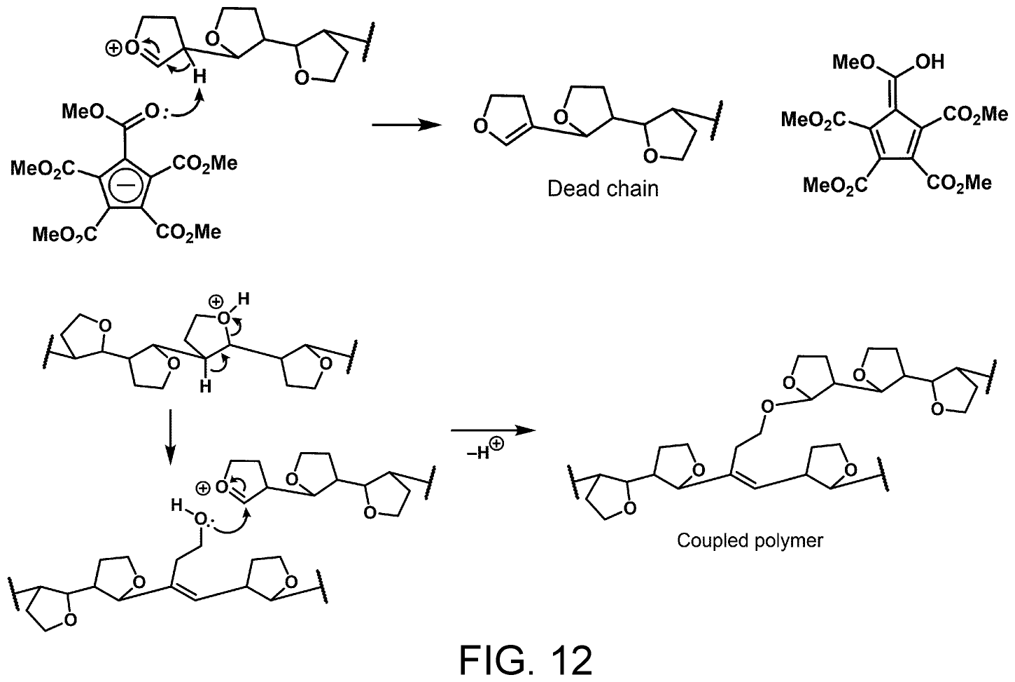

PDHF Polymerization. Table 2 and FIG. 10 show PDHF polymerization performed in DCM monitored over time. The tailing to low molecular weight can be ascribed to chain transfer, while the high Mₙ shoulder could be from chain coupling (FIG. 10). It is hypothesized that this could occur from protonation and subsequent ring opening of the cyclic ether in the polymer backbone, leading to a pendant alcohol (FIG. 12, bottom). This alcohol side chain could then perform nucleophilic attack on the oxocarbenium atom of a growing chain, resulting in a coupled polymer. This phenomenon was more apparent when targeting high molecular weights due to the longer reaction times and the increase in viscosity led to ceased stirring. The lack of mixing could decrease the relative concentration of monomer at the chain ends, thus leading to adventitious interactions with polymer backbone units. Thus, while the polymerization could not be classified as living, it is hypothesized that the chain transfer and chain coupling mechanisms have opposing effects on Mₙ, broadening the dispersity, but still attaining the Mₙ calculated from [PCCP]:[DHF]. This also leads to the bimodal appearance of the molecular weight distribution of the high molecular weight samples. No vinylic protons were observed in the ¹H NMR, likely due to their low concentration in these large polymers.

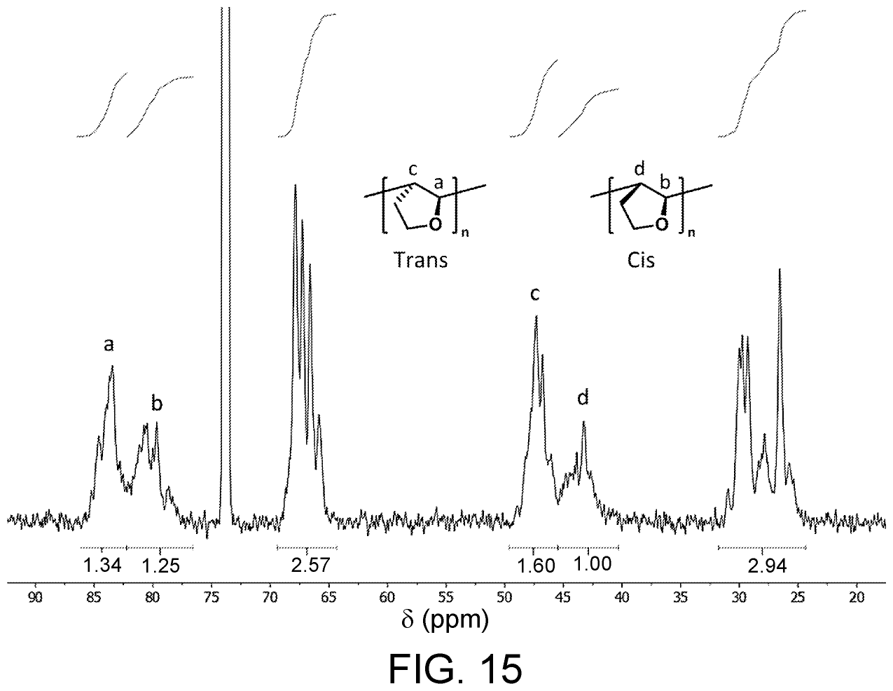

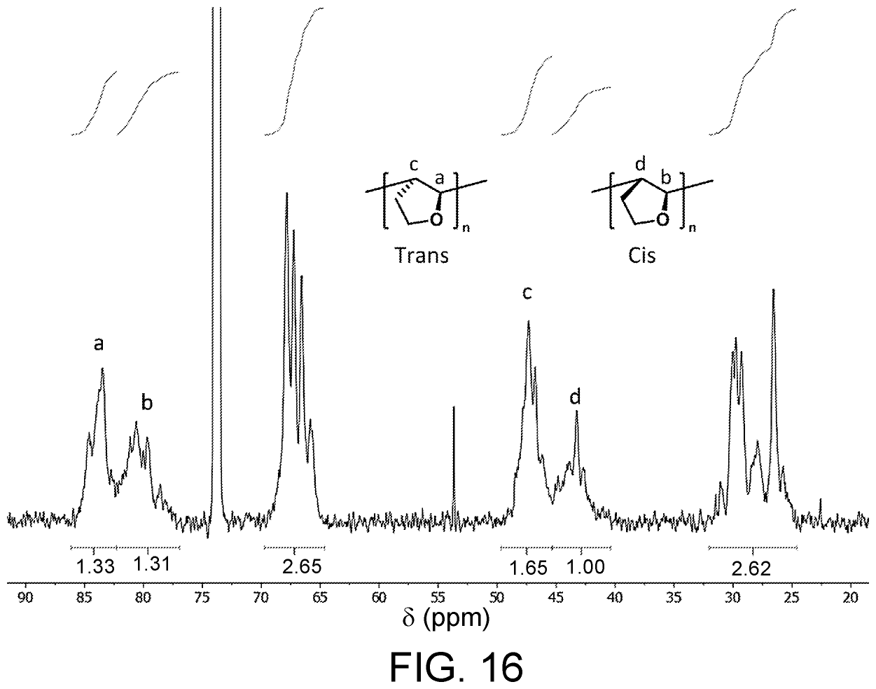

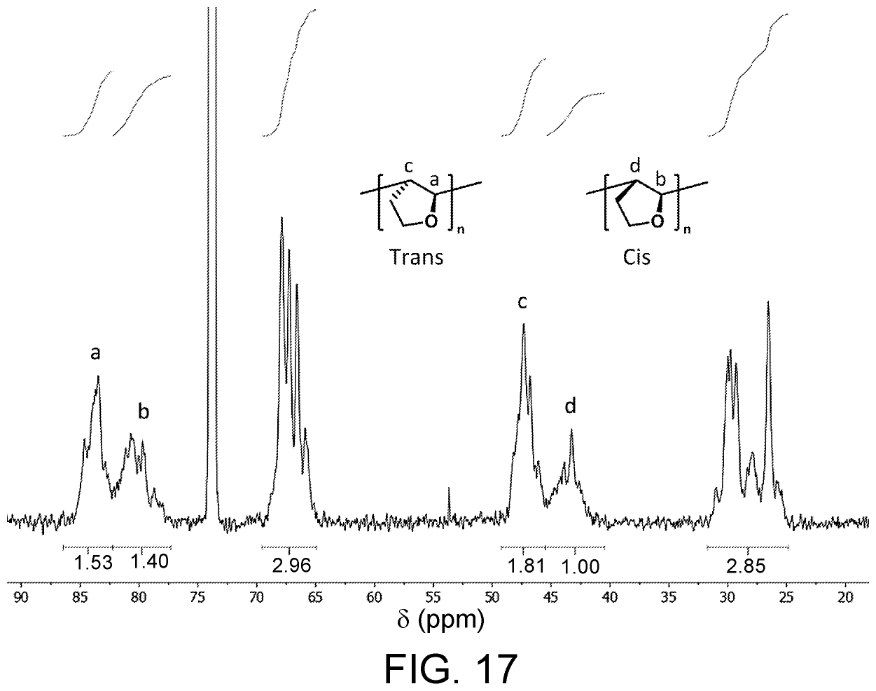

Diastereoselectivity of PDHF and the Effect on Glass Transition Temperature. Previous work assigned the peaks at 40-45 ppm and 76-82 ppm to the cis isomer of PDHF, while the peaks at 45-50 ppm and 82-87 ppm were assigned to the trans isomer. The ratio of peaks 40-45 ppm and 45-50 ppm were then used to calculate the ratio of trans to cis for a given polymer. We examined our polymers in a consistent manner using ¹³C spectra of PDHF samples obtained in 1,1,2,2-tetrachloroethane-d2 (FIGS. 15-17).

For all PDHF samples evaluated, the trans-content was similar, ranging from 50-64% (Table 3). This method's higher reaction temperature (22° C.) favors the trans-isomer. Interestingly, these samples maintained T_{g}s of around 131° C., higher than what was observed for previous high trans-PDHF (<120° C.). This discrepancy is attributed to previously reported T_{g}s for uncontrolled polymerizations, with Ð>2. In addition, inconsistent ratios of a:b and c:d for our integrations in the ¹³C NMRs were observed, indicating the assigned trans- and cis-peaks overlap to different extents, making this an inaccurate method for determining isomer content.

The master curve (FIG. 23) was generated using time-temperature superposition from frequency sweeps (0.1-100 rad/s, 1 Hz) at temperatures 140, 150, 160, 170 (reference), 180, 190, and 200° C. (FIGS. 24A-24C, FIG. 26). The minimum of tan(S) was found at 3.5 rad/s and this was used to find the plateau modulus (G_{N}⁰), as indicated by the dashed line in FIG. 23. G_{N}⁰ was then used in Equation 1 to calculate entanglement MW (Mₑ), in accordance with the equation derived by Ferry.

$${M}_{e} = \frac{ρ RT}{3 {G}_{N}^{0}} = \frac{1040 [ \frac{kg}{{m}^{3}} ] \cdot 8.314 [ {m}^{3} \cdot \frac{Pa}{K \cdot mol} ] \cdot ( 170 + 273 ) [ K ]}{( 3 ) \cdot 486 , 826 [ Pa ]} = 2.8 \frac{kg}{mol} \qquad Equation l$$

Water vapor transmission rate (WVTR) was tested on PDHF ˜38 m films prepared through the solvent casting procedure described previously. The films were tested in accordance with ASTM E-96, using a film diameter of 28 mm. The films were sealed with a 1:1 mixture of beeswax:rosin to a glass dish filled with activated desiccant (CaCl₂). This fixture was then placed in a 49% relative humidity chamber. The dish was removed, and the mass recorded each day at the same time for 8 days. WVTR was then calculated using the following equation:

$$WVTR = \frac{thickness [ mm ] \cdot transmission rate [ \frac{g}{day} ]}{area [ {m}^{2} ] \cdot ( rel . {humidity}_{out} - rel . {humidity}_{in} )} \qquad Equation 2$$

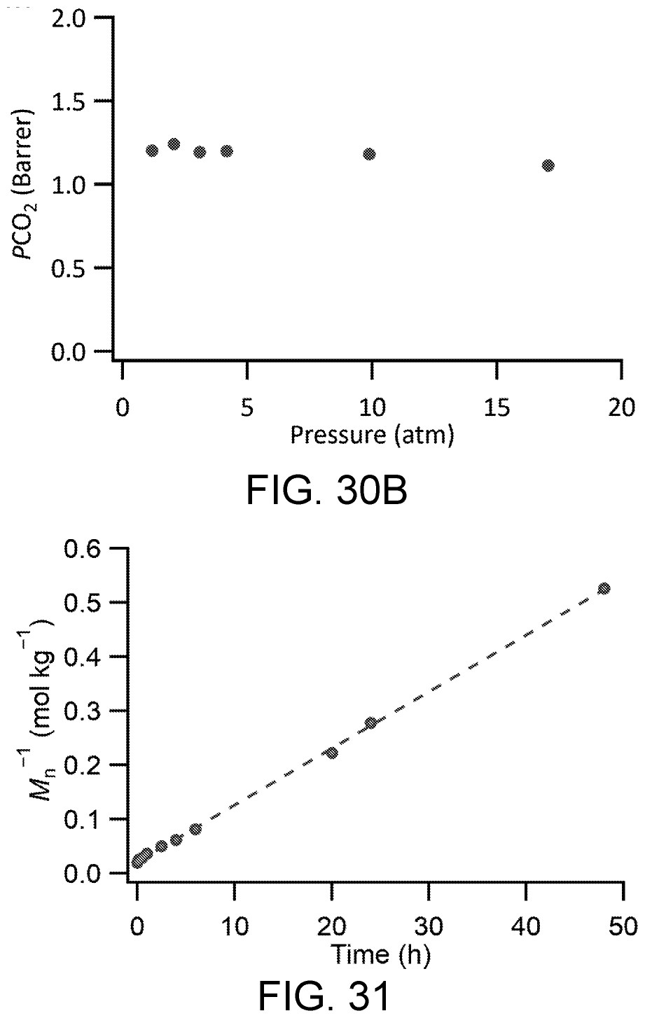

Permeation of O₂ and CO₂ (PO₂, PCO₂). For O₂, permeability was measured as the upstream pressure was increased from 2 atm to 16.7 atm, before pressure was then decreased down to 1 atm (FIG. 30A). For CO₂, the pressure was increased from 1 atm to 16 atm (FIG. 30B). No major change in permeability was observed with respect to pressure, thus the reported values for PO₂ and PCO₂ are an average of all pressures. The values obtained were compared to values reported in a recent article on barrier properties of bio-based food packaging materials.

PDHF Degradation. Procedure for the Accelerated Oxidative Degradation of PDHF. A 50 mL round bottom flask equipped with a magnetic stir bar was charged with PDHF (0.120 g, 1.71 mmol of DIF subunits, 1 equiv.) followed by DCM (12.0 mL). Once the polymer was completely dissolved, H₂O₂ (30 wt. % in water) was added (12.0 mL, 118 mmol, 68.7 equiv.) followed by (NH₄)₂Fe(SO₄)₂·6H₂O (0.134 g, 0.343 mmol, 0.2 equiv.). The flask was fit with a rubber septum which was pierced with a needle and stirred at room temperature for 48 h. The reaction appeared red at first but faded in color over the course of the reaction. Aliquots were taken from the organic layer for GPC analysis (Table 6).

### Example 2

The following is an example of PCVEs and PCVE compositions, methods of making same, and methods of using same.

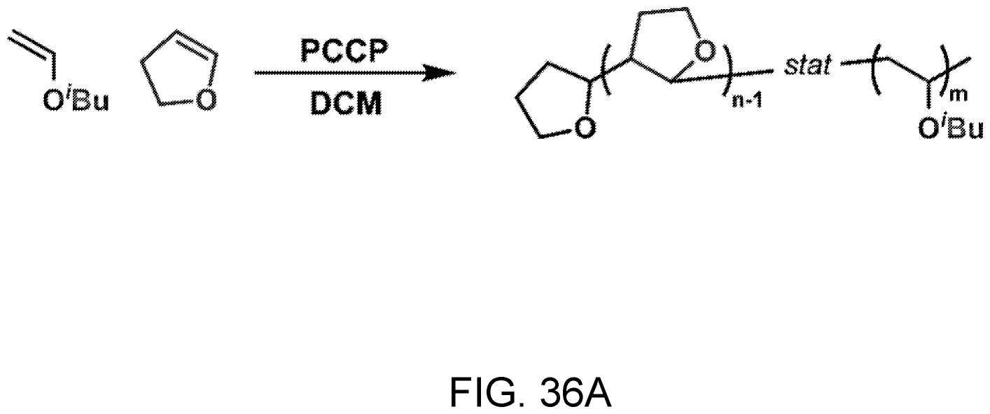

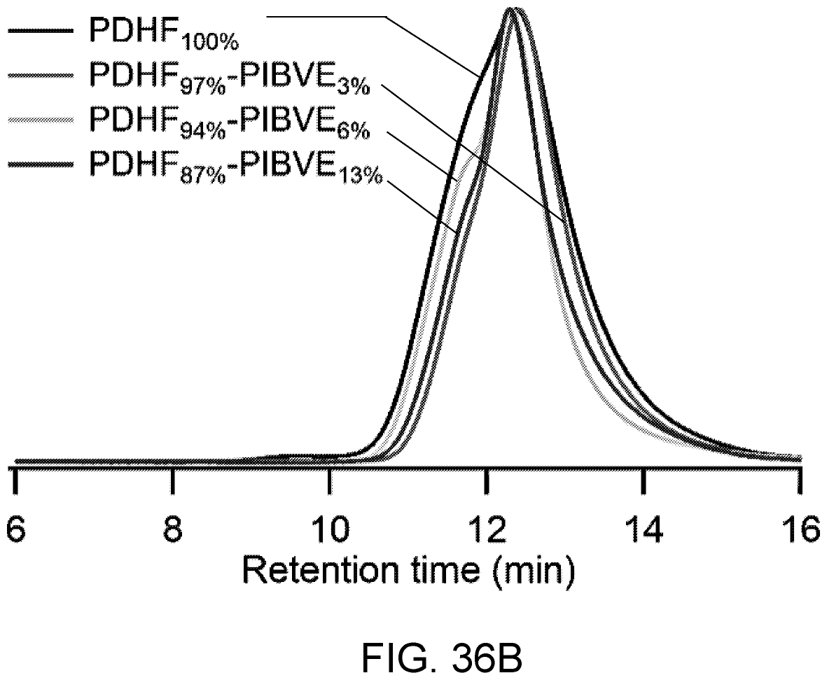

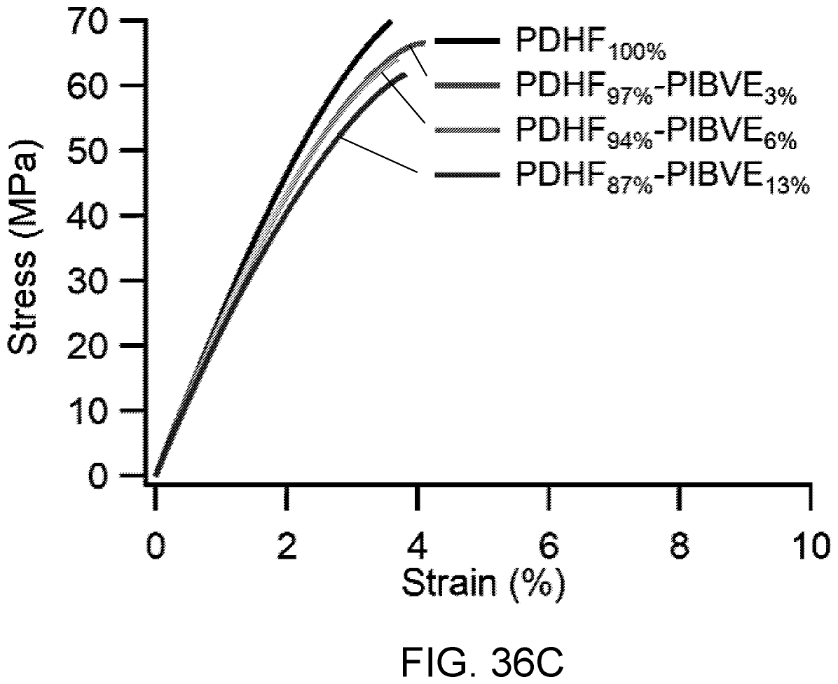

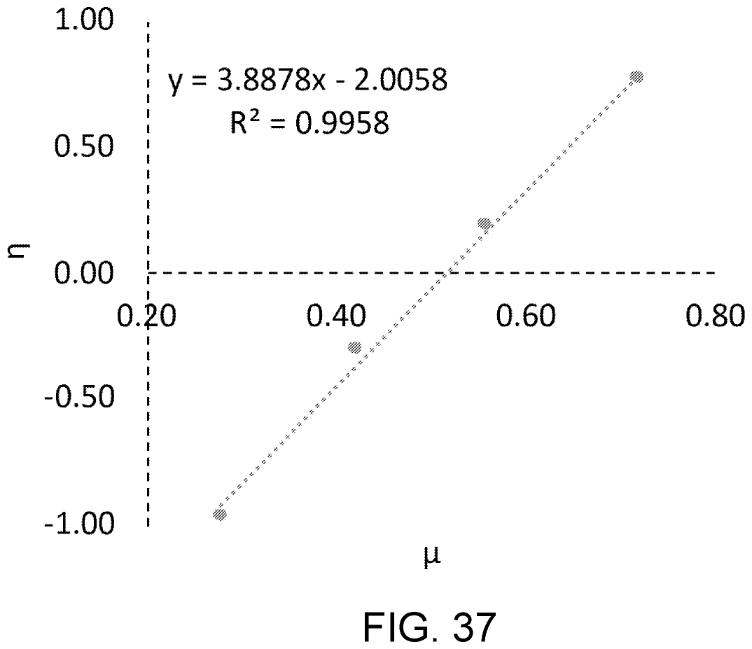

In addition to the synthesis of homopolymer PDHF described in Example 1, the copolymerization of DHF and IBVE was also examined. First the reactivity ratio of these monomers was determined. Polymerizations were performed with varying feed ratios of monomer and the incorporation of each into the polymer was examined at low conversion. With this data, Applicant calculated r_{IBVE}=1.9 and r_{DHF}=2.5 using a Kelen-Tüdős Plot (FIG. 37). This provided evidence that the polymerization of DIF and IBVE would produce a statistical copolymer. Thus, Applicant produced a series of polymers with 0, 3, 6, and 13% IBVE feed concentration and evaluated their material properties (Table 7, FIGS. 36A-36C). Applicant found that their tensile strength decreased proportionally with increasing PIBVE content. Unfortunately, the copolymers exhibited no increase in toughness, as the ε_{B} remained unchanged at 4%. Proportionally lower T_{g}s were observed for the copolymers, as expected.

TABLE 7

| | PIBVE | Mₙ^{exp} | | σ_{B} | ε_{B} | E | T_{g} |
|---|---|---|---|---|---|---|---|
| Sample | (mol %) | (kg/mol) | Ð | (MPa) | (%) | (GPa) | (° C.) |
| PDHF_{100%} | 0 | 56 | 2.13 | 71.6 | 4.1 | 2.61 | 135 |
| PDHF_{97%}-PIBVE_{3%} | 3 | 63 | 2.42 | 67.7 | 4.2 | 2.42 | 124 |
| PDHF_{94%}-PIBVE_{6%} | 6 | 63 | 2.23 | 64.1 | 3.8 | 2.61 | 116 |
| PDHF_{87%}-PIBVE_{13%} | 13 | 61 | 2.23 | 61.8 | 4.1 | 2.41 | 105 |

Copolymerization with Isobutyl Vinyl Ether. The copolymerization of DHF with isobutyl vinyl ether (IBVE) was also investigated to determine its effects on material properties. Copolymers of DHF and IBVE were prepared using the method described in Example 1 for the synthesis of homopolymer PDHF. IBVE was selected because it is another renewable vinyl ether sourced from a commercial bioalcohol. PCCP initiator successfully copolymerized the monomers statistically in feed ratios from 0 to 13%. The PDHF-stat-PIBVE samples had an average Mₙ of 61±3 kg/mol and dispersity of 2.3±0.1. These samples performed nearly identical in tensile testing, despite their T_{g}s decreasing (135-105° C.) with increasing PIBVE content (0-13%). This demonstrates that IBVE can be used to tune the T_{g} and therefore the processing temperature of the polymer.

Reactivity Ratios were determined by conducting several copolymerizations of IBVE and DHF with feed ratios (f_{IBVE}) from 0.2 and 0.8 and recording the mole fraction of monomer incorporation into the copolymer (F_{IBVE})(Table 8). These values were then used in the following calculations to determine the reactivity ratios.

TABLE 8

| Entry | f_{IBVE} | F_{IBVE} | G | H | η | μ |
|---|---|---|---|---|---|---|
| 1 | 0.2 | 0.12 | −1.6 | 0.46 | −0.52 | 0.09 |
| 2 | 0.4 | 0.34 | −0.63 | 0.86 | −0.23 | 0.36 |
| 3 | 0.6 | 0.60 | 0.5 | 1.5 | 0.23 | 0.68 |
| 4 | 0.8 | 0.84 | 3.2 | 3.0 | 0.52 | 0.91 |

### Fineman-Ross Equation:

$$G = {Hr}_{1} - {r}_{2} where ,$$

$$G = \frac{{f}_{IBVE} ( 2 {F}_{IBVE} - 1 )}{{F}_{IBVE} ( 1 - {f}_{IBVE} )}$$

$$H = \frac{{f}_{IBVE}^{2} ( 1 - {F}_{IBVE} )}{{{F}_{IBVE} ( 1 - {f}_{IBVE} )}^{2}}$$

To this, the Kelen-Tüdős normalization was applied limit bias of data points at high and low f_{IBVE}:

$$η = [ {r}_{1} + \frac{{r}_{2}}{α} ] μ - \frac{{r}_{2}}{α} where ,$$

$$η = \frac{G}{( α + H )}$$

$$μ = \frac{H}{( α + H )}$$

$$α = \sqrt{{H}_{min} {H}_{max}}$$

Thus, the plot of f versus yields the reactivity ratios, r₁ and r₂, where η=r₁ at μ=1 and η=−r₂/α when μ=0. Based on this, reactivity ratios 1.9 and 2.4 were calculated for r₁ and r₂, respectively.

Although the present disclosure has been described with respect to one or more particular examples, it will be understood that other examples of the present disclosure may be made without departing from the scope of the present disclosure.

1. A method of preparing a poly(cyclic vinyl ether) (PCVE), the method comprising:
forming a reaction mixture comprising:
one or more cyclic vinyl ether (CVE) monomer(s), each cyclic vinyl ether monomer independently comprising the following structure: 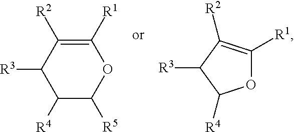
or a structural analog thereof,
wherein:
R² is H; and
R¹ is independently at each occurrence chosen from H, C₁-C₁₀ alkyl groups, C₃-C₁₀ cycloalkyl groups, and C₅-C₁₀ polycycloalkyl groups; and
R³ and R⁴ and R⁵ are according to the following:
R³ and R⁴ and R⁵ are each independently at each occurrence chosen from H, C₁-C₁₀ alkyl groups, C₃-C₁₀ cycloalkyl groups, and C₅-C₁₀ polycycloalkyl groups; or
R³ and R⁴, taken together, form a group independently at each occurrence chosen from C₃-C₁₀ cycloalkyl groups, C₅-C₁₀ polycycloalkyl groups, and C₅-C₁₀ aryl groups, and R⁵, if present, is independently at each occurrence chosen from H, C₁-C₁₀ alkyl groups, C₃-C₁₀ cycloalkyl groups, and C₅-C₁₀ polycycloalkyl groups; or
R⁴ and R⁵, taken together, form a group independently at each occurrence chosen from C₃-C₁₀ cycloalkyl groups, C₅-C₁₀ polycycloalkyl groups, and C₅-C₁₀ aryl groups, and R³ is independently at each occurrence chosen from H, C₁-C₁₀ alkyl groups, C₃-C₁₀ cycloalkyl groups, and C₅-C₁₀ polycycloalkyl groups; and
one or more pentakis((alkoxy/aryloxy)carbonylcyclopentadiene) (alkoxy/aryloxy PCCP) polymerization catalyst(s) and/or initiator(s); and
holding the reaction mixture for a time and at a temperature, wherein a PCVE is formed.

2. The method of claim 1, wherein the CVE monomer(s) is/are chosen from 2,3-dihydrofuran, α-methyl-2,3-dihydrofuran, 5-methyl-2,3-dihydrofuran, benzofuran, 2-methyl benzofuran, 2,3-dihydropyran, structural analogs thereof, and any combination thereof.

3. The method of claim 1, wherein the concentration of the CVE monomer(s) is from about 20% to about 60% by volume, based on the total volume of the reaction mixture.

4. The method of claim 1, wherein each alkoxy/aryloxy PCCP polymerization catalyst and/or initiator independently comprises the following structure: 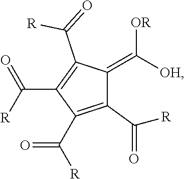
or a structural analog thereof,
wherein the R groups and the OR group are, independently at each occurrence, chosen from:
alkoxy groups, the alkoxy groups, independently at each occurrence, comprising an alkyl group; and
aryloxy groups, the aryloxy groups, independently at each occurrence, comprising an aryl group.

5. The method of claim 4, wherein the R groups and the OR group are, independently at each occurrence, chosen from: 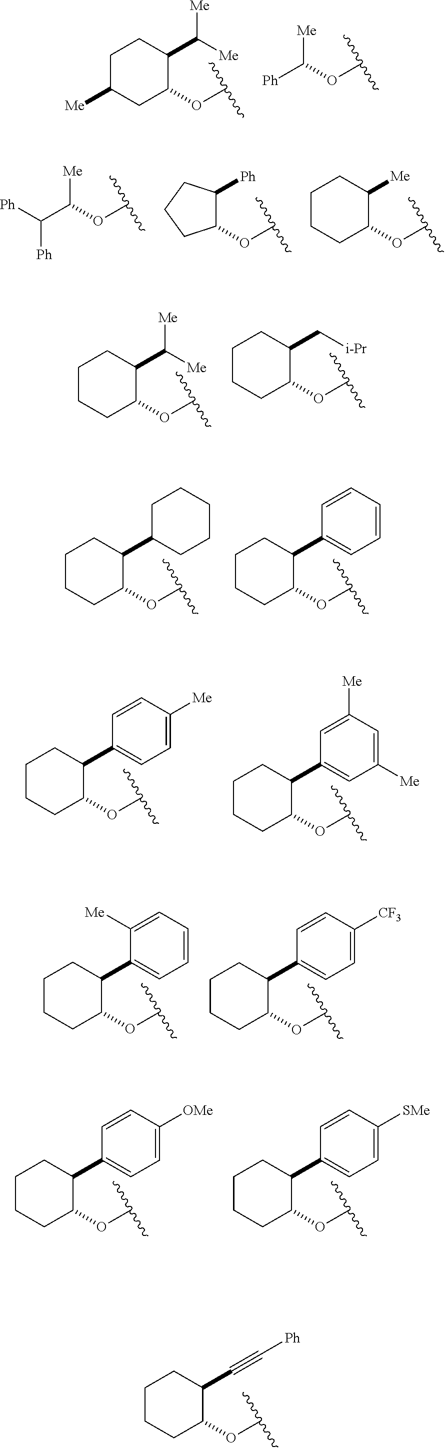 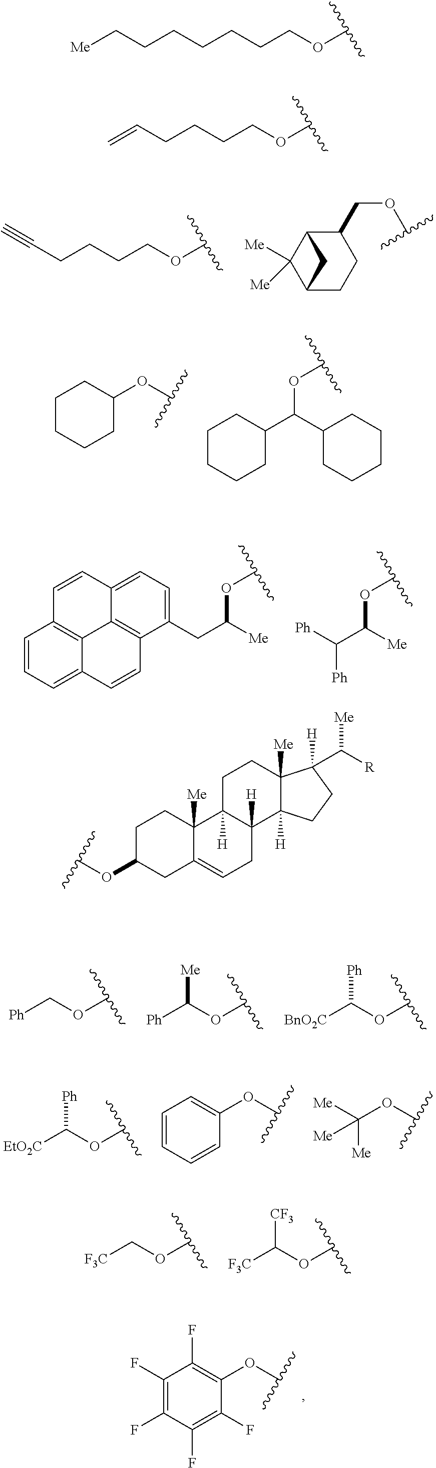
and any structural analog thereof, where 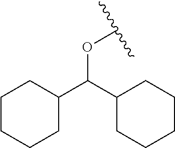 [SMILES: *OC(C1CCCCC1)C1CCCCC1]
is in the C protonated form.

6. The method of claim 4, wherein the alkoxy/aryloxy PCCP polymerization catalyst(s) and/or initiator(s) is/are chosen from C₁-C₃₀ alkoxy/aryloxy PCCP polymerization catalyst(s) and/or initiator(s).

7. The method of claim 4, wherein the R groups and the OR group are, independently at each occurrence, derived from cholesterol or menthol or methanol.

8. The method of claim 1, wherein one or more of the alkoxy/aryloxy PCCP polymerization catalyst(s) and/or initiator(s) is/are chiral alkoxy/aryloxy PCCP polymerization catalyst(s) and/or initiator(s).

9. The method of claim 1, wherein:
the reaction mixture further comprises one or more acyclic vinyl ether (AVE) monomer(s), one or more styrenic monomer(s), or any combination thereof, and/or
the method further comprises, after a desired conversion of the CVE monomer(s), adding one or more AVE monomer(s), one or more styrenic monomer(s), or any combination thereof, to the reaction mixture,
wherein the PCVE is a PCVE copolymer.

10. The method of claim 9, wherein:
each AVE monomer independently comprises the following structure: 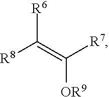
wherein:
R⁶, R⁷, and R⁸ are each H;
R⁹ is independently at each occurrence chosen from H, C₁-C₁₀ alkyl groups, C₃-C₁₀ cycloalkyl groups, and C₅-C₁₀ polycycloalkyl groups; and/or
each styrenic monomer independently comprises the following structure: 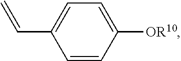
or a structural analog thereof,
wherein:
R¹⁰ are independently at each occurrence chosen from H, C₁-C₈ alkyl groups, C₃-C₁₀ cycloalkyl groups, and C₅-C₁₀ polycycloalkyl groups.

11. The method of claim 9, wherein: the AVE monomer(s) is/are chosen from isobutyl vinyl ether (VE), cyclohexane VE, adamantane VE, ethyl VE, 2-chloroethyl VE, n-butyl VE, t-butyl VE, n-propyl VE, iso-propyl VE, dodecyl VE, phenyl VE, 2-ethylhexyl VE, polyethylene glycol methyl VE, cyclohexyl VE, structural analogs thereof, and any combination thereof; and/or the styrenic monomer(s) is/are chosen from 4-methoxystyrene, structural analogs thereof, and any combination thereof.

12. The method of claim 9, wherein the reaction mixture comprises from about 1 mol % to about 99 mol %, of the AVE monomer(s) and/or the styrenic monomer(s), based on the total moles of the CVE monomer(s), the AVE monomer(s), and the styrenic monomer(s); and/or wherein the AVE monomer(s) and/or the styrenic monomer(s) is/are added to the reaction mixture at from about 1 mol % to about 99 mol %, based on the total moles of the CVE monomer(s), the AVE monomer(s), and the styrenic monomer(s).

13. The method of claim 1, wherein the reaction mixture comprises from about 0.02 mol % to about 1.5 mol %, of alkoxy/aryloxy PCCP polymerization catalyst(s) and/or initiator(s), based on the total moles of the CVE monomer(s), the AVE monomer(s), the styrenic monomer(s), and the alkoxy/aryloxy PCCP polymerization catalyst(s) and/or initiator(s).

14. The method of claim 1, wherein the reaction mixture further comprises one or more hydrogen bond donor(s), optionally chiral hydrogen bond donor(s).

15. The method of claim 14, wherein the hydrogen bond donor(s) is/are polymerization catalyst(s) and the alkoxy/aryloxy PCCP(s) is/are polymerization initiator(s).

16. The method of claim 14, wherein the hydrogen bond donor(s) is/are chosen from thiophosphoramide(s), sulfamide(s), thiourea(s), squaramide(s), and any combination thereof.

17. The method of claim 16, wherein:
the thiophosphoramide(s) independently comprise(s) the following structure: 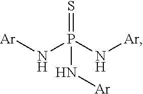
wherein Ar is independently at each occurrence an aryl group or the like, a structural analog thereof, or the like;
the sulfamide(s) independently comprise(s) the following structure: 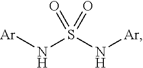
wherein Ar is independently at each occurrence an aryl group or the like, a structural analog thereof, or the like;
the thiourea(s) independently comprise(s) the following structure: 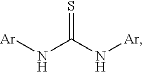
wherein Ar is independently at each occurrence an aryl group or the like, a structural analog thereof, or the like;
the squaramide(s) independently comprise(s) the following structure: 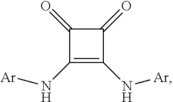
wherein Ar is independently at each occurrence an aryl group or the like, a structural analog thereof, or the like; and/or
optionally, the Ar group(s) is/are di(fluoroalkyl)phenyl group(s).

18. The method of claim 14, wherein the concentration of the hydrogen bond donor(s) is/are from about 0.005 mol % to about 1.5 mol %, based on the total moles of the CVE monomer(s), the AVE monomer(s), the styrenic monomer(s), the alkoxy/aryloxy PCCP(s) polymerization catalyst(s) and/or initiator(s), and the hydrogen bond donor(s).

19. The method of claim 1, wherein the reaction mixture is held until the conversion rate of the CVE monomer(s) to PCVE is from about 90% to about 100%, and, optionally, wherein the reaction mixture is quenched prior to, at, or after 100% conversion.

20. The method of claim 1, wherein the reaction mixture comprises one or more organic solvent(s) chosen from chlorinated hydrocarbon(s), alkane(s), ether(s), aromatic hydrocarbon(s), and any combination thereof.

21. The method of claim 1, further comprising forming an article of manufacture by casting, molding, spin-coating, extrusion, blowing, spinning, or any combination thereof, one or more of the PCVE(s).

22. A poly(cyclic vinyl ether) (PCVE) comprising a plurality of cyclic vinyl ether (CVE) repeat units, the PCVE comprising the following structure: 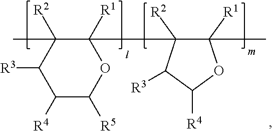
or a structural analog thereof,
wherein:
R² is H; and
R¹ is independently at each occurrence chosen from H, C₁-C₁₀ alkyl groups, C₃-C₁₀ cycloalkyl groups, C₅-C₁₀ and polycycloalkyl groups; and
R³ and R⁴ and R⁵ are according to the following:
R³ and R⁴ and R⁵ are each independently at each occurrence chosen from H, C₁-C₁₀ alkyl groups, C₃-C₁₀ cycloalkyl groups, and C₅-C₁₀ polycycloalkyl groups; or
R³ and R⁴, taken together, form a group independently at each occurrence chosen from C₃-C₁₀ cycloalkyl groups, and C₅-C₁₀ polycycloalkyl groups, C₅-C₁₀ aryl groups, and R⁵, if present, is independently at each occurrence chosen from H, C₁-C₁₀ alkyl groups, C₃-C₁₀ cycloalkyl groups, and C₅-C₁₀ polycycloalkyl groups; or
R⁴ and R⁵, taken together, form a group independently at each occurrence chosen from C₃-C₁₀ cycloalkyl groups, C₅-C₁₀ polycycloalkyl groups, and C₅-C₁₀ aryl groups, and R³ is independently at each occurrence chosen from H, C₁-C₁₀ alkyl groups, C₃-C₁₀ cycloalkyl groups, and C₅-C₁₀ polycycloalkyl groups; and
the mole ratio of the l repeat unit value to the m repeat unit value is from 100:0 to 0:100; and
the l+m repeat unit value is from about 70 to about 17,200.

23. The PCVE of claim 22, wherein the PCVE comprises a PCVE homopolymer comprising a molecular weight (Mn and/or Mw), of about 200 kg/mol or greater.

24. The PCVE of claim 22 wherein the PCVE comprises a polydispersity index (Mw/Mn) of from about 1.05 to about 10.

25. The PCVE of claim 22, wherein the PCVE comprises: a molecular weight between entanglements (Mₑ) of from about 2 kg/mol to about 5 kg/mol; and/or a critical molecular weight (M_{c}) of from about 4 kg/mol to about 10 kg/mol.

26. The PCVE of claim 22, wherein the CVE repeat units are independently at each occurrence chosen from a tetrahydrofuran group, a α-methyl-tetrahydrofuran group, a benzo-dihydrofuran group, and any structural analog thereof.

27. The PCVE of claim 22, wherein the PCVE comprises a PCVE copolymer further comprising one or more acyclic vinyl ether (AVE) repeat unit(s), one or more styrenic ether repeat unit(s), or any combination thereof.

28. The PCVE of claim 27, wherein the PCVE copolymer has the following structure, 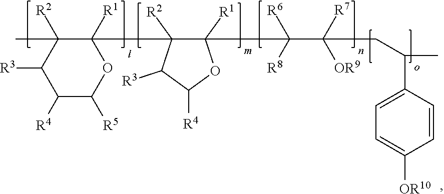
or a structural analog thereof,
wherein:
R², R⁶, R⁷, and R⁸ are each H; and
R¹ and R⁹ are each independently at each occurrence chosen from H, C₁-C₁₀ alkyl groups, C₃-C₁₀ cycloalkyl groups, and C₅-C₁₀ polycycloalkyl groups; and
R¹⁰ is independently at each occurrence chosen from C₁-C₁₀ alkyl groups, C₃-C₈ cycloalkyl groups, and C₅-C₁₀ polycycloalkyl groups; and
R³ and R⁴ and R⁵ are according to the following:
R³ and R⁴ and R⁵ are each independently at each occurrence chosen from H, C₁-C₁₀ alkyl groups, C₃-C₁₀ cycloalkyl groups, and C₅-C₁₀ polycycloalkyl groups; or
R³ and R⁴, taken together, form a group independently at each occurrence chosen from C₃-C₁₀ cycloalkyl groups, and C₅-C₁₀ polycycloalkyl groups, C₅-C₁₀ aryl groups, and R⁵, if present, is independently at each occurrence chosen from H, C₁-C₁₀ alkyl groups, C₃-C₁₀ cycloalkyl groups, and C₅-C₁₀ polycycloalkyl groups; or
R⁴ and R⁵, taken together, form a group independently at each occurrence chosen from C₃-C₁₀ cycloalkyl groups, C₅-C₁₀ polycycloalkyl groups, and C₅-C₁₀ aryl groups, and R³ is independently at each occurrence chosen from H, C₁-C₁₀ alkyl groups, C₃-C₁₀ cycloalkyl groups, and C₅-C₁₀ polycycloalkyl groups; and
the mole ratio of the l, m, or l+m repeat unit value to the n, o, or n+o repeat unit value is from 99:1 to 1:99; and
only one of the l repeat unit value and the m repeat unit value can be zero; and
only one of the n repeat unit value and the o repeat unit value can be zero.

29. The PCVE of claim 28, wherein the l, m, or l+m repeat unit value is from about 70 to about 4300, and wherein the n, o, or n+o repeat unit value is from about 10 to about 3000.

30. The PCVE of claim 28, wherein the PCVE copolymer is:
a statistical PCVE copolymer comprising a mole ratio of the l, m, or l+m repeat unit value to the n, o, or n+o repeat unit value of from about 99:1 to about 1:99; or
a block PCVE copolymer comprising a mole ratio of the l, m, or l+m repeat unit value to the n, o, or n+o repeat unit value of from about 5:95 to about 90:10.

31. The PCVE of claim 27, wherein: the AVE repeat unit(s) is/are chosen from an isobutyl vinyl ether (VE) repeat unit, a cyclohexyl (VE) repeat unit, an adamantane (VE) repeat unit, an ethyl (VE) repeat unit, a 2-chloroethyl (VE) repeat unit, an n-butyl (VE) repeat unit, a t-butyl (VE) repeat unit, an n-propyl (VE) repeat unit, an iso-propyl (VE) repeat unit, a dodecyl (VE) repeat unit, a phenyl (VE) repeat unit, a 2-ethylhexyl (VE) repeat unit, a polyethylene glycol methyl (VE) repeat unit, a cyclohexyl (VE) repeat unit, structural analogs thereof, and any combination thereof; and/or the styrenic repeat unit is chosen from a 4-methoxystyrene repeat unit, structural analogs thereof, and any combination thereof.

32. The PCVE of claim 27, wherein the PCVE copolymer comprises a molecular weight (Mn and/or Mw) of from about 5 kg/mol to about 500 kg/mol.

33. The PCVE of claim 27, wherein the PCVE comprises one or more end group(s) chosen independently from cyclic ether end group(s), cyclic vinyl ether end group(s), quencher end group(s), alkyl end groups, alkoxy end groups, and any combination thereof.

34. The PCVE of claim 27, wherein the PVE comprises one or more domain(s) and the domain(s) is/are, independently, at least partially or completely atactic, isotactic, isoenriched, syndiotactic, syndioenriched, or any combination thereof.

35. The PCVE of claim 27, wherein the PVE comprises one or more domain(s) and the domain(s) is/are, independently, at least partially or completely crystalline, amorphous, or any combination thereof.

36. The PCVE of claim 27, wherein the PCVE exhibits one or more or all of the following:
a tensile strength (σ) of from about 50 megapascal (MPa) to about 80 MPa;
a strain at break (ε) of from about 4% to about 50%;
a Young's modulus (E) of from about 2 gigapascal (GPa) to about 3 GPa;
a toughness of from about 1 MPa to about 25 MPa;
a glass transition temperature (Tg) of from about 130° C. or greater;
a thermal stability of 5% mass loss at from about 350° C. to about 370° C.;
an optical clarity of about 90% transmission or greater;
a permeability of water vapor of about 3 g·mm/m²·day or less;
a permeability of gas of about 1.5 Barrer or less; or
partial or complete degradability.

37. The PCVE of claim 27, wherein the PCVE is in the form of a flake, a pellet, a powder, a granule, a particle, a bead, a bar, a film, a fiber, a sheet, a monolith, a solution, an emulsion, or any combination thereof.

38. A composition comprising one or more PCVE(s) of claim 27.

39. The composition of claim 338, further comprising one or more additive(s) chosen from heat stabilizer(s), oxidation inhibitor(s), plasticizer(s), and any combination thereof.

40. The composition of claim 38, wherein the composition is in the form of a flake, a pellet, a powder, a granule, a particle, a bead, a bar, a film, a fiber, a sheet, a monolith, a solution, an emulsion, or any combination thereof.

41. An article comprising one or more PCVE(s) of claim 27.

42. The article of claim 41, wherein the article is a molded article, an extruded article, a blown article, a cast article, a spun article, or any combination thereof.

43. The article of claim 41, wherein the article is a coating, a sheet, a film, a fiber, a textile, a foam, a composite, or any combination thereof.

44. The article of claim 41, wherein the article is a single use article, a packaging article, a biomedical article, an architectural article, an automotive article, an agricultural article, an electronic article, a drug delivery article, a wound closure article, a surgical suture, a medical implant, a tissue engineering construct, or any combination thereof.

45. The article of claim 41, wherein the article is a wrapping, a bag, a container, a filler, a protector, a pad, a fastener, a cup, a bottle, a lid, a cutlery, a straw, or any combination thereof, or any combination thereof.

46. The article of claim 41, wherein the article is degradable in soil, freshwater environments, saltwater environments, or the like, or any combination thereof.
